(19) United States
(12) Patent Application Publication
(10) Pub. No.: US 2019/0340622 A1
(43) Pub. Date: Nov. 7, 2019

(54) ENHANCED CUSTOMER INTERACTION

(71) Applicant: EYE-IN INC., Montreal (CA)

(72) Inventors: Nathalie AZOULAY, Saint-Luc (CA); Jeff SINGER, Saint Luc (CA); Guillaume RIOUX, Montreal (CA)

(21) Appl. No.: 16/409,976

(22) Filed: May 13, 2019

Related U.S. Application Data
(63) Continuation of application No. PCT/CA2017/051371, filed on Nov. 17, 2017.

(51) Int. Cl. G06Q 30/00; G06Q 30/02; H04L 29/08

(52) U.S. Cl. CPC G06Q 30/016; G06Q 30/0205; H04L 67/22; G06Q 30/0261

(57) ABSTRACT

Provided is customer interaction system whereby a commercial establishment may interact with customer located at their physical premise using the customer's mobile device. Using a customer's mobile device, a location of the customer within a store may be established and a connection directly to an employee within the store may be made. Customers may interact with the employee via chat, allowing the employee to serve multiple customers at once. The platform also allows for customer profile building based on the chat and employee input to establish customer preferences, and customer profile information may be accessed by the employee to help in serving the customer. A profile building algorithm computes and provides suggestions of promotional offers and chat questions that can provide useful information to the customer profile data.

This application claims priority of U.S. provisional No. 62/463,972 filed Feb. 27, 2017 and also claims priority of U.S. provisional No. 62/424,115 filed Nov. 18, 2016, the contents of which are hereby incorporated by reference.

### TECHNICAL FIELD

The subject matter disclosed relates generally to the field of inter-device communication system and to the field of commercial promotion system. It also relates to the field of the customer-commerce interaction and computerized solutions therefor. It also relates to the field of customer profiling and custom service providing. It also relates to the field of custom promotion.

### BACKGROUND

Recent developments in mobile technology have provided many new shopping tools and options but have largely left the in-store experience unchanged. Online shopping has grown in popularity, however brick-and-mortar store locations continue to thrive based on the patronage or customers who prefer the experience and convenience of in-person shopping.

Although many customers walk around with smart devices such as smart phones and tablets use of such device in the shopping experience is typically limited to looking up product reviews and comparing prices online.

The manner in which a customer may seek and receive assistance from store personnel has largely remained unchanged in spite of recent technological developments. Typically, a customer seeking assistance with a purchasing decision or other in-store concern must physically walk around the store to find an available store clerk and ask his or her question in person. Due to the personal nature of the interaction, a clerk may only assist one customer at a time. Moreover, a customer may be hesitant to disturb a clerk for whatever reason, for example if the clerk seems busy, or if the customer does not want to engage in discussion for a simple question.

Such limitations may be costly to stores since customer queries that go unanswered or unaddressed may lead to a failed sale opportunity. Moreover by interacting with customers store clerks may identify customer needs and suggest products or other solutions that the customer may not have known about or found on his/her own.

Due to the anonymous nature of traditional shopping, stores miss out on the opportunity to tailor the shopping experience to the customer. For example, every time a customer interacts with a store clerk or purchases a product, the store learns about the customer's needs and shopping habits, but this information is immediately lost unless the same person that served him/her is there again and remembers their interaction the next time the customer comes to the store. This limits the store's ability to tailor the shopping experience to the customer. Product or service offerings and suggestions, e.g. during interactions with a store clerk but also unsolicited offers, cannot take into account information that has not been retained and made accessible.

Brick-and-mortar stores do not benefit from all the advantages of online stores. For example, traditional stores cannot have access to all their customers' browsing data and the like. some stores attempt to gather shopping profiles using rewards cards to associate purchases with individuals, however this method relies on knowing what the customer has bought and provides no additional information on what the customer considered buying, what the customer prefers, what kind of demographic profile the customer belongs to etc. This data can only be inferred from the purchase history.

Although store-based shopping continues to occupy an important role in the retail economy, in order to compete with the convenience of online shopping, it is important for brick-and-mortar stores to increase the convenience of the customer experience and the profitability of the business.

### SUMMARY

In accordance with an aspect is provided a customer interaction system for interacting with customers having customer attributes indicative of purchasing preferences. The system comprises a customer profile database comprising a plurality of customer datasets each associated with a respective customer profile of a customer, each customer dataset comprising a set of customer attribute entries, each customer attribute entry including customer attribute data including a level of confidence associated with an respective customer attribute of the respective customer. The system further comprises a promotional database comprising a plurality of promotional datasets each corresponding to a promotional offer and comprising offer data defining the promotional offer and promotional attribute data indicative of a customer attribute associated with the promotional offer. The system further comprises a promotional module embodied as computer-readable instructions stored in a storage medium executable by a general-purpose processor to cause the processor to access the promotional database to retrieve promotional datasets stored therein and cause the transmission of the offer data from the promotional datasets for display at customer mobile devices; and receive response data indicative of a customer response to the respective promotional offer. The system further comprises a profile builder module callable with respect to a particular customer profile embodied as computer-readable instructions stored in a storage medium executable by a general-purpose processor to cause the processor to access the customer profile database to locate the particular customer's customer profile dataset and to retrieve therefrom the level of confidence in the customer attribute data for a set of customer attribute entries, and identify a particular customer attribute for which new customer attribute data is required on the basis of a low level of confidence associated with the particular customer attribute; access the promotional database to retrieve promotional attribute data of at least a subset of the plurality of promotional datasets and identify within the subset of the plurality of the promotional datasets a particular promotional dataset having promotional attribute data indicative of the particular customer attribute; retrieve from the promotional database the particular offer data of the particular promotional dataset and cause the transmission of the particular offer data for display at a particular customer mobile device of the particular customer; and on receipt of response data by the promotional module, parsing the response data to identify the particular promotional offer and derive redeeming data, and updating the customer attribute data for the particular customer attribute on the basis of the redeeming data.

In accordance with another aspect is provided a method for interacting electronically with customers and for populating digital customer profiles using electronic interactions with the customers. The method comprises accessing customer profile database to locate a customer profile dataset associated with the particular customer and retrieving from the customer profile dataset a set of customer attribute entries, each customer attribute entry including customer attribute data including a level of confidence associated with an respective customer attribute of the respective customer. The method further comprises identifying within the set of customer attribute entries a particular customer attribute for which new customer attribute data is required on the basis of a low level of confidence associated with the particular customer attribute. The method further comprises accessing a promotional database comprising a plurality of promotional datasets each corresponding to a promotional offer and comprising offer data defining the promotional offer and promotional attribute data indicative of a customer attribute associated with the promotional offer to identify a particular promotional dataset having promotional attribute data indicative of the particular customer attribute. The method further comprises retrieving from the promotional database the particular offer data of the particular promotional dataset and causing the transmission of the particular offer data for display at a particular network-connected customer mobile device associated with the particular customer. The method further comprises receiving response data and parsing the response data to derive redeeming data indicative of a redeeming by the particular customer of the particular promotional offer, and updating the customer attribute data for the particular customer attribute on the basis of the redeeming data.

In accordance with another aspect is provided a customer interaction system for populating digital customer profiles using electronic interactions. The system comprises a customer profile database comprising a plurality of customer datasets each associated with a respective customer profile of a customer, each customer dataset comprising a set of customer attribute entries, each customer attribute entry including customer attribute data including a level of confidence associated with an respective customer attribute of the respective customer. The system further comprises a profile builder module callable with respect to a particular customer profile embodied as computer-readable instructions stored in a storage medium executable by a general-purpose processor to cause the processor to receive from a computing device a message indicating that a chat session has been engaged between the computing device and a customer mobile device associated with a particular customer; access the customer profile database to locate the particular customer's customer profile dataset and to retrieve therefrom the level of confidence in the customer attribute data for a set of customer attribute entries, and identify a particular customer attribute for which new customer attribute data is required on the basis of a low level of confidence associated with the particular customer attribute; generate a message comprising an identification of the particular customer attribute to display at the computing device an instruction to an operator at the computing device to ask the particular customer a question about the particular customer attribute in the course of the chat session; upon the question being asked, receive response data and updating the customer attribute data for the particular customer attribute on the basis of the response data.

In accordance with another aspect is provided a method for interacting electronically with customers and for populating digital customer profiles using electronic interactions with the customers. The method comprises receiving from a computing device a message indicating that a chat session has been engaged between the computing device and a customer mobile device associated with a particular customer. The method further comprises accessing customer profile database to locate a customer profile dataset associated with the particular customer and retrieving from the customer profile dataset a set of customer attribute entries, each customer attribute entry including customer attribute data including a level of confidence associated with an respective customer attribute of the respective customer. The method further comprises identifying within the set of customer attribute entries a particular customer attribute for which new customer attribute data is required on the basis of a low level of confidence associated with the particular customer attribute. The method further comprises generating a message comprising an identification of the particular customer attribute to display at the computing device an instruction to an operator at the computing device to ask the particular customer a question about the particular customer attribute in the course of the chat session. The method further comprises upon the question being asked, receiving response data and updating the customer attribute data for the particular customer attribute on the basis of the response data.

In accordance to another aspect is provided a method for interacting with a customer at a physical store premises. The method comprises detecting the presence within the physical store premises of a network-connected customer mobile device associated with the customer. The method further comprises based at least in part upon the detection of the presence within the physical store premises, establishing communication between the customer mobile device associated with the customer and an in-store computing device operated by a store employee at the physical store premises and initiating a real-time chat conference whereby text messages entered by the customer at the customer mobile device and by the employee at the in-store computing device are exchanged in real time between the customer mobile device and the in-store computing device.

In accordance with another aspect is provided a computing device operable in a physical store premises by a store employee comprising a network communication interface for exchanging data over a data network, a general-purpose processing device configurable by computer-readable instructions, a display, and a memory accessible to the processing entity storing computer-readable executable by the processing entity for implementing an application for a store employee in a customer interaction system. The computer-readable instructions comprise a connection module comprising computer-readable instructions to instantiate over the network communication interface a connection with a customer mobile device of a customer located in the store on the basis of the customer's location. The computer-readable instructions further comprise a chat module comprising computer-readable instructions to instantiate a text-based chat exchange with the customer. The computer-readable instructions further comprise a customer profile module comprising computer-readable instructions to retrieve customer preference data associated with the customer and representative of the shopping preferences of the customer for presentation to the employee.

In accordance with another aspect is provided a mobile computing device operable in a physical store premises by a customer comprising a network communication interface for exchanging data over a data network, a general-purpose processing device configurable by computer-readable instructions, a display, and a memory accessible to the processing entity storing computer-readable executable by the processing entity for implementing an application for a store employee in a customer interaction system. The computer-readable instructions comprise a location module comprising computer-readable instructions for ascertaining the location of the mobile computing device for determining that the mobile computing device is located within the physical store premises. The computer-readable instructions further comprise a connection module comprising computer-readable instructions to instantiate over the network communication interface a connection with an in-store computing device accessible by an employee of the store at least in part on the basis of the determination that the mobile computing device is located within the physical store premises. The computer-readable instructions further comprise a chat module comprising computer-readable instructions to instantiate a text-based chat exchange with the employee at the in-store computing device at least in part on the basis of the determination that the mobile computing device is located within the physical store premises.

In accordance with another aspect is provided a server for implementing a customer interaction system comprising a network communication interface for exchanging data over a data network, and a general-purpose processing device configurable by computer-readable instructions. The server also comprises a server storage storing a customer profile dataset associated with a particular customer, the customer profile dataset comprising customer identification data and customer preference data indicative of shopping preferences for the customer, and a commercial profile dataset associated with a commercial establishment comprising identification data and a set of chat logs representative of chat conversations with individual customers. The server also comprises a memory accessible to the processing entity storing computer-readable executable by the processing entity for implementing an application for a store employee in a customer interaction system. The computer-readable instructions comprise a customer API module comprising computer-readable instructions to communicate over the network communication interface with a customer mobile device associated with the customer profile dataset and located in a physical premises of the commercial establishment, and receive from the customer mobile device location information pertaining to the location of the customer mobile device and to determine, on the basis of the location information, that the mobile computing device is located within the physical premises. The computer-readable instructions further comprise a commercial API module comprising computer-readable instructions to communicate over the network communication interface with an in-store computing device associated with the commercial profile dataset and located in the physical premises of the commercial establishment. The computer-readable instructions further comprise a core module comprising computer-readable instructions to establish a connection between customer mobile device and the in-store computing device at least in part on the basis of the determination that the mobile computing device is located within the physical premises, and to establish a chat session between the in-store computing device and the customer mobile device at least in part on the basis of the determination that the mobile computing device is located within the physical premises.

In accordance with yet another aspect is provided a multi-dimensional customer interaction system for selectively communicating promotional data to a particular customer over one of a plurality of different customer communication services available to the particular customer. The system comprises a set of interfaces, each being adapter to cause a transmission over a respective one of the plurality of different customer interaction services, a general-purpose processing device configurable by computer-readable programming instructions for executing the computer-readable instructions of the promotional module and the profile-builder module, and a tangible computer-readable storage medium in communication with and accessible by the general-purpose processing device storing computer-readable instructions executable by the general-purpose processing device implementing a selective contact algorithm. The selective contact algorithm, when implemented, comprises receiving input indicative of a particular customer to contact and of a particular promotional offer to provide to the customer, selecting a particular one of the plurality of interfaces through which to communicate the particular promotional offer to the customer, and instruct the particular interface to communicate the promotional offer to the particular customer.

In accordance with yet another aspect is provided a method of selectively communicating promotional data to a particular customer over one of a plurality of different customer communication services available to the particular customer. The method comprises receiving input indicative of a particular customer to contact and of a particular promotional offer to provide to the customer, selecting a particular one of a set of interfaces through which to communicate the particular promotional offer to the customer, each of the a set of interfaces being adapter to cause a transmission over a respective one of the plurality of different customer interaction services, and instructing the particular interface to communicate the promotional offer to the particular customer.

In accordance with yet another aspect is provided a method of populating a customer relationship management system with data derived by a customer monitoring system. The method comprises obtaining at the customer monitoring system a plurality of data packages, each of which describing corresponding information content about a particular customer; processing the plurality of data packages to determine that the corresponding information content about the particular customer fit a particular behavior pattern; and in response to determining that the corresponding information content about the particular customer fit the particular behavior pattern, generating a contribution message descriptive of the particular behavior pattern in a customer relationship management system format and communicating the contribution message to the customer relationship management system through an inter-system interface.

In accordance with yet another aspect is provided a customer monitoring system for identifying customer behavior and populating a customer relationship management system with customer data comprising a general-purpose processing entity configured to be programmed by computer-readable instructions; a network interface in communication with the general-purpose processing entity for communicating data over a data network with remote devices; and a computer-readable memory accessible by the general-purpose processing entity. The computer-readable memory comprises computer-readable program instructions for obtaining at the customer monitoring system a plurality of data packages, each of which describing corresponding information content about a particular customer; processing the plurality of data packages to determine that the corresponding information content about the particular customer fit a particular behavior pattern; and in response to determining that the corresponding information content about the particular customer fit the particular behavior pattern, generating a contribution message descriptive of the particular behavior pattern in a customer relationship management system format and communicating the contribution message to the customer relationship management system through an inter-system interface

### BRIEF DESCRIPTION OF THE DRAWINGS

The invention will be better understood by way of the following detailed description of embodiments of the invention with reference to the appended drawings, in which:

FIG. 1 shows a cutaway perspective view of a commercial physical premises with a customer interaction system deployed in accordance with an exemplary embodiment;

FIG. 2A shows a block diagram of the customer interaction system deployed in the commercial physical premises of FIG. 1;

FIG. 2B shows a block diagram of a customer interaction system in accordance with another exemplary embodiment;

FIG. 2C shows a block diagram of a customer interaction system in accordance with yet another exemplary embodiment;

FIGS. 3A and 3B shows a representative block diagram of an exemplary instance of a customer profile dataset in connection with the customer interaction system of FIG. 1;

FIG. 3C shows a representative block diagram of an exemplary instance of a employee profile dataset in connection with the customer interaction system of FIG. 1;

FIG. 3D shows a representative block diagram of an exemplary instance of a promotional dataset in connection with the customer interaction system of FIG. 1;

FIG. 4A shows a block diagram of a customer mobile device from the customer interaction system of FIG. 1, in accordance with an exemplary embodiment;

FIG. 4B shows a block diagram of an in-store computing device from the customer interaction system of FIG. 1, in accordance with an exemplary embodiment;

FIG. 4C shows a block diagram of a system server from the customer interaction system of FIG. 1 in accordance with an exemplary embodiment;

FIG. 5A shows a block diagram of a software system for the customer mobile device of FIG. 4A in accordance with an exemplary embodiment;

FIG. 5B shows a block diagram of a software system for the in-store computing device of FIG. 4B in accordance with an exemplary embodiment;

FIG. 5C shows a block diagram of a software system for the system server of FIG. 4C in accordance with an exemplary embodiment;

FIG. 6 shows a finite state machine diagrams illustrating some of the functions of the software system of FIG. 5A;

FIG. 7A shows the customer mobile device of FIG. 4A displaying a log-in screen;

FIG. 7B shows the customer mobile device of FIG. 4A displaying a customer chat screen;

FIG. 8A shows the in-store computing device of FIG. 4B displaying an employee chat screen;

FIG. 8B shows the in-store computing device of FIG. 4B displaying a promotion management screen;

FIG. 9A shows a flow chart illustrating an exemplary profile builder;

FIG. 9B shows a flow chart illustrating an example of a search algorithm for a profile builder in accordance with an exemplary embodiment;

FIG. 10 shows a flow chart illustrating an example of a promotional offer selection function according to an exemplary embodiment;

FIG. 11 shows a transition state diagram illustrating the some elements of an implementation of a web interface according to an exemplary embodiment;

FIG. 12 A shows a promotional page of the web interface of FIG. 11 according to an exemplary embodiment;

FIG. 12B shows a personal settings page of the web interface of FIG. 11 according to an exemplary embodiment;

FIG. 13 shows a block diagram of the customer interaction system of FIG. 1 implementing customer interaction in a multi-dimensional customer communication context;

FIG. 14 shows a block diagram of a customer monitoring system according to an exemplary embodiment;

FIG. 15 shows a schematic illustration of different layers of data that may be provided by the customer monitoring system of FIG. 14;

FIGS. 16A, 16B, 16C show flow charts illustrating exemplary triggers implemented by the customer monitoring system of FIG. 14;

FIGS. 17A, 17B show block diagrams of database components of an exemplary customer monitoring database implemented by the customer monitoring system of FIG. 14;

FIGS. 18A, 18B, 18C, 18D show flow charts illustrating examples of pattern recognition and activity determination by the customer monitoring system of FIG. 14;

FIG. 19 shows a visual depiction of exemplary map data used by the customer monitoring system of FIG. 14;

FIG. 20A shows a flow chart illustrating an event flow of an exemplary customer journey compiled by the customer monitoring system of FIG. 14;

FIG. 20B shows a visual depiction of the customer journey of FIG. 20A illustrated in map form;

FIG. 20C shows a schematic depiction of the customer journey of FIG. 20A;

FIG. 20D shows a schematic depiction of statistical information pertaining to the customer journey of FIG. 20A;

FIG. 21A and FIG. 21B together show a flow chart illustrating an exemplary event chain from obtaining data packages to transmitting a contribution message to a customer relationship management system by the customer monitoring system of FIG. 14; and

FIG. 22 shows a flow chart illustrating an exemplary event chain implementing a trigger mechanism by the customer monitoring system of FIG. 14.

### DETAILED DESCRIPTION

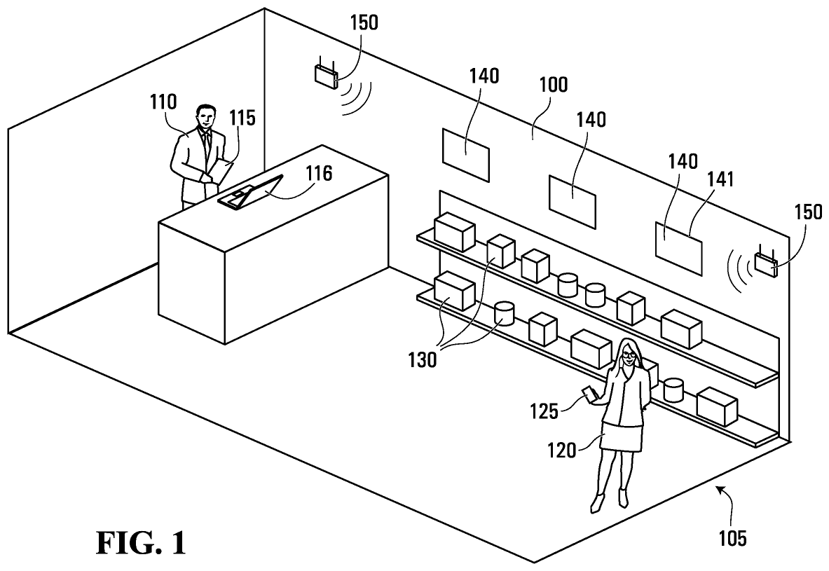

FIG. 1 shows a cutaway perspective view of a commercial physical premises 105 with a customer interaction system 100 deployed in accordance with an exemplary embodiment. The customer interaction system 100 provides customers with an enhanced commercial experience and provides a technological solution to overcome limitations of traditional existing systems.

The commercial physical premises is a location of a commercial establishment such as a shop, a kiosk, a grocery store, a department store, a car dealership, a travel agency, or the like, and is generally called a physical store premise, or store 105 for short. The commercial physical premises 105 is typically an indoor location such as a store building or a locale in a shopping mall or the like, and is defined by geographic boundaries enclosing a physical space. Although many commercial establishments are single-location with a single commercial physical premises, other commercial establishments such as designer shop chains or grocery shop chains may have several commercial physical premises at various locations (e.g. in various malls). In the present example, the store 105 is a single shop of a commercial establishment which has other premises in other locations. For the present example, the commercial establishment is StoreCo, a chain of sports and outdoors equipment and the store 105 is a particular StoreCo shop, located in a particular mall. Of course, other configurations for stores or commercial establishment are possible and it will be appreciated that stores can be outdoors, and can have a wide variety of geographic definitions, including differently defined boundaries, discontinuities, etc. . . . or may be non-geographical in nature. For example, a store may operate in an unbounded or outdoor area such as at a concert, festival, sporting event or race area.

The store 105 is serviced by an employee 110 who provides services or attends to responsibilities related to the store 105's commercial offerings, such as being a salesman, a cashier or a manager. Although the term employee is used for simplicity, the employee 110 needs not necessarily be a salaried worker. Depending on the business model of the commercial establishment, the store 105 may have other types of representatives of the commercial establishment such as owners, co-owners/partners, volunteers, club members, etc. . . . . The term employee is not meant to exclude any such personnel. Moreover, where applicable non-human resources may take the role of the employee 110, such as artificial intelligence entities, chat bots or the like.

The store 105 has a clientele including in the illustrated instance a customer 120 who is a patron of the store 105. Typically, a store 105 sells goods, and occasionally services, and patrons are typically potential purchasers of the goods or services sold. In the illustrated example, the store 105 sells products 130, including sports equipment and the customer 120 is a shopper who has entered the store 105. In other embodiments, the customer 120 may be another type of patron, such as a participant in an experience (e.g. laser tag, a concert, a trade show, or a product demonstration), have another role fitting the offering of the particular commercial physical premises he/she is using.

In accordance with the existing paradigms, if the customer 120 has a question or wants help, he/she must locate the employee 110 and ask the question in person. This may be time consuming if the employee 110 is not readily locatable or is busy (e.g. with another customer) and some customers do not want to engage in the formalities of discussion and inquiry for what they judge to be a quick or simple question. In accordance with the present example, the customer interaction system 100 provides customers with new and more convenient ways of interacting with representatives of the commercial establishment while in the store 105, in a way that is both very fast and convenient and yet lacks none of the personal touch that on-premises shopping can offer.

More specifically, the customer interaction system 100 connects the customer 120 to the store 105, and even to the employee 110 via the customer's own mobile device 125 (e.g. smart phone). Through a universal interface which does not require a store-specific download or registration, the customer 120's presence within the store 105 is detected and the customer 120 can be put in contact with the employee 110 via a convenient chat interface such that a customer 120 can quickly and conveniently send a question, query, or other message, to the employee 110 who can respond via an in-store computing device 115. The in-store computing device may be a work station but is preferably a mobile device such as a tablet (as in the illustrated example) such that the employee 110 can move around the store 105 with the in-store computing device 115.

Advantageously, the in-store computing device 115 allows for multiple simultaneous chat conversations such that the single employee 110 can hold multiple chat-based conversations with different customers simultaneously. This allows the employee 110 to be readily findable (via the customer interaction system 100) and available for a question. In contrast, using the traditional customers must find the employee 110 somewhere in the store 105, and wait until the employee 110 is done serving other customers. In large-surface stores a common question for employees is where to find a particular item. This can be a long and tedious problem if an employee is solicited by multiple customers. But typically, the employee knows off-hand the answer to the question. using the customer interaction system 100, several customers, including customer 120, can simultaneously send the employee 110 their questions, and the employee 110 can answer them all rapidly and without major delay. What's more, if the customer 120 requires in-person help; for example if the customer 120 is asking questions about how specifically to use a product 130 which requires a physical demonstration, the employee 110 can locate the customer 120 in the store 105 using the customer interaction system 100 and physically meet the customer 120 to help them directly.

Through the customer interaction system 100, the customer 120 may obtain information concerning the employee 110, such as a picture, name and position displayed to the customer at the customer mobile device 125 so that the customer may readily recognize the employee 110 when they meet physically. This may also help reassure the customer of the employee 110's competence to address a particular question. Moreover contact information may be provided to allow the customer 120 to pursue the conversation or to follow-up at a later time remotely. Contact information may include data on the store 105 or more broadly the commercial establishment (StoreCo) or the employee 110 themselves.

Similarly, the customer interaction system 100 allows the employee 110 to obtain information regarding the customer 120 allowing them to provide them better and more targeted service. In particular, a customer profile is compiled, in part from interactions done over the customer interaction system 100 which is provided to the employee 110 and which contains information on interests, past purchases or the like. This information is provided to the employee 110 via, and displayed on, the in-store computing device 115 such that the employee 110 may have the information on-hand when assisting the customer 120 to allow the employee 110 to make suggestions and recommendations tailored to the customer 120. Moreover, interactions over the system, particularly chat texts, are mined for additional data with which to enhance the customer profile. Moreover still, the employee 110 may enter notes into the system based on the interaction they have with the customer 120 to further enhance the customer profile or may amend it directly. Other sources of data for the customer profiles may include transactions/purchases as well as other account data such as social media profile.

The customer interaction system 100 also allows for targeted promotional data, such as advertising or promotions, to be presented to the customer 120. In one instance, the customer mobile device may be used to display promotional materials such as ads or promotions directly to the customer 120. Using data from the customer profile, the customer interaction system 100 may select targeted promotional material matching the customer's interests, past purchases or other profile data. Moreover the employee 110 may select specific promotional material to present to the customer 120, e.g. based on their interaction. This may include coupons or discounts specifically for the customer 120 which are provided on a discretionary basis.

In another instance, promotional material presented within the store 105 may be modified to target the particular customer 120. For example, the store 105 has three displays 140 used for displaying video or still promotional materials. On the basis of the location of the customer 120 within the store 105 as ascertained by the customer interaction system 100, the promotional material displayed on a particular display 140 (e.g. on the display nearest the customer 120) may be selected based on the customer 120's profile, e.g. to match a particular interest or purchase history of the customer 120.

In a particular use case that is purely exemplary, the customer 120 is a middle-aged family man who has a wife two teenage children. The customer 120 has entered the store with no particular goal in mind, but has stopped near the front to look at rock-climbing shoes that are on a shelf near a first display 141.

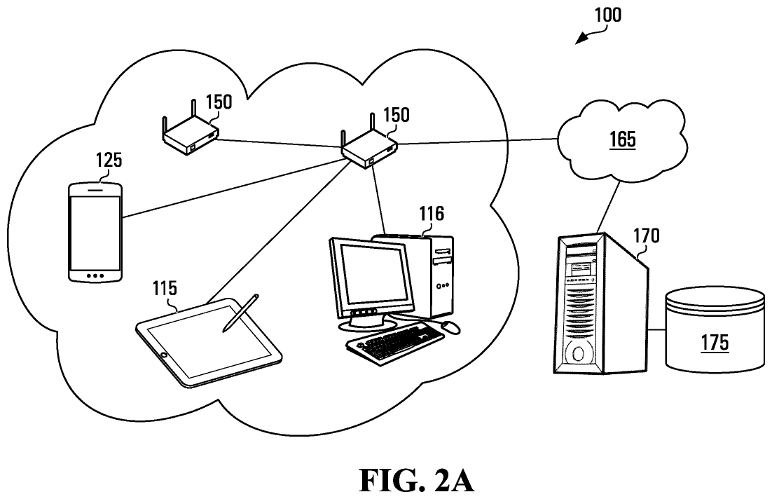

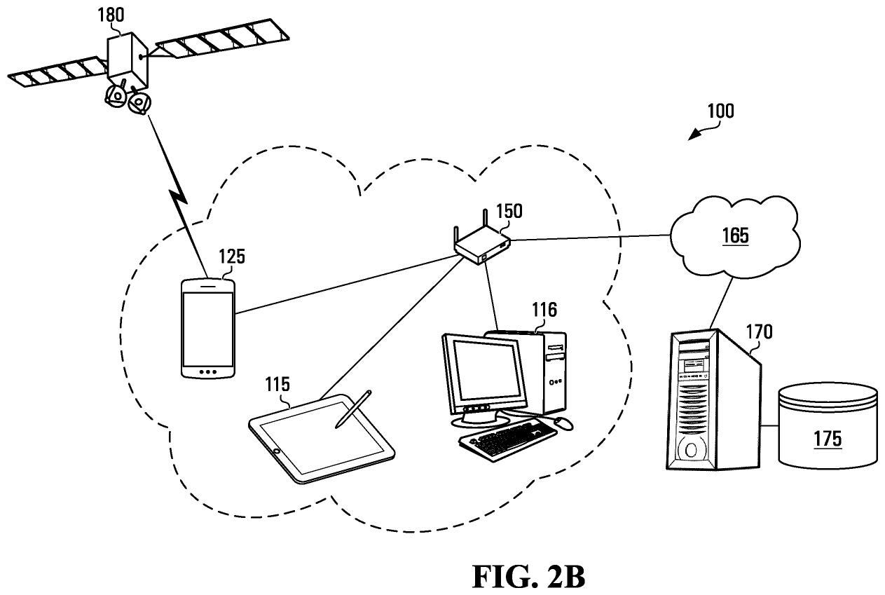

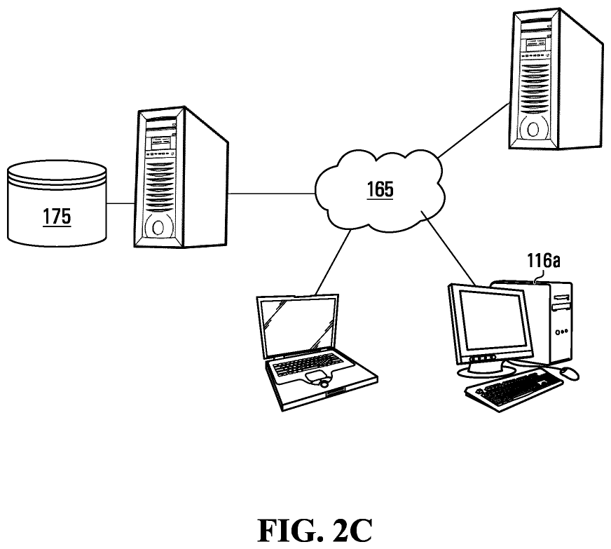

Turning now to FIG. 2A, this figure illustrates the customer interaction system 100 in a block diagram. As shown, the system comprises a system server 170 and a server storage 175. A local data network 160 is provided at the store 105, which in this case is a Wi-Fi™ network comprising one or more routers 150. The local data network 160 is connected to a public network, in this case the internet 165 which links equipment on the local network to the system server 170. In this example, the customer mobile device 125 and the in-store computing device 115 are both connected to the local network 160. The in-store computing device 115 used by the employee 110 is a mobile tablet, however there is in this example another in-store mobile device that is a computer 116, which is provided with the same capabilities and which can be used by another employee. In this example, the computer 116 also serves as cash register.

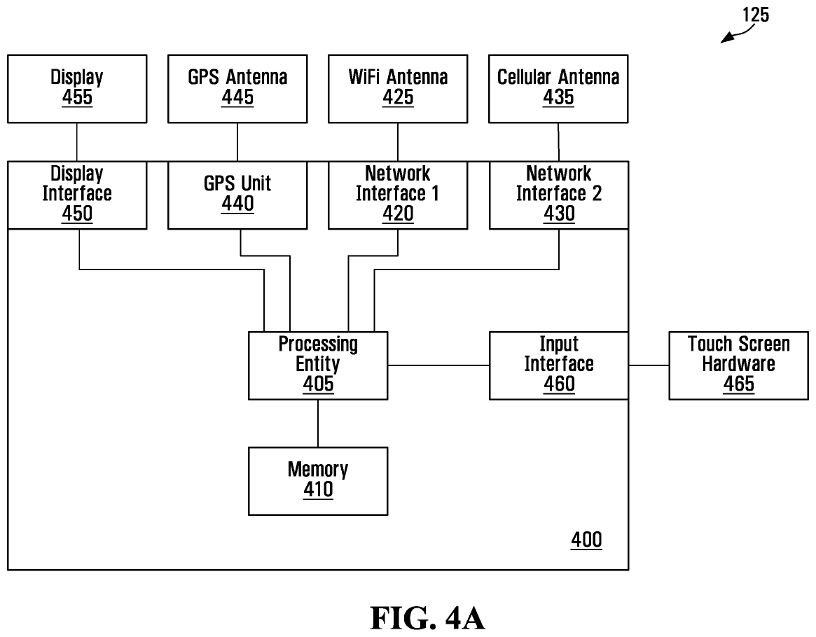

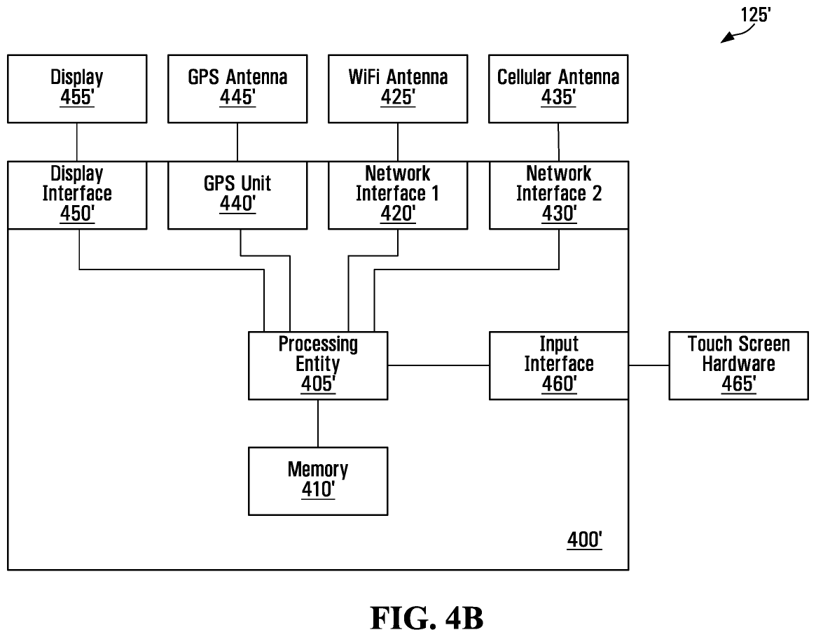

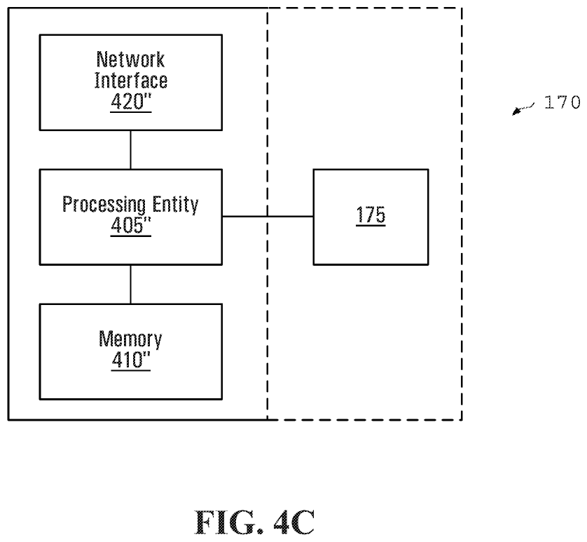

FIG. 4A is a block diagram of the customer mobile device 125. The customer mobile device 125 comprises computing hardware 400 which includes several computing modules including a processing entity 405, memory 420, a first network interface which in this example is a Wi-Fi™ interface 420, a second network interface which in this example is a cellular network interface 430, a GPS unit 440, a display interface 450, an input interface 460 and a Bluetooth™ interface. The customer mobile device 125 further comprises a Wi-Fi™ antenna 425, a Bluetooth™ antenna 475, a cellular antenna 435, a GPS antenna 445, a display 455 and touch screen hardware 465 for receiving input from a touch screen provided with the display 455.

The processing entity 405 comprises a general-purpose processing unit such as a multi-core CPU, which is configurable by computer-readable program instructions to perform certain functions as described herein. Although shown as unitary, it may comprise several cooperating processing units and may also be distributed. Although the processing entity 405 is shown separately here from the other computing hardware, it will be appreciated that the processing entity 405 may be provided on a multi-purpose chip or chipset that comprises dedicated hardware for implementing the functionality of other modules shown here separately. Likewise, certain modules of the computing hardware shown as separate from the processing entity 405 may be implemented partially or fully in software within the processing entity 405.

The memory 410 is a computer-accessible storage system in communication with the processing entity 405. The processing entity 405 is in communication with the memory 410 to retrieve therefrom, and write therein storage data. The storage data may include general data such as files, application data used exclusively by particular applications/programs, and computer-readable program instructions such as the ones implementing the customer application described herein. The memory 410 may be comprise random access memory, such as memory provided by one or more DDR3 chip or the like. Although the memory 410 is shown as a single unitary block for illustration purposes, the skilled person will understand that the memory 410 may be provided using multiple chips. Thus memory may comprise volatile and non-volatile units. Non-volatile memory may include extendable storage, for example in the form of SD card storage which may be disconnected from the device. Typically, software will comprise computer-readable program instructions and data stored in non-volatile memory, which may be transferred to volatile memory for execution or use by the processing entity. Thus, there may also be different layers of memory having different speeds for implementing a caching architecture.

The GPS unit 440 is a location unit that determines a location of the customer mobile device 125 and generates location data indicative of this location. In this example it is in electric communication with the GPS antenna 445 and receives therefrom GPS signals received at the GPS antenna 445 from multiple GPS satellites 180 and resolves therefrom a geographical location for the customer mobile device 125, and therefore for the customer 120 insofar as the customer 120 is presumed to be generally collocated with the customer mobile device 125. The GPS unit 440 is in communication with the processing entity 405 and provides thereto the geographic location in the form of geographic location data referred to herein as GPS data to avoid confusion with other types of geographic location data. In this example, the GPS unit 440 is provided on a separate chip than the general-purpose processor and is in communication with the processing entity 405 via a data bus. However, in embodiments wherein the GPS unit 440 is provided by dedicated hardware on the same chip, the communication may be via an internal bus or shared memory. In embodiments where the GPS unit 440 is provided in software by the processing entity 405, the communication between the GPS unit 440 and the rest of the processing entity 405, that is, between the GPS unit and other processes provided by the processing entity 405 may be entirely done by shared memory. Although in this example the GPS unit uses signals from the Global Positioning System satellite fleet, it should be understood that the GPS unit may be any positioning system including such using other satellite fleets instead of, or alongside, the American system, including the GLONASS system or the like. The GPS unit 440 may also comprise hardware to determine direction of gaze (e.g. compass hardware) or logic to derive direction of gaze (e.g. based on movement) or both.

The Wi-Fi™ interface 420 is in electric communication with the Wi-Fi™ antenna 425 and receives therefrom and outputs thereto signals exchanged over the Wi-Fi™ antenna 425 with a Wi-Fi™ router 150. The Wi-Fi™ interface 420 receives signals from the Wi-Fi™ antenna 425 and translates them into data which it provides to the processing entity 405. The Wi-Fi™ interface 420 also receives from the processing unit 405 data to be transmitted over the Wi-Fi™ network and generates a signal with which to drive the Wi-Fi™ antenna 425 to communicate the data. In this example, the Wi-Fi™ interface 420 is provided on a separate chip than the general-purpose processor and is in communication with the processing entity 405 via a data bus. However, a skilled person will understand any other possible configuration.

The cellular network interface 430 is in electric communication with the cellular antenna 435 and receives therefrom and outputs thereto signals exchanged over the cellular antenna 435 with a base station (not shown). The cellular network interface 430 receives signals from the cellular antenna 435 and translates them into data which it provides to the processing entity 405. The cellular network interface 430 also receives from the processing unit 405 data to be transmitted over the cellular network and generates a signal with which to drive the cellular antenna 435 to communicate the data. In this example, the cellular network interface 420 is provided on a separate chip than the general-purpose processor and is in communication with the processing entity 405 via a data bus. However, a skilled person will understand any other possible configuration.

The Bluetooth™ interface 470 is in electric communication with the Bluetooth™ antenna 475 and receives therefrom and outputs thereto signals exchanged over the Bluetooth™ antenna 425 with another device. In the present example, the Bluetooth™ interface supports Bluetooth Low Energy (a.k.a. BLE or Bluetooth Smart™) technology. The Bluetooth™ interface 470 receives signals from the Bluetooth™ antenna 475 and translates them into data which it provides to the processing entity 405. The Bluetooth™ interface 470 also receives from the processing unit 405 commands to be executed with respect to other Bluetooth™-enabled devices in communication with the customer mobile device 125 and data to be transmitted over the Bluetooth™ protocol and generates a signal with which to drive the Bluetooth™ antenna 475 accordingly. In this example, the Bluetooth™ interface 470 is provided on a separate chip than the general-purpose processor and is in communication with the processing entity 405 via a data bus. However, a skilled person will understand any other possible configuration. for example, it may be provided as a separate module on a system-on-a-chip (SOC) comprising the processing entity 405 and/or other modules of the customer mobile device 125.

The display interface 450, of which the skilled person will understand the implementations possible, is shown here as a separate hardware display driver for the display 455. The display interface 450 receives from the processing entity 405 data to be displayed on the display 455 and generates signals for driving the display 455, to which it is in electrical communication.

The input interface 460 comprises a touch screen interface which is in communication with touch screen hardware 465 which translates human touch to a signal which the touch screen interface translates to input data representing the human touch (e.g. localization on the touch screen). The input interface 460 is in communication with the processing entity 405 and communicates thereto the input data. The input interface 460 may also receive input from other sources such as buttons and process these inputs (e.g. de-bounce, etc. . . . ) to produce input data which it provides to the processing entity 405. Such functions may be provided by different hardware than the touch screen interface, and even by the processing entity 405 itself, although the input interface is shown here as unitary for convenience and simplicity.

The processing entity 405 of this example implements an operating system based on OS program code and data stored in the memory 410. The operating system controls various aspects of the computing performed by the processing entity 405 and may also manage access to data provided to the processing entity from the various computing modules and vice versa. The operating system of this example provides multi-tasking support for processes running on the processing entity 405 such that multiple other applications may run simultaneously or pseudo-simultaneously. The processing entity 405 may therefore run multiple applications which in this example are implemented by computer-readable instructions stored in the memory 410 executable by the processing entity 405 to configure the processing entity 405 to execute certain functions and methods including those described herein as coded by a skilled programmer in accordance with the description provided herein. operating system in an Android operating system.

FIG. 4B is a block diagram of the in-store computing device 115. The in-store computing device 115 may be similar to the customer mobile device 125 in that it is also an smart mobile device, although in this example it is a tablet rather than a phone. In this embodiment, the in-store computing device 115 comprises computing hardware 400′ which includes several computing modules including a processing entity 405′, memory 420′, a first network interface which in this example is a Wi-Fi™ interface 420′, a second network interface which in this example is a cellular network interface 430′, a GPS unit 440′, a display interface 450′ and an input interface 460′. The in-store computing device 115 further comprises a Wi-Fi™ antenna 425′, a cellular antenna 435′, a GPS antenna 445′, a display 455′ and touch screen hardware 465′ for receiving input from a touch screen provided with the display 455′.

The processing entity 405′ comprises a general-purpose processing unit such as a multi-core CPU, which is configurable by computer-readable program instructions to perform certain functions as described herein. Although shown as unitary, it may comprise several cooperating processing units and may also be distributed. Although the processing entity 405′ is shown separately here from the other computing hardware, it will be appreciated that the processing entity 405′ may be provided on a multi-purpose chip or chipset that comprises dedicated hardware for implementing the functionality of other modules shown here separately. Likewise, certain modules of the computing hardware shown as separate from the processing entity 405′ may be implemented partially or fully in software within the processing entity 405′.

The memory 410′ is a computer-accessible storage system in communication with the processing entity 405′. The processing entity 405′ is in communication with the memory 410′ to retrieve therefrom, and write therein storage data. The storage data may include general data such as files, application data used exclusively by particular applications/programs, and computer-readable program instructions such as the ones implementing the customer application described herein. The memory 410′ may be provided in the form of random access memory, such as memory provided by one or more DDR3 chip or the like. Although the memory 410′ is shown as a single unitary block for illustration purposes, the skilled person will understand that the memory 410′ may be provided using multiple chips. There may also be different layers of memory having different speeds for implementing a caching architecture.

The GPS unit 440′ is in electric communication with the GPS antenna 445′ and receives therefrom GPS signals received at the GPS antenna 445 from multiple GPS satellites 180 and resolves therefrom a geographical location for the in-store computing device 115, and therefore for the employee 110 insofar as the employee 110 is presumed to be generally collocated with the in-store computing device 115. The GPS unit 440′ is in communication with the processing entity 405′ and provides thereto the geographic location in the form of geographic location data referred to herein as GPS data to avoid confusion with other types of geographic location data. In this example, the GPS unit 440′ is provided on a separate chip than the general-purpose processor and is in communication with the processing entity 405′ via a data bus. However, in embodiments wherein the GPS unit 440′ is provided by dedicated hardware on the same chip, the communication may be via an internal bus or shared memory. In embodiments where the GPS unit 440′ is provided in software by the processing entity 405′, the communication between the GPS unit 440′ and the rest of the processing entity 405′, that is, between the GPS unit and other processes provided by the processing entity 405′ may be entirely done by shared memory. Note that the employee 110's location might not necessarily be used in every embodiment, and in some instances, the in-store computing device 115 may be immobile (such as in the case of computer 116) and as such the GPS unit may occasionally be omitted.

The Wi-Fi™ interface 420′ is in electric communication with the Wi-Fi™ antenna 425′ and receives therefrom and outputs thereto signals exchanged over the Wi-Fi™ antenna 425′ with a Wi-Fi™ router 150. The Wi-Fi™ interface 420′ receives signals from the Wi-Fi™ antenna 425 and translates them into data which it provides to the processing entity 405′. The Wi-Fi™ interface 420′ also receives from the processing unit 405′ data to be transmitted over the Wi-Fi™ network and generates a signal with which to drive the Wi-Fi™ antenna 425′ to communicate the data. In this example, the Wi-Fi™ interface 420′ is provided on a separate chip than the general-purpose processor and is in communication with the processing entity 405′ via a data bus. However, a skilled person will understand any other possible configuration.

The cellular network interface 430′ is in electric communication with the cellular antenna 435′ and receives therefrom and outputs thereto signals exchanged over the cellular antenna 435′ with a base station (not shown). The cellular network interface 430′ receives signals from the cellular antenna 435 and translates them into data which it provides to the processing entity 405′. The cellular network interface 430′ also receives from the processing unit 405′ data to be transmitted over the cellular network and generates a signal with which to drive the cellular antenna 435′ to communicate the data. In this example, the cellular network interface 420′ is provided on a separate chip than the general-purpose processor and is in communication with the processing entity 405′ via a data bus. However, a skilled person will understand any other possible configuration. Note that in some instances, the cellular network interface 430′ may be omitted, for example where the in-store computing device 115 is a Wi-Fi™-only tablet or where it is a non-cellular-enabled computer such as computer 116.

The display interface 450′, of which the skilled person will understand the implementations possible, is shown here as a separate hardware display driver for the display 455′. The display interface 450′ receives from the processing entity 405′ data to be displayed on the display 455′ and generates signals for driving the display 455′, to which it is in electrical communication. Note that in some instances the display might not be provided with and directly on the in-store computing device, such as in the case of a computer where the display is provided separately. In such cases, the display interface 450′ may take the form of a graphics card or chipset for driving an external display that is not provided as part of the in-store computing device.

The input interface 460′ comprises a touch screen interface which is in communication with touch screen hardware 465′ which translates human touch to a signal which the touch screen interface translates to input data representing the human touch (e.g. localization on the touch screen). The input interface 460′ is in communication with the processing entity 405′ and communicates thereto the input data. The input interface 460′ may also receive input from other sources such as buttons and process these inputs (e.g. de-bounce, etc. . . . ) to produce input data which it provides to the processing entity 405′. Such functions may be provided by different hardware than the touch screen interface, and even by the processing entity 405′ itself, although the input interface is shown here as unitary for convenience and simplicity. Note that in some instances, the input interface may be a different type of interface where the input device is not a touch screen. For example in the case of the computer 116, the input device may be a mouse and keyboard, in which case the input interface may comprise, for example, a hardware device interface (e.g. USB) and software for interpreting data received from a USB mouse and keyboard.

The processing entity 405′ of this example implements an operating system based on OS program code and data stored in the memory 410′. The operating system controls various aspects of the computing performed by the processing entity 405′ and may also manage access to data provided to the processing entity from the various computing modules and vice versa. The operating system of this example provides multi-tasking support for processes running on the processing entity 405′ such that multiple other applications may run simultaneously or pseudo-simultaneously. The processing entity 405′ may therefore run multiple applications which in this example are implemented by computer-readable instructions stored in the memory 410′ executable by the processing entity 405′ to configure the processing entity 405′ to execute certain functions and methods including those described herein as coded by a skilled programmer in accordance with the description provided herein. In this example, the operating system in an Android operating system.

FIG. 4C is a block diagram of the system server 170. The system server 170 comprises computing hardware including a processing entity 405″, core memory 420″ and a network interface 420″. The system server 170 may also include other modules such as input and output (e.g. display) modules but these are not shown here. Also shown is the server storage 175 which may be implemented within or externally to the server 170, as shown by the two possible dashed outlines of the server.

The processing entity 405″ comprises a general-purpose processing unit such as a multi-core CPU, which is configurable by computer-readable program instructions to perform certain functions as described herein. Although shown as unitary, it may comprise several cooperating processing units and may also be distributed. Although the processing entity 405″ is shown separately here from the other computing hardware, it will be appreciated that the processing entity 405″ may be provided on a multi-purpose chip or chipset that comprises dedicated hardware for implementing the functionality of other modules shown here separately. Likewise, certain modules of the computing hardware shown as separate from the processing entity 405″ may be implemented partially or fully in software within the processing entity 405.

The memory 410″ is a computer-accessible storage system in communication with the processing entity 405″. The processing entity 405″ is in communication with the memory 410″ to retrieve therefrom, and write therein storage data. The storage data may include general data such as files, application data used exclusively by particular applications/programs, and computer-readable program instructions such as the ones implementing the customer application described herein. The memory 410″ may be provided in the form of random access memory, such as memory provided by one or more DDR3 chip or the like. Although the memory 410″ is shown as a single unitary block for illustration purposes, the skilled person will understand that the memory 410″ may be provided using multiple chips. There may also be different layers of memory having different speeds for implementing a caching architecture. In particular, the memory 410″ may include large-capacity storage as provided by one or more hard disk drive, for example.

The server storage 175 is implemented in this example by a separate storage. Whereas the memory 410″ is local storage used for running the system server 175, the server storage 175 is an archiving storage storing uniquely archiving files such as customer profiles datasets, employee profile datasets (both of which described further herein) and the like. In this example, the server storage 175 is a separate bank of hard drives accessible through a high-speed bus. It will be understood, however, that both the server storage 175 and the memory 410″ are computer-readable memories and that in alternative architectures, they may both be implemented together. Likewise in other embodiments still, the server storage 175 may be networked storage located remotely over a network, such as cloud storage accessible over the internet. In such a case the processing entity 405″ may be in communication with the server storage 175 via the network interface 420″

The network interface 430″ is in electric communication with network equipment such as a router. In the present example, the network interface 430″ comprises a high-speed network card or cards that are in communication with a router providing a connection to the internet 165. The network interface 430″ exchanges data over the network (here, the internet 165) to which end it is connected to network physical infrastructure and receives therefrom and outputs thereto signals exchanged over the network. The network interface 430″ receives signals and translates them into data which it provides to the processing entity 405″. The network interface 430″ also receives from the processing unit 405″ data to be transmitted over the network and generates a signal with which to drive the network physical infrastructure to communicate the data.

The processing entity 405″ of this example implements an operating system based on OS program code and data stored in the memory 410″. The operating system controls various aspects of the computing performed by the processing entity 405″ and may also manage access to data provided to the processing entity from the various computing modules and vice versa. The operating system of this example provides multi-tasking support for processes running on the processing entity 405″ such that multiple other applications may run simultaneously or pseudo-simultaneously. The processing entity 405″ may therefore run multiple applications which in this example are implemented by computer-readable instructions stored in the memory 410″ executable by the processing entity 405″ to configure the processing entity 405″ to execute certain functions and methods including those described herein as coded by a skilled programmer in accordance with the description provided herein. In this example, the operating system in a Linux™-based operating system.

Although the system server 170 is implemented in this example as a single server device, it should be understood that its functionality may be distributed, for example over several such devices sharing access to network-based server storage 175 with workload distributed by a load-balancing server. The system server 170 and server storage 175 may be multiplied for redundancy using known techniques. Thus it will be also understood that the system server 170 may be implemented using cloud-based server services.

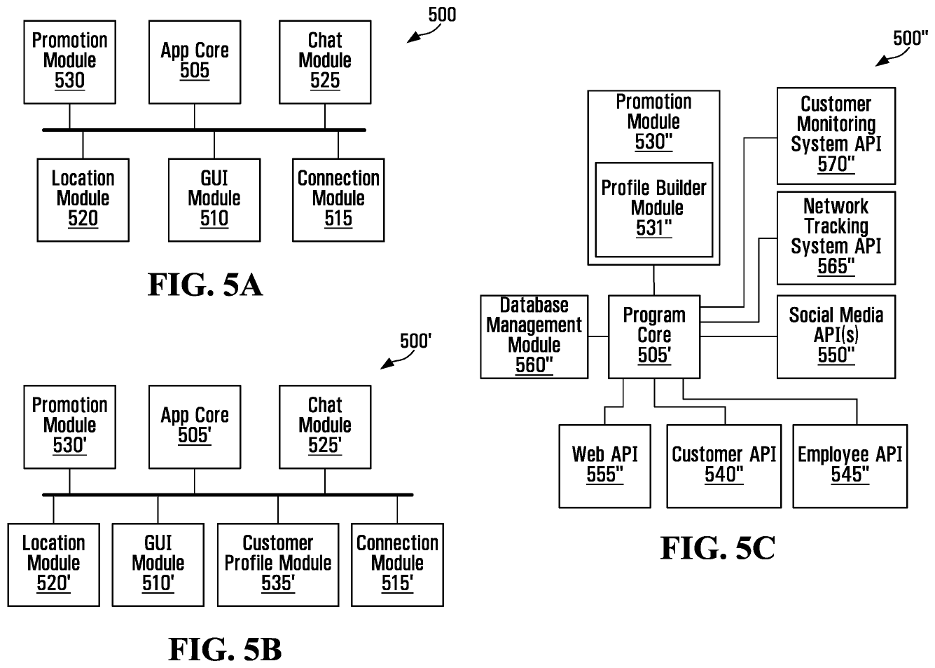

Among the applications implemented on the customer mobile device 125, is the customer application 500 of which a block diagram is provided in FIG. 5A. Although shown as a standalone application, as will be seen herein the customer application 500 may also be implemented as a web app. The customer application 500 comprises several program modules each of which comprising programming instructions for implementing various functions. The program modules are shown here as unitary blocks, although it will be appreciated that each block may comprise several sub-blocks, such as classes when implemented in a class-based programming language, which may be organized in one or more files during code-writing. Once compiled each module may represent a set of computer-readable instructions configuring the processing entity 405 by instructing it to perform the functions ascribed to the particular module as described herein. As shown, the customer application 500 includes an application core module 505, a GUI module 510, a connection module 515, a location module 520, a chat module 525 and a promotion module 530.

The modules of the customer application 500 are linked by access to application memory and by cross-module calls/instantiations. In the present example, the customer application 500 is programmed in the Java™ programming language. A class defined in one module executing a particular function germane to that module may call a method from another module when necessary. For example, the application core module 505 may call a method from the chat module 525 to initiate a chat while the location module 520 may store location information in a variable accessible to the connection module 515 which the latter uses to determine the establishment of a connection.

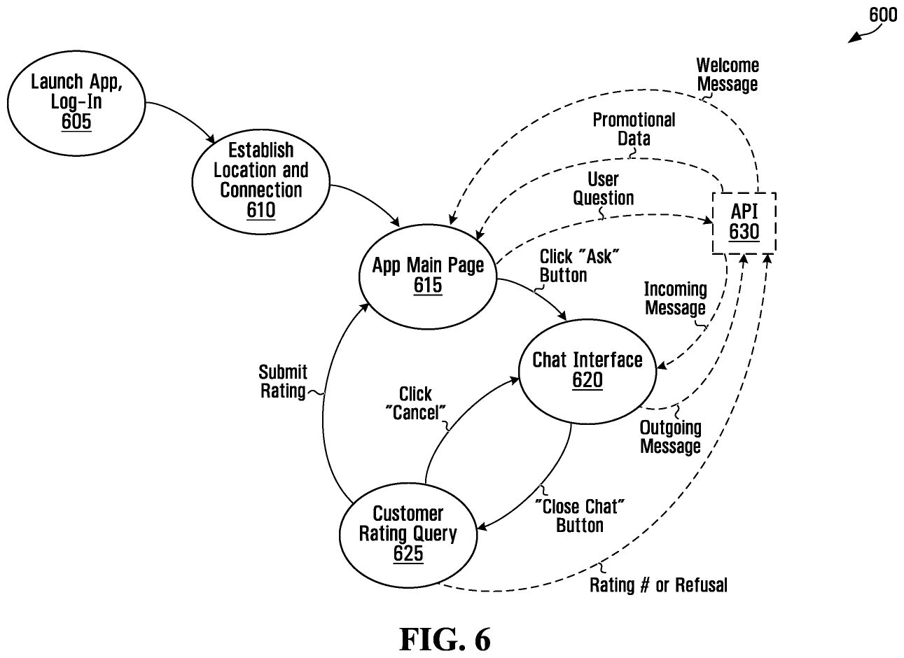

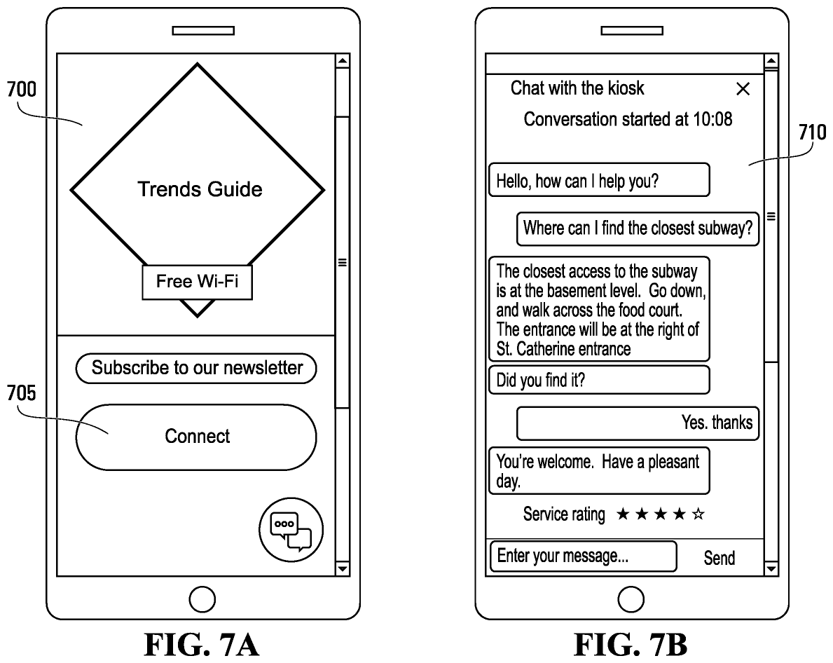

The application core module 505 comprises computer-readable instructions for implementing the backbone of the application, including the main process that is initiated upon startup. The application core module 505 implements a finite state machine 600 illustrated in FIG. 6. As shown, at the launch of the customer application 500, the core module 505 implements a login screen by causing the GUI module 510 to display a login screen 700 as shown in FIG. 7A.

The GUI module 510 comprises computer-readable instructions for implementing graphical user interface (GUI) elements of the customer application 500. To this end the GUI module 510 comprises code defining the layout and configuration of visual elements on the display. The code of the GUI module 510 also determines how user interactions are received. The GUI module 510 comprises instructions for the laying out of user-manipulable elements such as buttons, text boxes and the like and the like and for receiving user manipulations in return and triggering resulting events.

The location module 520 comprises computer-readable instructions for determining the geographic location of the customer 120 on the basis of the geographic location of the customer mobile device 125 to ascertain which store the customer 120 is in, if any, and optionally to ascertain the customer 120's location within the store. The location module 520 may utilize GPS data as derived by the GPS unit 440. To that end, the location module 520 comprises may communicate with the system server 170, e.g. via a dedicated customer-server communication API exploited by the connection module 515 (or alternatively by the application core module 505 or by another unshown server communication module), to exchange the GPS data, or more broadly coordinates data, or even more broadly location data, or derivatives thereof for a store identifier identifying the particular store 105 in which the customer 120 is location. Alternatively, the location module 520 may store or obtain on demand geographic locations or boundaries of different stores and compare the customer 120's geographic location with these to ascertain itself which store the customer 120 is located in.

In the present example, the location module 520 determines the customer's location on the basis of Wi-Fi™ data. In particular, the location module determines which Wi-Fi™ networks are in range and ascertains on the basis of the Wi-Fi™ networks detected and/or connected-to which store the customer is located in. In particular, when the customer 120 enters a store and the customer mobile device 125 is within range of the network 160 (or alternatively when it connects to the network 160), the location module 520 determines on this basis that the customer is located in the store 105, based on the knowledge that the particular network 160 is associated with the store 105. This end, the location module 520 exchanges Wi-Fi™ data with the system server 170 which stores in the server storage 175 concordances between Wi-Fi™ networks and stores and which resolves the store 105 and returns an identifier thereof to the customer mobile device 125. Additional information on the network 160, such as router IDs or MAC addresses or the like may also be used, particularly where a single network spans several store locations. It will also be noted that in alternative embodiments, the customer application 500 may be location-agnostic, being itself unaware of the particular store in which the customer 120 is located, but presenting nonetheless store-specific information as obtained from the system server 170 and/or in-store computing device 115. In such cases the location module 520 may serve principally to provide the system server 170 information required for resolving the customer 120's location.

The connection module 515 comprises computer-readable instructions for establishing a connection with the store 105's systems, including in-store computing device 115. In the present example, location resolving may be performed by the system server 170 as described. Once the location has been resolved to the store 105, the connection module 515 establishes a connection between the customer mobile device 125 and the in-store computing device 115. To this end, the connection module 515 comprises code for obtaining the coordinates of the employee 110 and/or in-store computing device 115. Particularly in this example, where communication between the in-store computing device 115 and the customer mobile device 125 takes place through the system server 170, the connection module 515 requests and receives from the system server 170 data identifying the employee 110, particularly a portion of an employee profile dataset described further herein, including an employee ID. In this example, communications destined to the employee 110 at the in-store communication device 115 are sent to the system server 175 with the employee ID as destination and the system server 175 resolves the destination device address to which to forward the communication.

Although in this embodiment communication between the devices is server-based, it should be understood that in alternate embodiment, they may be based on a peer-to-peer (P2P) communication protocol. In such a case, the connection module 515 may communicate with the system server 170 to obtain the data required to establish a P2P connection with the in-store computing device 115 and establishes such a connection.

The chat module 525 comprises computer-readable instructions for establishing a chat session with the in-store computing device 115 once the connection therewith has been established. The chat module 525 calls upon methods in the GUI module 510 to generate the necessary GUI elements such as a chat window and text input as shown in FIG. 7B. The chat module 525 also calls upon methods in the connection module 515 and may comprise methods called upon by the connection module 515 to transfer chat text input at the customer mobile device 125 using chat window as messages sent to the in-store computing device 115 and to receive as messages text likewise entered at the in-store computing device 115 for display on the customer mobile device 125. Although in this example the chat is text-based, in alternate examples, the chat may comprise sound (e.g. voice) exchanges and image (e.g. video) exchanges, in which case the chat module 525 may comprise the necessary codecs to encode and decode these inputs and the messages exchanged may comprise encoded audio and/or image data.

The promotion module 530 comprise computer-readable instructions for presenting promotional information to the customer 120 at the customer mobile device 125. To that end, the promotional module 530 communicates via method calls with the connection module 515 to receive from the system server 170 promotional data to be presented to the customer 120. Promotional data received may originate from the system server 170 or from the in-store computing device 115, however since in the present embodiment communications between the customer mobile device 125 and the in-store computing device 115 are server-based, this is received at the customer mobile device 125 from the server 170. In alternate embodiments, the promotional data may be received directly from the in-store computing device 115, e.g. via a P2P connection. The promotional module 530 also communicates with the GUI module 530, in this example by calling methods of the GUI module to display promotional data on the display of the consumer mobile device 125.

Among the applications implemented on the in-store computing device 115, is the employee application 500′ of which a block diagram is provided in FIG. 5B. Although shown as a standalone application, the employee application 500′ can also be implemented as a web app. The employee application 500′ comprises several program modules each of which comprising programming instructions for implementing various functions. The program modules are shown here as unitary blocks, although it will be appreciated that each block may comprise several sub-blocks, such as classes when implemented in a class-based programming language, which may be organized in one or more files during code-writing. Once compiled each module may represent a set of computer-readable instructions configuring the processing entity 405′ by instructing it to perform the functions ascribed to the particular module as described herein. As shown, the employee application 500′ includes an application core module 505′, a GUI module 510′, a connection module 515′, a location module 520′, a chat module 525′ and a promotion module 530′.

The modules of the employee application 500′ are linked by access to application memory and by cross-module calls/instantiations. In the present example, the employee application 500′ is programmed in the Java™ programming language. A class defined in one module executing a particular function germane to that module may call a method from another module when necessary. For example, the application core module 505′ may call a method from the chat module 525′ to initiate a chat while the location module 520′ may store location information in a variable accessible to the connection module 515′ which the latter uses to determine the establishment of a connection.

The application core module 505′ comprises computer-readable instructions for implementing the backbone of the application, including the main process that is initiated upon startup.

The GUI module 510′ comprises computer-readable instructions for implementing graphical user interface (GUI) elements of the employee application 500′. To this end the GUI module 510′ comprises code defining the layout and configuration of visual elements on the display. The code of the GUI module 510′ also determines how user interactions are received. The GUI module 510′ comprises instructions for the laying out of user-manipulable elements such as buttons, text boxes and the like and the like and for receiving user manipulations in return and triggering resulting events.

A finer positional determination is derived by the use a local positioning system. In the present example, positional beacons 190 are positioned throughout the store 105 which are used to determine the customer 120's location based on the customer mobile device 125's location, which itself is geolocated on the basis of the signals exchanged with the positional beacons 190. In the present example, the positional beacons 190 are iBeacons™, which communicate with the customer mobile device 125 using the Bluetooth™ low energy protocol. On the basis of the signals exchanged, the customer mobile device 125 establishes an approximate distance to iBeacons™ in range and transmits this information to the system server 170, which uses it to establish a location for the customer 120 in the store. In one example, the location established may simply be an identification of the nearest positional beacon 190, and indeed in the present example, each positional beacon 190 is positioned near a display 140, thus this information may be used to select a display 140 on which to display promotional content directed to the customer 120. Alternatively, relative distances to different positional beacons 190 may be used, alongside knowledge of the location of the positional beacons 190 within the store 105 to establish an approximate position for the customer 120 within the store. This information may be stored in the customer profile dataset 300 or in an active cash of customer profile data and be updated frequently. It may also be communicated from the system server 170 to the in-store computing device 115 to allow the employee 110 to see the position of the customer 120 (position display not shown but known map display techniques may be used) and thus to provide directional information during chat sessions, e.g. directions to find an item. Computing the location of the customer 120 may be done using any suitable positioning algorithm, and although in this example it is performed by the system server 170, in alternate embodiments this may be done at the customer mobile device 125 or the in-store computing device 115 provided the required data (e.g. beacon position information, beacon range, etc. . . . ) is suitably transferred.

The location module 520′ may be omitted from the employee application 500′ in certain embodiments, but in the present embodiment it is provided and comprises computer-readable instructions for determining the geographic location of the employee 110 on the basis of the geographic location of the in-store computing device 115 to ascertain where the employee 110 is, and more particularly where in the store 105 the employee 110 is. The location module 520′ may utilize GPS data as derived by the GPS unit 440.

The location module 520′ may further comprise computer-readable instructions for receiving location data indicative of the location of the customer mobile device 125, and therefore of the customer 120, within the store 105, and to display, for example by interacting with the GUI module 510′, e.g. by method calls or by sharing the location data in shared memory, to display on the display 455′ the location of the customer 120 in the store 105 to the employee 110. This may be displayed as a visual indicia, for example as an icon representing the customer 120 on a virtual map of the store 105.

The connection module 515′ comprises computer-readable instructions for establishing a connection with the customer mobile device 125. To this end, the connection module 515′ establishes a connection between the customer mobile device 125 and the in-store computing device 115. To this end, the connection module 515′ comprises code for obtaining the coordinates of the customer 120 and/or the customer mobile device 125. Particularly in this example, where communication between the in-store computing device 115 and the customer mobile device 125 takes place through the system server 170, the connection module 515′ requests and receives from the system server 170 data identifying the customer 120, particularly a portion of a customer profile dataset described further herein, including an employee ID. In this example, communications destined to the customer 120 at the customer mobile device 125 are sent to the system server 175 with the customer ID as destination and the system server 175 resolves the destination device address to which to forward the communication.

Although in this embodiment communication between the devices is server-based, it should be understood that in alternate embodiment, they may be based on a peer-to-peer (P2P) communication protocol. In such a case, the connection module 515′ may communicate with the system server 170 to obtain the data required to establish a P2P connection with the customer mobile device 125 and establishes such a connection.

The chat module 525′ comprises computer-readable instructions for establishing a chat session with the customer mobile device 125 once the connection therewith has been established. The chat module 525′ calls upon methods in the GUI module 510′ to generate the necessary GUI elements such as a chat window and text input as shown in FIG. 7B. The chat module 525′ also calls upon methods in the connection module 515 and may comprise methods called upon by the connection module 515′ to transfer chat text input at the in-store computing device 115 using chat window as messages sent to the customer mobile device 125 and to receive as messages text likewise entered at the customer mobile device 125 for display on the in-store computing device 115. Although in this example the chat is text-based, in alternate examples, the chat may comprise sound (e.g. voice) exchanges and image (e.g. video) exchanges, in which case the chat module 525′ may comprise the necessary codecs to encode and decode these inputs and the messages exchanged may comprise encoded audio and/or image data.

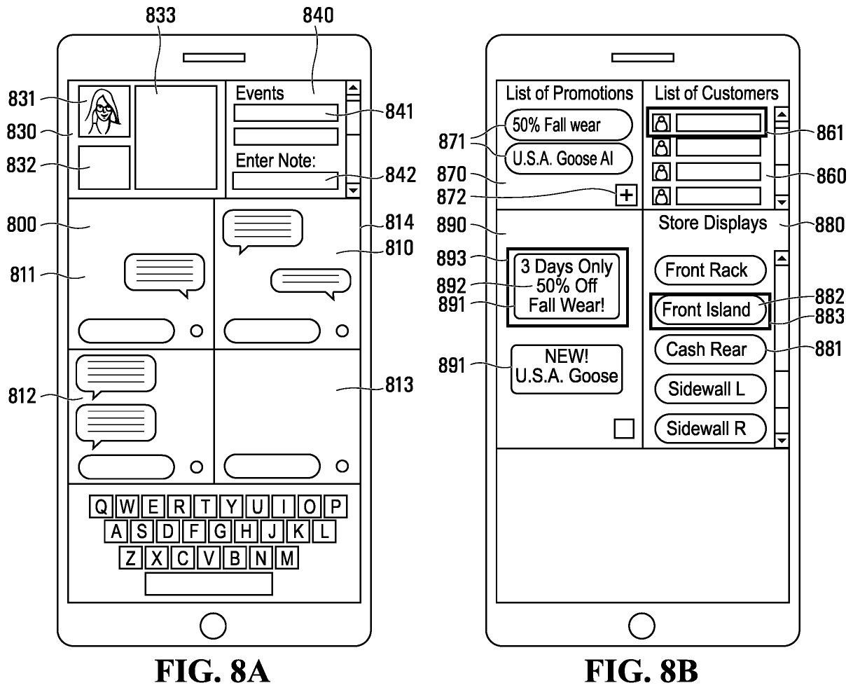

In the present example, the employee 110 can chat with multiple patrons simultaneously. To this end, the chat module 515 may include program code that can be instantiated multiple times so as to open multiple concurrent chat windows as shown in FIG. 8A, discussed herein.

The promotion module 530′ comprises computer-readable instructions for presenting promotional information to the customer 120 at the customer mobile device 125. In this To that end, the promotional module 530 communicates via method calls with the connection module 515′ to transmit to the customer mobile device 125 promotional data to be presented to the customer 120, in this example via the system server 170. Promotional data received may originate from the system server 170 or from the in-store computing device 115. For example, the system server 170 may store a collection of promotional material, e.g. provided by an administrator, which is transferred in whole or in reduced (e.g. thumbnail) form to the in-store computing device 115. This may be done upon connection or upon a request prompted by the promotion module 530′. The promotional material may be ads displayable on the customer mobile device 125 but may also include coupons or the like. A coupon may be similar to an ad and likewise displayable but may contain a barcode, QR code and/or alphanumeric code for a discount.

The promotional module 530′ selects promotional material (e.g. from amongst promotional material obtained from the system server 170, but alternatively promotional material (e.g. a discount code) entered by the employee 110) to be displayed to the customer 120. The promotion module 530′ may interface with the customer profile module 535′ (e.g. by accessing customer profile data in application memory that was obtained by the customer profile module 535′) and may select promotional material to cause to be displayed on the basis of customer profile data, e.g. as a function of a customer's activities or product interest as provided by the customer profile data. For example, the function may be to identify the promotional material that corresponding to an activity and/or product category for which the customer 120 has the higher interest score according to the customer profile data. This functionality, rather than to be provided by the in-store computing device 115, may be provided by the system server 170 by a similar promotional module provided thereon.

In the present example, the promotional module 530′ may select promotional material to cause to be displayed on the basis of employee input received at the input interface 460′ of the in-store computing device 115. To this end, the promotional module 530′ receives input from the employee via the GUI module 510 and selects promotional material to be displayed at the customer mobile device 125. For example, the employee 110 may notice that the customer 120 is eyeing a certain product or notice form the customer profile data that the customer has a strong interest in a particular product, and in response select an advertisement or a coupon for the product to be displayed at his device. Or in the course of a chat, the employee 110 can recommend a particular product and provide a coupon as added incentive.

Some or all of the promotional material may originate at the in-store computing device 115. In the present example, a bank of available promotional material is present in the server storage 175 and is provided to the in-store computing device 115 by the server 170 to be displayed at the in-store computing device 115. The promotion module 530′ implements an interface to allow the employee 110 to select from available promotional material to be presented to the customer 120 at the customer mobile device 125.

In the present example, the employee 110 may also originate promotional material. If an employee 110 wishes to offer a coupon (generally: a discount) to the customer 120, they may do so through a promotion interface created by access from the promotion module 530′ to GUI module 510′ which provides an input for identifying a product (e.g. enter a SKU) and a discount amount (e.g. a dollar value or percentage). This discount is communicated as promotion data to the customer mobile device 125 using calls to the connection module 515′ whereupon the promotional module 530 at the customer mobile device 125 causes a pop-up (via calls to the GUI module for the appropriate GUI components) to appear offering the discount. The promo input may also include fields for defining a recurrence (e.g. offer this discount to everyone who enters the store today) and the promotion module 530′ further comprises code for executing the transmission of the promotion data in accordance with the selected recurrence.

The customer profile module 535′ comprise computer-readable instructions for accessing and, in this example, modifying customer profile data which in this embodiment is stored in the server storage 175. The customer profile module 530′ uses the connection module 515′ to communicate with the system server 170 and receive therefrom customer profile data from the system server 170. In this particular example, when a connection is established between the customer mobile device 125 and the in-store computing device 115, the system server 170 verifies the permissions/authorizations associated with the requesting employee 110 and accesses in the server storage 175 the customer profile data accessible to the employee 110. In this example, this is done specifically by the program core 505″ that requests server storage 175 data by calling a function that accepts a requester identifier as argument and provides in returns the data which the requester is authorized to view. The customer profile module 535′ moreover interacts with the GUI module 510′, in this example by providing the customer profile data in a memory space accessible by the GUI module 510′ to display customer profile data selectively on the in-store computing device 115, in this example this is presented in a sub-window in response to a selection by the employee of the customer 120 from amongst a list of connected customers.

The customer profile module 535′ also comprises computer-readable instructions for modifying the customer profile data, in this example by adding details to the customer profile. In particular, the customer profile module 535′ interacts with the GUI module 510′ which presents to the employee 110 input GUI elements to receive input from the employee 110 to modify the customer profile data. In this particular example, the employee 110 may add notes via a text box provided by the GUI module 510′ and modify interest values for activities or products. Based on the modifications to the customer profile made by the employee at the in-store computing device 115, the customer profile module 535′ prepares and transmits a message to the system server 170 comprising the requested modifications, e.g. a note text or a data field value change, using the connection module 515′ in this example by calling methods in the connection module 515′ and providing thereto the data to be transmitted along with an identifier of the customer 120 to be transmitted with the data. In this example, modification of customer profile data may be done by directly interacting using GUI tools with the customer data displayed on the in-store customer device (e.g. by clicking on a value and typing a different one to change it or by entering a text note in the textbox provided), however in alternate embodiment, a form or the like may be brought up to submit customer profile data.

The memory 410″ of the system server 170 comprises computer read-able instruction executable by the processing entity 405″ to configure the processing entity 405″ to execute a server program 500″ illustrated in FIG. 5C. As shown, the server program 500″ comprises several program modules each of which comprising programming instructions for implementing various functions. The program modules are shown here as unitary blocks, although it will be appreciated that each block may comprise several sub-blocks, such as classes when implemented in a class-based programming language, which may be organized in one or more files during code-writing. Once compiled each module may represent a set of computer-readable instructions configuring the processing entity 405″ by instructing it to perform the functions ascribed to the particular module as described herein. As shown, the server program 500″ includes a program core module 505″, a promotion module 530″, a customer API module 540″, an employee API module 545″, one or more social media API modules 550″, web API module 555″, a database management module 560″, a network tracking system API 565″, and a customer relationship management system API 570″.

The Customer API module 540″ comprises computer-readable instructions for interacting with customer mobile devices such as customer mobile device 125, while the employee API module 545″ comprises computer-readable instructions for interacting with employee or store devices (or more generally with devices of clients of the customer interaction system 100) such as in-store computing device 115. In the present example the system server 170 implements an API for these devices comprising a protocol for communicating with the system server 170 and functionality that may be derived from the system server 170 by communicating therewith. Although in some embodiments a same set of code may be used to define communication with both customer and employee devices, in this example this has been split into two modules. Broadly speaking, the employee API module 545″ is a commercial API module, as the employees using the in-store computing device may not necessarily have individual accounts, as described herein. The in-store computing device 115 may be used by multiple employees. When the in-store computing device 115 is in communication with the system server 170, it is associated with a commercial account and accordingly with a commercial dataset (here the employee dataset 300′). The system server 170 recognizes this association on the basis of a suitable means. In the present example, the connection to the server 170 from the in-store computing device 115 comprises a log-in procedure identifying the particular employee 110 using the in-store computing device 115 and subsequent communications further identify the employee 110 or the session established at login, e.g. using a token system. In alternative embodiments, the in-store computing device 115 may be permanently associated with the employee 110, which may be identified, for example, from the originating IP address or the like. Similarly, when the customer mobile device is in communication with the system server 170, it is associated with a customer account and a customer dataset (here customer dataset 300). The system server 170 recognizes this association on the basis of a suitable means. In the present example, the connection to the server 170 from the customer mobile device 125 comprises a log-in procedure identifying the particular customer 120 using the customer mobile device 125 and subsequent communications further identify the customer 120 or the session established at login, e.g. using a token system. In alternative embodiments, the customer mobile device 125 may be permanently associated with the customer 120, which may be identified, for example, from the originating IP address or the like.

The customer API module 540″ employee API module 545″ comprise methods for communicating with the customer mobile device 125 and the in-store computing device 115 to exchange therewith requests and responses and also comprise logic in the form of computer-readable program code to execute related methods. For example, the customer API module 540″ employee API module 545″ comprise methods for receiving registration requests comprising registration information regarding a new customer or employee and communicates with the database management module 560, in this example by calling methods therein, to generate the corresponding data sets, described further herein. Likewise, the customer API module 540″ employee API module 545″ comprise logic for managing chat communications between customers and employees, e.g. between the customer 120 and the employee 110, to manage chat exchanges, including to receive chat messages from the customer mobile device 125 destined to the in-house computing device (and vice versa) and to identify the destination and forward the messages to their destination.

The customer API module 540″ and employee API module 545″ also include logic for other exchanges between the customer mobile device 125 and the system server 170 and between the in-store computing device 115 and the system server 170 described herein. For example, the employee API module 545″ of the present embodiment comprises logic for receiving instructions from the in-store computing device 115 to cause certain promotional material, e.g. a particular ad or coupon to be displayed at the customer mobile device 125 and the customer API module 540″ comprises logic for instructing the customer application 500 to display the corresponding promotional material, including logic to cause the transfer of the promotional material in question to the customer mobile device 125. the customer API module 540″ and employee API module 545″ of this example also comprises logic for receiving from either devices a request to create a new customer or employee profile, which includes standard validation logic as well as logic for receiving profile data and for using the database management module 560 logic (in this example by method calls) to create in the server storage 175 a new profile dataset as described herein for the customer or employee in question.

Either API modules may also implement different levels of permission for different functions available through the API. In the present example, every user is associated with a user ID which is included in the communications to the system server 170 in order to be recognized. Each user ID is associated with a profile type (e.g. customer or employee) each type being associated with certain functions available to the user (e.g. employees may request promotional data to be displayed to a user who is in their store, but not to a user outside their store, while customers have no such ability at all). In addition, each user ID may also be associated with a profile sub-type associated with different permissions. In the present example, employees have different sub-types (e.g. manager, salesperson and administrator) indicated in their profile dataset which have different permissions associated therewith. A salesperson may be authorized to engage in a chat with a customer but not to issue a discount beyond what is available for selection by the employee 110 in the available promotional material stored in the system storage 175. Any attempt to use the API-defined request for the issuance of a discount will be denied if associated with an unauthorized employee subtype. Managers, on the other hand are permitted to originate new promotion material using the described interface to provide a particular discount to a customer on an ad-hoc basis. Administrators may be able to make changes to other accounts of other employees by requesting changes to their profile dataset.

The one or more social media API module 550″ comprises computer-readable program instructions for interfacing with social media APIs to communicate profile data and associated data between a respective social media server and the system server 170. In the present example, during sign-up or sign-in, users may use a social media login in a widget provided in the customer application 500 and/or employee application 500′, whereupon the corresponding social medial API module 550″ confirms the identity of the user and downloads available shared data on the user to populate therewith the corresponding user profile dataset. This may include data indicative of activities and products like by the user. In one example, a social media API module 550″ communicates with a social media server (not shown) using a social media API to obtain public posts and interest data for a particular customer, whereby customer posts are mined to identify expressions corresponding to particular interests or products (in this example, this is done using a correspondence list although other intelligent algorithms may be used). Expressions may include keywords or keyphrases, but also links, e.g. to YouTube™ videos that are known, according to the correspondence list (or alternatively to another intelligent algorithm, such as one based on keywords in the video description and links to/in the video) to correspond to a particular activity or product. Identified activities of interest are then indicated in the customer's profile by incrementing the value for that interest, shown in more detail herein. Likewise, indicator-of-interest data (e.g. data representing “likes”, “favorites”, or “pins” by the user) is likewise mined to identify things which correspond to an activity or product.

The promotion module 530″ comprises computer-readable instructions to manage access to promotion data, including transmitting promotion data representative of promotional material to the in-store computing device 115 for display there (e.g. to display a list of available material) and transmitting promotion data (e.g. banner ads to display) to the customer mobile device 125 for display thereat. This may be done by suitable inter-module communication, in this example by calling methods of the employee API module 545″ and of the customer API module 540″ to cause the transmission of data. The promotion module 530″ also communicates with the employee API module 545″ (in this example by having methods called thereby) to interprets communications from the in-store computing device 115 providing instructions to transmit particular promotional data to the customer mobile device 125 for display thereat, and in response identifies the proper promotion data and communicates it as described.

The promotion module 530″ comprises a submodule called the profile builder module 531″, which itself comprises a subset of the computer-readable instructions of the promotion module 530″.

The database management module 560″ comprises computer-readable instructions for managing access to the server storage 175. The database management module 560″ comprises methods for creating new dataset, modifying datasets (e.g. by adding data thereto), reading datasets, and even deleting datasets. These methods incorporate authorization verification to verify that the originating requestor, on the basis of an identifier provided with the request has authorization to perform the requested function. Verifying authorization may involve accessing the dataset corresponding to the requestor in the server storage 175 to identify the authorizations associated therewith before servicing the request. Token systems may be used. The methods of the database management module 560″ are made available to other modules, in this example by being callable by other modules.

The Web API module 555″ comprises computer-readable instructions to interface with a web server 205, including code to receive (e.g. via the network interface 420″) and interpret messages, including requests, instructions and information messages, from the web server and code to generate messages, including requests, instructions and information messages, for the web server and to transmit them thereto (e.g. via the network interface 420″). The Web API module 555″ also includes computer-readable program instructions to query the server storage 175 and access the databases therein to retrieve data therefrom and input data thereto in the manner described herein. The API module 555″ defines a communication protocol for communications between web servers and the system server 170, including defining messages exchanged therebetween and their significance, including requests, instructions and other messages. The API module 555″ defines the structure of the messages exchanged, e.g. how customer profile data, promotional data and response data and other reports is represented in the server-to-server messages. The API module 555″ also defines what kind of requests may be made to the system server 170 and how they are services/responded to, what kind of requests the system server may make of the web server 205 and how it should be serviced/responded to, what instructions each server may send the other and how to service/respond to them, and what kind of information may be transferred between servers; in each case defining how the message is to be structured so as to be mutually intelligible. The skilled person will appreciate the protocols that may be used for server-to-server communication and how to put them to practice in the manner described herein.

The network tracking system API module 565″ comprises computer-readable program instructions for interfacing with a network tracking system 1405 to receive therefrom data being tracked on one or more particular networks. The network tracking system API module 565″ may comprise code for communicating with a network tracking system 1405 using a network tracking system API using an agreed-upon protocol for such communications. In one particular embodiment, the network tracking system API module 565″ is configured to receive network tracking data from a network tracking system 1405. Network tracking systems may be implemented with a network architecture to track various activities in a network. In one particular embodiment, the network tracking system 1405 is a system that track the location of network-connected devices over a multi-node network, such as a multi-access point WiFi network. A network tracking system may ascertain a position for a connected device at multiple points in time over multiple cells using the network equipment (e.g. WiFi access points), e.g. using triangulation, signal strength, etc. . . . . In one example, the network tracking system 1405 is the Cisco™ Connected Mobile Experiences (CMX) system. The network tracking system API module 565″ may be adapted to receive communications from the network tracking system 1405 comprising information about connected devices and/or users associated therewith. These may be pushed by the network tracking system 1405 or may be pulled by request sent by the server program 500″ via the network tracking system API module 565″.

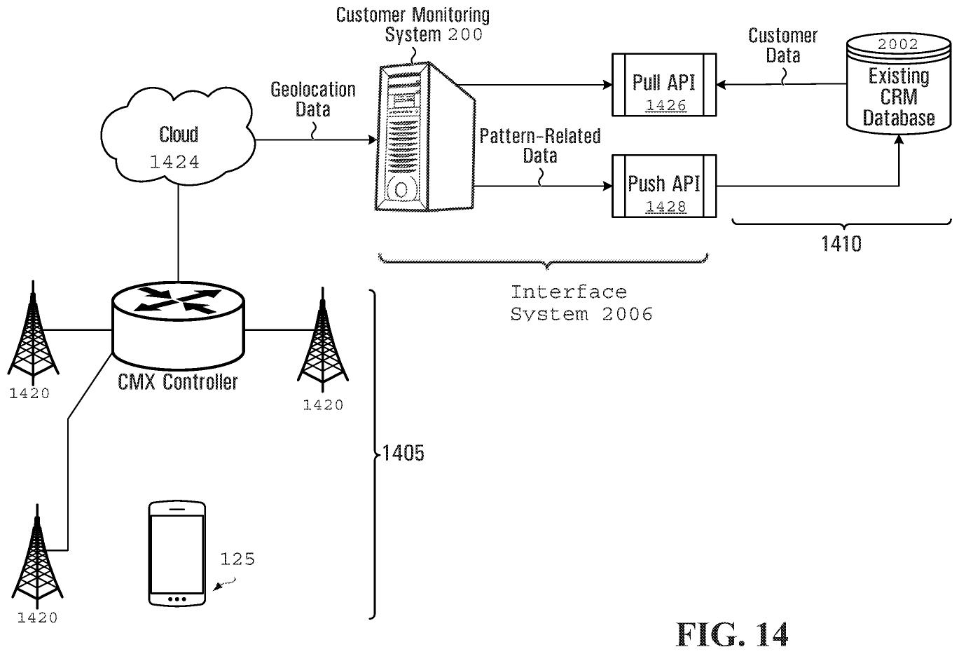

In one embodiment, a network tracking system 1405 transmits at a recurring occasion to the system server 170 implementing a customer monitoring system 2000 a data message comprising location information for a mobile device or user. The data message in this example is transmitted at a regular frequency (e.g. once per minute) and comprises location data for all currently detected/tracked devices on a network. However, in alternate examples, data messages may be sent individually for individual tracked devices and/or may be transmitted in response to particular stimuli, such as in response to a particular distance moved by a device, e.g. since a last position transmitted. FIG. 14 illustrates an exemplary customer monitoring system 2000.

The network tracking system 1405 in this example tracks network-connected devices, although it may include a user database or the like, linking devices to particular users of their network. In this manner, an individual may be associated with multiple devices by the network tracking system 1405 which may track the location of such a user based on a detected location of one or more device associated with the user. As a result, depending on the configuration of the network tracking system 1405, the data message may identify devices by a user ID associated with a user, which may be a user tracking ID specific to the network tracking system 1405. Alternatively, the user track ID's used by the network tracking system 1405 may be a device ID (e.g. MAC address, Android™ device ID, and/or IMEI number). The customer interaction system 100 may include a reference dataset referencing user tracking ID's from the network tracking system 1405 with particular customers, or related ID's, of the customer interaction system 100. In one particular embodiment, such a reference dataset is stored in server storage 175, and more particularly in the customer profile database. In particular, in one example, each customer profile dataset 300 may comprise one or more data entries identifying devices and accounts associated with the respective customer, e.g. in the customer ID data 305. In one example, there are fields for one or more device ID (e.g. MAC address, Android™ device ID, and/or IMEI number) of a mobile device associated with the account (e.g. associated with the customer mobile device 125 on which the customer app 500 is installed), as well as a field for a user tracking ID used by the network tracking system 1405. When a data message is received from the network tracking system 1405 containing location data for respective devices which are identified by user tracking ID's, the customer interaction system 100, e.g. the server program 500″, e.g. at network tracking system API module 565″ may parse the data message to derive subportions comprising location information for individual devices and parse these subportions to find the user tacking ID and accesses the reference dataset to identify a related customer, e.g. by searching the customer profile database to identify a customer profile dataset 300 having the user tracking ID in the customer ID data 305.

The customer interaction system 100 may populate the customer database with customer tracking ID in any suitable way. In one particular embodiment, the server program 500″ populates the customer profile database with user tracking ID's by associating the MAC address of customer mobile devices with the customer profile associated with the login credentials supplied by the users of customer mobile devices. Moreover, the server program 500″ may also create associations with new user tracking IDs (e.g. IDs specific to the network tracking system 1405) if such are received alongside known user ID's (e.g. MAC addresses) in the data messages received from the network tracking system 1405.

Although only one network tracking system API module 565″ is shown here, there may be multiple such modules for interacting with different network tracking systems, which may each have respective APIs, or one module may be adapted for communicating with different network tracking systems.

The customer relationship management system API module 570″ comprises computer-readable program instructions for interfacing with a customer relationship management system 1410 to provide thereto customer-related data derived by the customer interaction system 100. The network tracking system API module 565″ may comprise code for communicating with a customer relationship management system 1410 using a customer relationship management system API using an agreed-upon protocol for such communications.

The customer relationship management system 1410 may be any system which monitors customers or is used to assist in the maintenance of good customer-business relationship. Such systems and related services may be referred to as CRMs for short. In one example, the customer relationship management system 1410 is a Salesforce™ system.

The customer relationship management system API module 570″ may generate contribution messages comprising information about one or more particular customer to the customer relationship management system 1410. The customer relationship management system 1410 may identify customers with respective customer monitoring ID's such as unique CRM account ID's, telephone numbers, name and address combinations, etc. . . . . The contribution messages may identify customers using customer monitoring ID's used by the customer relationship management system 1410. The customer interaction system 100 may include a reference dataset referencing customer monitoring ID's from the customer relationship management system 1410 with particular customers, or related ID's, of the customer interaction system 100. In one particular embodiment, such a reference dataset is stored in server storage 175, and more particularly in the customer profile database. In particular, in one example, each customer profile dataset 300 may comprise one or more data entries identifying devices and accounts associated with the respective customer, e.g. in the customer ID data 305. In one example, there may be a field for one or more customer monitoring ID associated with the account, and/or other identification fields (e.g. phone number) which may be used by the customer relationship management system 1410 to identify customers. When generating a contribution message for the customer relationship management system 1410 containing data for a respective customer, the customer interaction system 100, e.g. the server program 500″, e.g. at network tracking system API module 565″ may lookup the customer monitoring ID in the reference dataset (which in this example may be implemented by the customer profile database) to and incorporate within the contribution message the customer monitoring ID used by the customer relationship management system 1410.

In this particular example, contribution messages are created and transmitted to the customer relationship management system 1410 in response to the detection of a particular relevant information (e.g. detected relevant behavior pattern) about individual customers and each concern individual customers. However, in other embodiments, the customer interaction system 100, e.g. the server program 500″, may digest several relevant informations detected about several respective customers together into a single multi-customer contribution message containing multiple entries, e.g. one per customer or one per detected relevant information, each being associated with a particular customer monitoring ID obtained as described and provided with the entry.

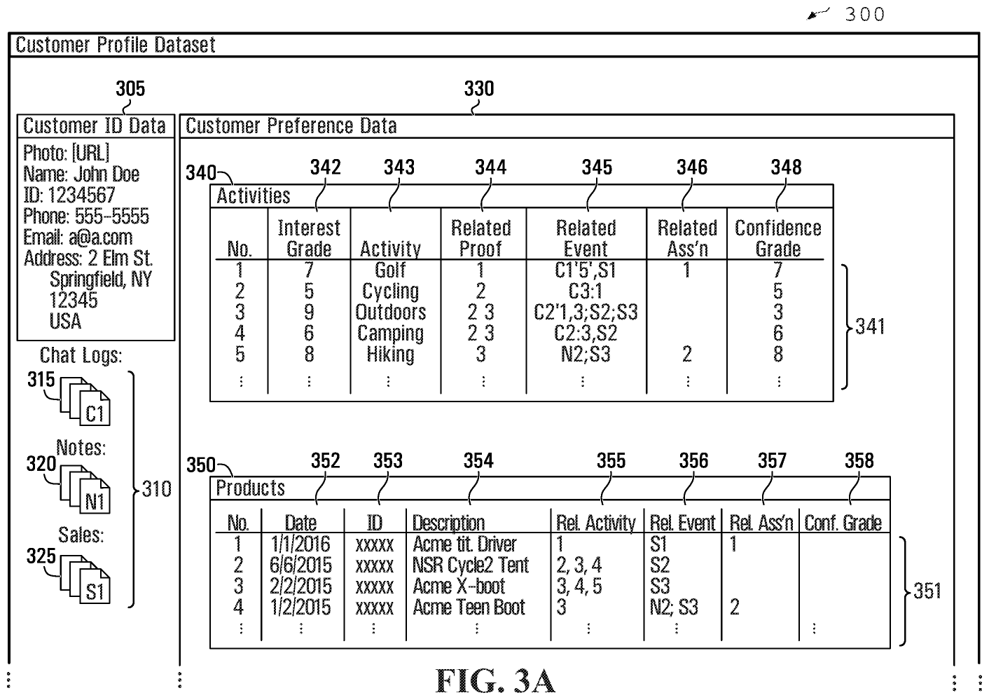

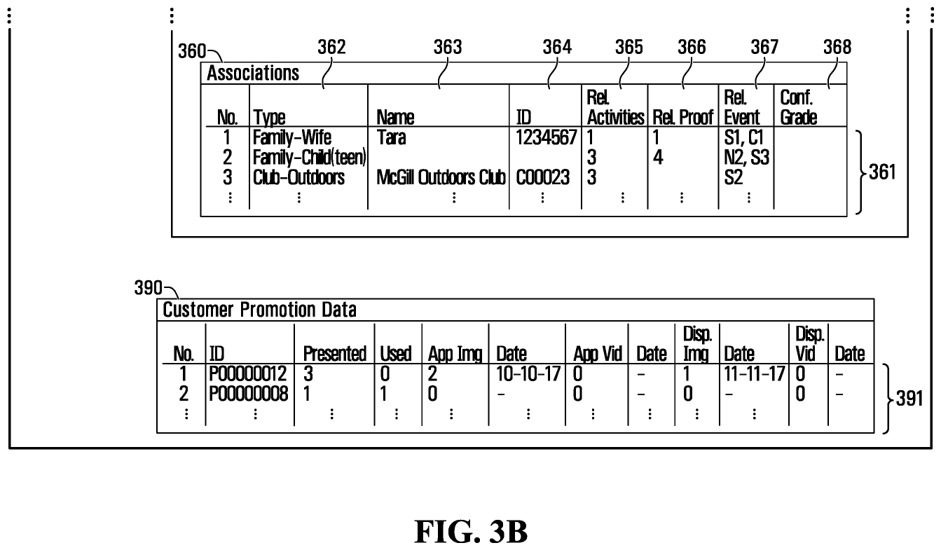

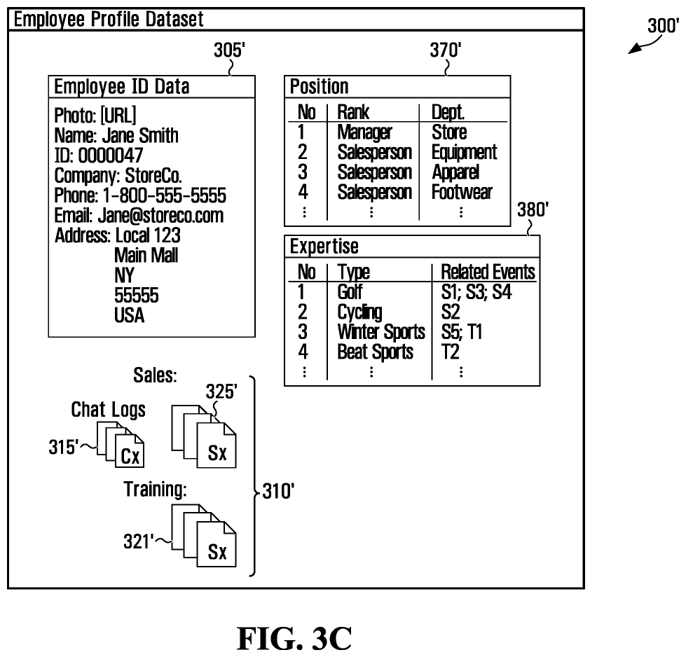

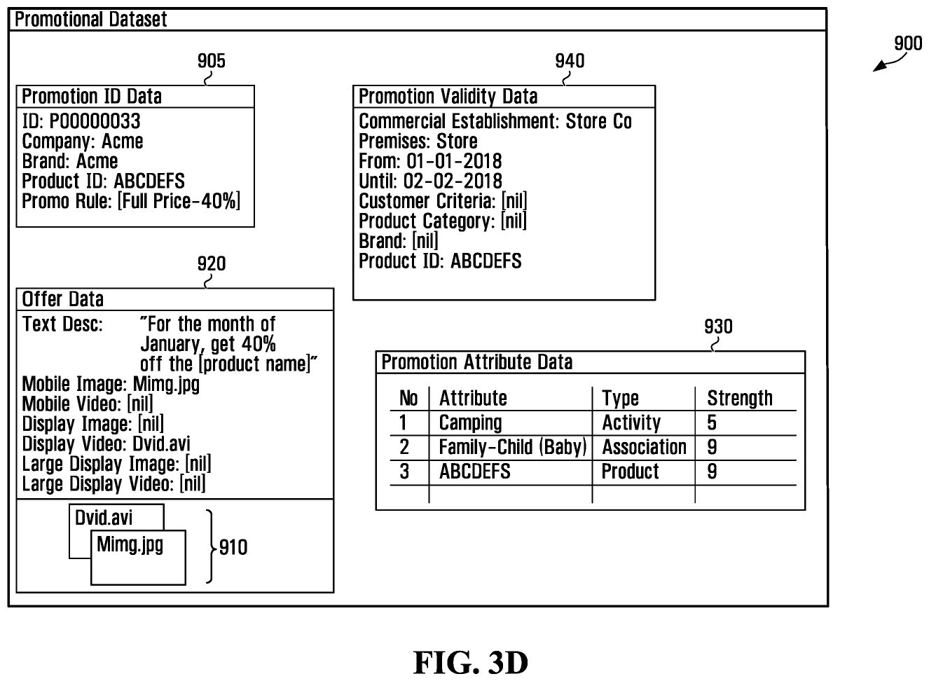

FIG. 3A shows a representative block diagram of an exemplary instance of a customer profile dataset 300 stored in the server storage 175. The server storage 175 comprises a relational database storing data used by the customer interaction system 100, including customer profiles, employee profiles, promotional data, and the like. In the present example, the server storage 175 comprises user profiles including customer profiles and employee profiles that are stored as datasets, which comprise data relating to the particular user including the data described herein. Relationships between the datasets and/or data within the user profile datasets are built into the database structure, in this example as stored relational information.

The customer profile dataset 300 shown here corresponds to the customer 120 in the store 105. A similar dataset exists for other customers registered in the customer interaction system 100. Customer profile datasets are described here with reference to this particular example in order to better illustrate the system, however it will be appreciated that the particular contents and form of the customer data may vary according to the particular customer and the particular implementation of the system.

The customer profile dataset 300 comprises customer identification data 305. the customer identification data 305 comprises data identifying and related to the identity of the customer 120. In this particular example, the customer identification data 305 includes a name (here a single field, but could be split), an ID number, a phone number, an e-mail address and a physical address. Each of these fields define a variable or data structure of appropriate type to contain the desired information. In this example, the ID is a string that comprises a portion holding a unique identifier associated with the customer 120 and also comprises portions holding unique identifiers associated with linked social media accounts for use by the social media API(s) 550″. The customer identification data 305 also comprises a photo of the customer, which in this example is provided by a URL pointing to a photo, although in other examples a photo file may be included or pointed to. The customer identification data 305 may also include other customer characteristics, including for example a “status” identifier which may identify a tier to which the customer belong. This status may be displayed to store employees communicating with the customer simply as information on the customer, or it may be used to establish a priority with which to serve the customer.

In the present example, when a connection is established between the customer mobile device 125 and the in-store computing device 115, the system server 170 transmits to each device the photo (or rather, the link thereto which the respective apps use to download the photo) of the other user such that the customer may see who they are chatting with and such that the employee may quickly find the customer if assistance is necessary.

The customer profile dataset 300 also comprises sets of files 310 pertaining to the customer 120. In this particular example, the sets of files 310 are actually reference pointers pointing to files stored elsewhere in the server storage 175.

The set of files 310 comprise chat logs 315 which are files containing the text transcript of previous and ongoing chats. After the customer API module 540″ and the employee API module 545″ establishes a connection between the employee 110 and the customer 120 via the in-store computing device 115 and the employee mobile device 125, the program core module 505″ calls upon a method of the database management module 560″ to create a new chat log and populates the file with data pertaining to the customer 120 and employee 110 and other data such as time, date and place, in a header in the file. The program core module 505″ then relays chat messages between the customer 120 and the employee 110. As it does it accesses each communicated message and stores the contents thereof in the chat log it has created.

The set of files 310 also comprises notes 320. These are employee-generated notes containing information that other users, typically employees, have noted about the particular customer. In particular, the upon receiving at the system server 170 customer profile data from the in-store computing device 115, e.g. in the manner described herein, the application core 505″ may interact with the database management module 560″ to cause the modification of the pertinent fields or addition of new data in the customer profile dataset 300. In this example, the program core module 505″ calls a method in the database management module 560″ and passes it the employee ID associated with the message received containing the customer profile data and the customer profile data contained in the message. If the employee is authorized to make the requested change, the database management module 560″ applies the changes in the system storage 175. If the requested change was the addition of a note, then anew file may be created comprising a header which the database management module 560 populates with the employee ID of the employee 110 and other metadata such as the time of day, date and location/store 105 where the note was taken. The file body is populated with the content of the note.

The set of files 310 also comprises records of purchases, or sales from the store 105's perspectives, attributed to the customer 120. The records of sales 325 of this example are files comprising receipt information, including metadata regarding the time, date and place/store of purchase, payment type information, as well as an itemized list of items purchased and the corresponding price. Discount data indicative of discounts provided on the items purchased may also be stored in the records of sales 325, which can help identify trends in the shopping style of the customer 120.

The customer profile dataset 300 also comprises customer promotion data 390 which contains information about the promotional offers which have been presented to the customer 120. The customer promotion data 390 in this example comprises a table comprising different entries 391, here numbered consecutively. Each table entry 391 in this example corresponds to a promotional offer, and comprises fields for each medium of presentation through which the customer 120 was presented the promotional offer containing the number of times it was presented and a related field with the date of most recent presentation. Different media include on the customer mobile device 125 in the customer app 500 by static image, chat (personal) description, or by video ad, on and the displays 140 by static image or video ad. In other embodiments, different medias may also include an e-mail transmission, telemarketing calls, and where online activity is also tracked by the system, online ads optionally with a field for the website or internet service (e.g. ad-enabled mobile app) through which it was displayed. In this example, the table entries 391 also include a field for the overall number of times the promotional offer was presented to the customer 120. The table entries 391 also include a field for the number of times, if any, the promotional offer was redeemed or used. In the present example where promotions are for sellable items and promotional offers may be applicable to a sale of an item, this corresponds to number of item purchases to which the promotional offer was applied, if indeed the promotional offer can be applied to a sale. The present structure and contents of the customer promotion data 390 is merely exemplary and it will be appreciated that it can be modified as desired to add more or fewer details depending on the requirements and features desired for the system.

The customer profile dataset 300 also comprises customer preference data 330. The customer preference data 330 comprises customer attribute data indicative of the customer's preferences. Customer attributes are attributes of customers that are indicative of their purchasing preferences, in the case of a store, or other consumption/commercial preferences for other business types. Customer attributes may include activities in which they are known to partake, product types they have been known to purchase or have demonstrated interest in purchasing, and associations that might inform purchasing/consumption decisions such as family members they may shop for or clubs to which they belong. In the present example, these customer attributes are categorized into three types, namely activities, products and association, each of which are stored in respective data structures, however additional types or different type breakdowns could be used, and in one alternative example, all customer attribute data for all attribute types are stored in a single data structure with entries including the definitions required to identify the type of attribute concerned. The customer preference data 330 in this example derived by the customer interaction system 100. In particular, in this example, the customer preference data comprises activity preference data 340, product data 350 and association data 360, all of which provide useful information about a customer's habit (e.g. shopping habits), and potential future transactions.

The activity preference data 340 comprises information about the customer 120's activities. In this example, the activity preference data 340 comprises a table comprising different entries 341, here numbered consecutively, each table entry 341 comprising an interest grade 342 an activity identifier 343, a related products field 344, a related events field 345, a related association field 346 and a confidence grade 348.

The product data 350 comprises information about the customer 120's products of interest. Although in other embodiments, this table may include products for which the customer 120 has expressed interest (based on the same alogrithmics used to determine interest in activities), in this example, the product data 350 comprises data for products that the customer 120 has purchased. In this example, the product data 350 comprises a table comprising different entries 351, here numbered consecutively, each table entry 351 comprising a date field 352 for the corresponding sale, a product ID field 353 comprising a product identifier (e.g. a SKU), a description field 354 providing a textual description of the product for quick reference, a related activity field 355, a related event field 356, a related association field 357, and a confidence grade 358.

The association data 360 comprises information about the customer 120's associations. This includes other individuals or entities (clubs, businesses) with which the customer 120 has been found to be associated in a manner pertinent to their commercial activities. This may include family members the customer 120 may shop for and clubs the customer 120 belongs to. In this example, the association data 360 comprises a table comprising different entries 361, here numbered consecutively, each table entry 361 comprising a type filed 362 indicating the type of association, a name field 363 storing the name of the associated entity, if available, an ID field 364 storing an identifier of the profile dataset of the associated entity, a related activities field 365, a related products field 366, a related events field 367, and a confidence grade 368.

The interest grade 342 field comprises an indicator of a strength of the interest of the customer 120 for that particular activity as ascertained by the customer interaction system 100. The interest grade 342 also represents a level of confidence in the customer 120's interest in the particular activity. As such, in this example, the interest grade 342 and level of confidence 348 have the same values and one of these fields could be omitted, although both are shown here for illustration purposes. The strength of the interest is calculated on the basis of employee input, social media activity, chat conversations, and purchasing events, although other/different inputs may be used to compute the interest grade 342. The stronger the interest found, the more confidence is associated with the customer 120 having being associated with the related activity and therefore the higher the confidence level. Likewise, the lower the strength, the lower the confidence that the customer 120 is indeed associated with the related activity and therefore the lower the confidence score.

The confidence score is also present in the other customer attribute data entries, namely in the entries of the product data 350 and associate data 360. Although in the illustrations only entries with a certain confidence score are shown, the entries for customer attributes with no data/no confidence may also be included (e.g. for activities, products and/or associations with which the customer 120 has shown no association) with a confidence score of zero. Thus entries for all possible attributes may be included. However, in this example, zero confidence attributes are be omitted from the customer preference data 330 and implied as zero confidence entries by their absence in the customer preference data 330. An actual score of zero serves to indicate certainty that the customer does not have the corresponding attribute/preference.

In this example, profile builder module 531″, comprises program code to implement an algorithm called a grading function which attributes the confidence score to customer attribute data entries 341, 351, 361. The interest grade is a grade between 0 and 9 where 0 indicates a low confidence in the link between the customer 120 and the related customer attribute and 9 indicates a strong confidence. The customer interaction system 100, introduces a new entry 341, 351, 361 when a new customer attribute is detected, and attributes a value to the confidence grade 348, 358, 368 on the basis of a grading function performed on the available data. This value is recalculated as new data is obtained that is pertinent to the activity on the basis of the same function. In this particular example, this is done by the system server 170 and more particularly by the program core module 505″.

The grading function applies three points for every chat conversation of which the attribute is a subject. To this end, the customer interaction system 100, and more particularly here the system server 170 and more particularly still the program core module 505″ implements a text analysis to identify the subjects of chats as messages are exchanged between customers and employees. The text analysis may comprise a simple keyword search to identify the presence of keywords such as activity names and product names, but in the present example an intelligent contextual text analysis is used which can identify subject based on related words. For example a conversation containing the terms “shredding” near “powder” will be ascertained as being related to the activity “downhill skiing”. The text analysis also identifies product names and relation indicators (such as “for my wife” or “my children love”) and thereby identifies product-type or association-type customer attributes and provide points to the confidence grade of the related product data entry 351 or association data entry 361. The grading function also creates on the basis of proximal use of different customer attributes associations between activities and products, activities and associates and products and associations. In this particular example, the proximity required to attribute an association is within the same chat session, although in alternate example, other or more complex proximity rules may be used. The output of the text analysis are provided to the grading function.

Moreover, the grading function has access to an association database, here stored in the server storage 175, which stores associations between products and activities such that downhill ski boots, for example, are associated with the “downhill skiing” activity. Moreover, in this particular example (although this needs not be the case in every embodiment, or indeed for every store), the customer interaction system 100, and more particularly the system server 170, has access to sales data obtained from the store 115. In the present example, the computer 116 serves as cash register but is also an in-store computing device like the in-store computing device 115 which runs the employee app 500′. The application of the computer 116, however, further has a cash register API module (not shown), which receives receipt data from a cash register program also running on the computer 116 via inter-process communication, which in this example is implemented by saving receipt data for each sale processed by the program as files in a shared memory and triggering a semaphore to indicate to the employee app that the receipt data is available. A queue of sales receipt files is implemented in the shared memory to ensure that each sale receipt is consumed only once by the employee app and an appropriate queue synchronization algorithm is used from among known schemes. The employee app running on the computer 116 retrieves each receipt file and obtains the sales data contained therein and generates a message to the system server 170 to transmit the sales data. In this example it does so by transmitting the sales data as a sales file containing data found in records of sales 325 by calling a suitable method in the connection module 515′ and providing it (in this example through shared memory) the sales file to transfer to the system server 170.

The system server 170 receives sales files from the computer 116 whereupon the employee API module 545″ calls upon a database management module method to save the data contained in the sales file in the server storage 175. In the present example the method does this by extracting the sales data from the sales file and generating a sales record 325 adding a header with information regarding the sale which in this example is extracted from the sales file (e.g. transaction number, date, store and employee).

In the present example, upon the introduction of a new sales file, the profile builder module 531″ is also called upon to add to the sales record 325 additional information; in particular, the profile builder module 531″ comprises a method to identify a customer corresponding to the sales record 325 with which to associate the sales record and to identify whether a recent chat should be associated with the sale, and provides an association, if appropriate, as a result. In the present example the sales record may itself identify the customer 120 by the customer ID if the customer volunteers personal identification data (e.g. a phone number or loyalty card number) but may also be identified using information from the transaction, e.g. a cardholder name. This method then identifies recent chat(s) and determines whether to associate the chat(s) with the sale as a function of the chat parameters. Chat parameters used here include time between chat and transaction (e.g. has it been less than one hour?), connectivity or location of the customer 120 (e.g. has the customer 120 left the store since the chat for an extended period of time?), and employee on the computer 116 or credited on the receipt (e.g. even if it has been long and the customer left and came back, was the sale credited to the same employee?). The profile builder module 531″ provides this data to the database management module method which creates the sales record 325 as a file containing the sales data received from the computer 116 and this additional data.

Likewise, the profile builder 351″ is also called upon on the presentation of promotional data to the customer 120. The functions used by the employee application 500′ to cause promotional material to display on the customer mobile device 125 or on displays 140 for the customer 120 include code to cause the transmission of a message to the system server 170 which, when interpreted by the program core 505″, leads to a calling of the profile builder module 531″ to modify, or add if not present, an entry for the promotional offer to the customer promotion data 390 to indicate the presentation of the promotion to the customer 120. Alternatively, the message may be sent by the customer app 500 upon receipt and display of any promotional data. The message may simply comprise a customer ID and promotion ID. Likewise, any functions of the server program 500″ causing promotional data to be presented to the customer 120 includes a similar call of the profile builder module 531″ to update the customer promotion data 390.

When a file is added, the grading function is called to mine the file for data on the basis of which to modify the customer preference data 330. In the example of a sales file, each item is parsed and a corresponding product data entry 351 is modified or added if not present, and provided a confidence score of 9, since it is now known that the customer 120 has interest in that product. Moreover, the activity data entries 341 for activities associated with each product may likewise be added/modified; in example the grading function provides two points to the interest grade for every sale that is related to the particular activity.

Now a sales record 325 in this example also includes data on the promotional offers applied to the sales as entries alongside purchased items. When a customer has been presented a promotional offer, subsequent redeeming of the offer by purchasing an item is a response to the promotional offer. The information on the promotional offers applied to the sales therefore constitutes response data pertaining to the promotional offer. This data is also parsed by the profile builder module 531″ to derive redeeming data including in this example an indication of the particular promotional offer in question (in this example, to derive the promotion ID) and the parameters of the promotion use. In this example, the parameters of the promotion derived from the parsing of the response data include the item against which it was used and the number of times it was used (e.g. if multiple items were bought). The date of use is also parsed from the sales record. The profile builder module 531″ thus identifies the particular promotional offer then modifies or adds, if not present, a corresponding customer promotion data entry 391 to reflect the redeeming of the promotional offer in the used field of the customer promotion data 390 entry 391 corresponding to the promotional offer. Specifically, the profile builder module 531″

The grading function of this example further ascertains associations related to each activity. As described, the text analysis may identify associations such as other persons the customer 120 may be shopping for. This information is used by the grading function to ascertain whether a particular factor, such as a chat conversation or a sale concerns an association of the customer's 120. Based on the detected association, the customer grading function provides an indication of the association in the related associations field 346, and may also modulate the points provided for the particular factor. Thus if a sale or a chat is determined to be related to an association (e.g. “my wife”), then the impact on the points contributed to the grade may be modulated by a factor (in this case it is halved) since a particular customer may be considered more likely to be returning to shop for activities and products that interest themselves rather than an association. Moreover the type of association may be a factor in determining the modulation factor. In this example if an event is for a person association (e.g. wife or kids) indicating that the customer 120 is shopping for someone else, the points contribution associated with the event (chat or sale) is halved. However, if the association is one of a club (e.g. an alpine club), then the association may be considered stronger, since the customer 120 has joined a related club and the points contribution may be doubled.

Moreover, the grading function may attribute a time modulation to each factor it considers, to gradually phase out the effect of factors as they fade further back in time. For example, each factor may have its points contribution halved for every year since the related event. This way, a person having twice purchased downhill skiing equipment for themselves may have four points added to the interest grade 342 for that activity, however, if no further activity happens in a years, that interest grade may drop to two points, and by three years those sales no longer contribute any points.

In the present example, interest grades 342 are recomputed at ever change in the customer preference data 330 and stored as shown. This interest grade 342 is the same for all users of the system and is shared with all stores and all commercial establishments using the customer interaction system 100, providing the benefit to each such establishment of the data acquired everywhere in the customer 120's commercial activities. However, in other embodiments, some of the customer profile data may be reserved for a particular store or otherwise accessed only under permissions. In such cases each or some of the data in the customer profile dataset 300 is further attributed access permissions and the interest grades 342 is computed every time they are to be transmitted to an in-store computer system using only the data authorized for the permission level of the requestor.

Once a link of an association with an activity is established, the grading function also indicates the reciprocal reference to the activity in the related activities field 365 of the associations table.

The related product field 344 comprises references to entries 351 in the product data 350 table. As described, the grading function identifies associations between products and activities based on the products associated with the customer 120 —in this case the products in the product data 350 table. The grading algorithm populates the related products field 344 of the activities preference data 340 table and also the related activity field 355 in the products data 350 table.

The related event 345 field identifies all event files related to that particular activity. In this example, event files include chat logs 315, employee notes 320 and sales records 325. Modifications to the customer profile dataset 300 in the form of field changes (e.g. manual changing of the interest grade) may also be stored as employee notes 320. When such files are created, the method of the database management module 560″ that creates the file in the server storage 175 provides each file with a unique identifier and stores this identifier in the related event portion of the pertinent users' profile dataset. In the case of customer 120, when activities, products and associations determined to be relevant based on chat logs, notes or sales (broadly speaking, event) will be provided, in the corresponding table entries 341, 351, and/or 361 with the identifier of the event file in which the association is found. Thus in entry 1 of the activities table, chat log C1 is identified and sales record S1 is identified because both pertained to golfing. As we can see, in the products table, entry 1 concerned a golf driver which was included in the transaction of sales record S1, hence the association of S1 with the activity golfing. Turning now to the associations table, we see that the first entry, denotes an association of customer's wife, Tara, who herself has a customer ID since she is a user of the customer interaction system. Tara is associated with chat log C1 and sales record S1, indicating that the golf driver was probably for her. This association was ascertained by the grading function as described herein based on the discovery of the term “for my wife” near “driver” by the text analysis of the chat, and based on the soon-subsequent purchase of the driver. The related events field 350 of the products table and the related events field 367 of the associations table are similarly populated.

The related associations field 346 stores cross-references to entries in the associations table found as described herein. Likewise the related activities field 365 in the association table stores the reciprocal association to the event.

Thus the product table in the products data 350 stores a list of products previously purchased by the customer 120. As described the entries 351 include a field with references to related events files such as sales records 325 and chat logs 315. notes may also be entered by an employee and associated with a sales record 325 using much the same function as the one associating chats with transactions. The date field 352, product ID field 353 and product description field 354 comprise data that may be obtained from the transaction record, but are stored in the table for quick reference. This is also useful for embodiments storing product preferences including not-bought products such as products discussed in a chat. The related associations field 357 stores cross-references to entries 361 in the associations table corresponding to associations found to be related to the product purchase. For example, the driver was found to be purchased for the customer 120's wife. The reciprocal reference is stored in the related product field 366 of the corresponding entry in the associations table.

As mentioned, the associations table comprises an ID field 364 which may comprise references to other datasets stored in the server storage 175 corresponding to associated entities.

Turning now to FIG. 3B, a similar dataset is provided in the server storage 175 for the employee 110. Such a dataset may be provided for all users on the commercial establishment side of things, although in some embodiments several users (e.g. all employees of a store, or even of a commercial establishment) may share a dataset if preferred). The employee profile dataset 300′ comprises some of the same data fields as the customer profile dataset 300, including employee identification data 305′ that is similar to the customer identification data 310, although it may include fields particular to the store 105 or its overarching commercial establishment. Employee and customer identification data is exchanged between the two by the system server 170 after establishment of a connection between them. The employee identification data 305′ may permit the customer to quickly identify the employee 110 and to quickly re-find and re-contact the employee 110 or the store 105 at a later date if need be. Having this data (e.g. name and picture) may also reassure the customer 120 that they are indeed in communication with a nearby store employee and receiving real human help, not help from a bot or a faraway call center employee.

A set of files 310′ corresponding to the employee are similarly stored in the employee profile dataset, here too as references to files stored elsewhere in the server storage 175. Thus multiple profiles (e.g. employee and customer) may share a file. Sales records 325′ and chat logs 315′ pertain to sales made by the employee 110 and chats held by the employee 110. Training records 321′ in this example store data pertaining to trainings underwent by the employee 110 that may, for example, confer expertise to the employee.

The employee profile dataset 300′ in this example comprises position data 370 indicative of the employee 110's position and rank. This may be used to ascertain the permissions related to the employee. In particular, in this example the database management module verifies the rank and position of employees originating requests for data or requests to modify data in the database by first accessing the requesting employee's profile dataset before granting the request. The position data 370 of this example comprises a table having entries for each rank held by the employee 110 in each department. Here we see that employee 110 is store manager, and as such is also qualified as a salesperson in all departments.

The employee profile dataset 300′ of this example also comprises expertise data 380 indicative of the employee's expertise in commercial activities (e.g. sales) for various activities. Here these activities correspond to potential activities of interest to customers. This information may optionally be shared with the customer 120 in the same manner as the identification data, which may further reassure customers that they are dealing with competent employees for their particular needs. Expertise may be assessed in various manners. In the present example expertise is assigned using a function similar to the grading function described herein, only with a binary output: the employee 110 is either an expert or not in each field. Factors weighed include the number of sales related to a particular activity made by the employee 110 and trainings related to that activity undertaken by the employee 110. Training records 321′ in this example identify clearly in a field the activity to which they pertained, but in alternative embodiments training reports may be analyzed in a manner similar to the chat logs.

Broadly speaking the employee profile dataset 300′ is a commercial profile dataset associated with a commercial establishment, in this case a particular commercial physical premises, and in this case more particularly a store. Although in this example every employee using the customer interaction system 100 has a respective account and employee profile dataset, it will be appreciated that in other embodiments, several employees may share an account, and that an account may also be shared for an entire store/physical premises or for an entire commercial establishment. In such cases, the particular data contained in the dataset will be associated with the entire group of employees/store/commercial establishment to which it is associated and accordingly employee identification data will pertain to the particular entity/group concerned. Likewise the set of files 310′ will contain files (or references thereto) corresponding to the entity/group concerned. Position information 370′ and expertise 380′ may likewise be modified to correspond to the entire entity/group concerned (e.g. to store the lowest position shared by all users and all the expertises of any users, for example) or be omitted entirely.

As described, the server storage 175 stores a customer profile database comprising a plurality of customer profile datasets like the customer profile dataset 300, described above. The server storage 175 also comprises an employee database comprising a plurality of employee profile datasets like the employee profile dataset 300′, described above. In this example, the server storage 175 also comprises a promotional database comprising promotional dataset each corresponding to respective promotional offers. Now, this configuration is exemplary but others may be envisaged. For example, the different databases need not reside on the same server storage. Moreover certain server functions may be performed other device(s) in the system, with the required data being made accessible to the device(s) in question.

FIG. 3C shows a representative block diagram of an exemplary instance of a promotional dataset 900. Relationships between the datasets and/or data within the user profile datasets are built into the database structure, in this example as stored relational information. The promotional dataset comprises promotion ID data 905, offer data 920, promotional attribute data 930, and promotion validity data 940.

The promotion ID data 905 comprises identifying information for the promotion. Each promotion is given a unique ID number beginning in this example with the letter P to identify it as a promotion. The promotion ID data 905 of this example includes a company name, which represent the company offering the promotion. This can be the company making a product on which a promotion is being offered, for example, or the commercial establishment (e.g. chain of stores) selling the product in another example. In this example, this value is stored as a plain text name, but a system of IDs can be used as well. The promotion ID data 905 also comprises a brand name, that is a brand on which the promotion applies. This field may be blank if no brand applies, for example if the offer is on a service, or on all products in a store. Multiple brands may also be represented, in this example by comma separated values. Here too the brand is stored as plain text but an ID system could be used. The promotion ID data also comprises a product ID field identifying the product targeted by the promotion. Any suitable identification system may be used. In this example, a SKU code is used, and there can be multiple product IDs, here in a comma separated list. Additional codes or wildcards may be used, such as a code to denote “all products in store”, a code to denote “all regularly-priced product”, a code to denote “all products in fall 2018 collection”, etc. . . . . Alternatively an additional field may be included for classes of products. Regardless of the particular identification scheme used, the promotional dataset 900 comprises information identifying the promotion and the promotion parameters. In this example, a promotion rule field is also included which comprises a code indicating the promotional offer rule. Here the rule is defined using an XML-like code in which variables denoting different aspects of a rule can be combined. In the illustrated example, the term “Full Price” indicates that the rule applies on the products original price, and the term “−40%” indicates that a 40% off discount is applied at the cash register.

Additional data may be stored in the promotion ID data 905, or indeed elsewhere in the promotional dataset 900, such as data pertaining to how to deal with the promotion internally, such as reimbursement details for manufacturer-offered rebates and coupons.

The offer data 920 comprises data used to convey the offer. In this example, the offer data 920 comprises the data used to convey the promotional offer internally and the data used to convey the promotional offer as an ad to customers. In this example, the offer data 920 comprises a textual description field containing a brief textual description of the offer, which can be easily displayed on an employee device such as the in-store computing system 115 or the computer 116.

The offer data 920 also comprises the actual audio/visual materials displayable as ads to customers. In this example, this material is stored within the server storage 175, however in other embodiments the offer data 920 may include links to other locations where the materials are hosted. In either case, the offer data 920 defines the promotional offer. In this example, the offer data 920 comprises audio/visual material for a variety of different media, including for the customer mobile device 125, for the display 140, as well as for larger displays such as may be used to display menus in restaurants. There may be both still image and video materials, to be used in different circumstances. For example, the customer app 500 may have a certain dimension for images for displaying ads in half the screen while the customer 120 chats with the employee 110. The corresponding material is provided here in the field Mobile Image. In this example, the offer data 920 comprises fields storing links to files 910 that are also considered part of the promotional database and stored in the server storage 175, although they could be stored elsewhere. Likewise, video material could also be stored, e.g. to play as a video advertisement on the customer mobile device 125, although here the corresponding field is empty, denoting that no such material exists. Although one image and one video field for mobile is shown here, it will be appreciated that additional fields for different formats (e.g. full-page, half-page) could be present. The same promotional offer may have different display material for the displays 140. In this example, the promotional offer may be pushed by the employee 110 to a display 140, e.g. when the customer 120 is near the display 140. In this example, a video file exists for this purpose, which may be a brief ad targeting the customer 120. Optionally, textual overlays or voice-to-text (e.g. reading the customer's name and speaking it) may be used to personalize the promotional material. In this example, the offer data 920 may also store different material for different media such as large screens, however non is provided for this particular promotional offer.

The promotional validity data 940 comprises parameters defining the promotion validity. This may be implemented using any suitable system to define validity parameters. In the present example, the system 100 is used across several commercial establishments, and the promotional validity data 940 comprises a commercial establishment field identifying the commercial establishment where the offer is valid. This is stored here as plain text, although any ID system may be used, and codes and wildcards may be used, e.g. to denote “any store” or the like. Multiple establishments may be provided, here using comma separation. Many commercial establishments have presence across wide areas and some offer may be valid only in some areas or in some other subset of the commercial establishment's presence. In this example, a field denoting premises is provided which for the illustrated offer includes only the store 105. Again, ID systems may be used, codes and wildcards may be used and additional premises may be provided using comma separation or other suitable systems. The promotional validity data 940 also includes time-validity information for the offer, here in the form of a date range although more complex systems may be used to create more complex validity rules (e.g. “every Friday”, “any time the local team is playing on home turf”, etc. . . . ). Other validity rules may be defined here. In this example, there is a field for customer criteria, which may contain restrictions on the types of customers that may benefit from the offer such as names of specific customers, address details (e.g. city line=Chicago), or specific customer attributes (e.g. parents of young children), etc. . . . . Restrictions on product categories, brands, specific products are also listed here. This introduces some redundancy with the information stored in the promotion ID data 905, which could be eliminated in alternate designs but has maintained here.

Now certain promotional offers are suitable for different customer profile types. For example, a promotion on baby implements such as diapers and baby clothes is useful only to someone who provides for a baby, such as a parent. For this reason, a customer's response to a particular promotion can be used to identify customer attributes. Promotional attribute data 940 comprises data indicative of customer attributes associated with the promotional offer, which can be used to update the customer profile of customers who have redeemed the promotional offer. A single promotional offer may be associated with more than one customer attribute, and in this example, promotional attribute data comprises a table having entries for each customer attribute with which it is associated. Each entry comprises a field defining the attribute to which it pertains, corresponding to customer attributes that can be found in the customer preference data of the customer dataset. In this example the attribute is provided in plain text, as in the customer dataset. In the illustrated example, the attributes are listed in a single table rather than in separate tables for different attribute types. Indeed, they could also be listed this way in the customer preference data of the customer dataset in alternate examples. An attribute type field is included which indicates in this example whether the attribute for this entry is an activity, an association or a product.

Additional fields may be provided for more detailed implementations. In the present example, a strength field indicates the strength of the association between the offer in question and the attribute of this entry. The strength may be used to determine the modification to a customer's customer preference data to be made as a result of the customer redeeming the offer. In this particular example, the strength comprises a value that is added by the grading function of the profile builder module 531″ to the confidence grade of the corresponding customer attribute field in the customer dataset when a customer redeems the offer. The grading function adds to the confidence grade to a maximum value of 9, thus there is no harm in computing this modification even if the confidence is already at maximum. Optionally, the grading function could denote another field, e.g. the interest grade field, to be maximum-free (or, more practically speaking, to have a very high maximum value limited only by the size of the data field attributed to it) so as to track interest strength more precisely, even after full confidence of the attribute is achieved. In another alternative, confidence level itself could be maximum-free (in the same manner).

Although not shown here, it should be noted that products may likewise have associated customer attributes that have a strength associated to them, like the promotions do.

For example, in the illustrated promotional dataset 900, the promotional offer concerns a special type of reusable diapers suitable for use while camping. Now, diapers are products that are rarely bought for other people and are not considered a gift item, so such an offer is strongly indicative that the customer who would redeem it is a parent of a very young child. Accordingly, the promotional attribute data 940 comprises an entry with for the promotional attribute “Family—Child (Baby)”, which corresponds a same possible customer attribute. Here the strength of the association is 9, since it is so likely that the redeemer is a parent of a baby. Likewise, there is an entry for the product type itself, which also has a strength 9, since the redeemer would necessarily have the customer attribute of being interested (in other words, having as a product preference) the product that is the object of the offer. Finally, the promotional attribute data 940 also has a field for camping since this product is typically used in camping or like activities. However, the strength of this association is weaker, only a 5. Indeed, we cannot conclude with certainty that the product is bought for camping, despite it being marketed for such. It could be that the parents are merely trying to be environmentally friendly or that they prefer this product for other reasons. As such, the system 100 does not derive perfect confidence in the redeemer having a preference for camping as a customer attribute, a score of 5 is provided, which if compounded with other substantiating evidence could add up to an eventual 9 confidence.

In this example, the promotional attribute data 940 for the promotional offer is likely similar to the customer attributes that are associated with the product that is the target of the offer, however this needs not necessarily be the case. For example, customer attributes in some embodiments may include shopping preferences such as responsiveness to certain types of discounts/offers, in which case a promotional attribute field may include an entry for the discount type which would not apply to the product alone. Likewise certain customer attributes that are associated with the product may be left out of the promotional attribute data 940 of the promotional offer, e.g. the product field.

In the present example, the grading function detects the redeeming of an offer on the basis of sales data as obtained, e.g. from a parsed sales receipt. Specifically, when a transaction is processed, e.g. at computer 116, the sales receipt indicates not only the items purchased, but also the promotional offers applied to the sale. In this example, the promotion ID is listed on the sales receipt along with the price difference created by the sale (the item being shown as having the price prior to redeeming the offer). When the sales data is parsed, the grading function obtains the promotion ID and knows that the corresponding promotional offer has been redeemed and modifies the purchasing customer's customer dataset accordingly, in the same manner as is done for products. However, since the product also has an impact on the customer preference data 330, in order to avoid doubling the impact of a sale just because it is the subject of a promotion, the grading function of this example includes program code to lookup the item(s) to which a parsed promotional offer apply, and verifies whether the corresponding modification has already been done for the item before modifying the confidence level based on the promotional offer. If it has already been done, the grading function does not repeat it. If there is a conflict (e.g. if the product has a different strength associated with it—e.g. if only one point is counted per product but more are counted for the promotion), it resolves this by modifying the confidence level so as to have applied the largest modifier of the two. Other redundancy avoidance/conflict resolution schemes could be used. For example here, the products are searched after the promotional offer is read because in this example, receipts list promotions after the products to which they apply. However, the grading function can be adapted for other types of receipts.

In the present example, the customer attributes with which the promotional offer is associated are stored in the promotional offer dataset 900. However, this needs not be the case. The promotional offer may be associated to customer attributes by virtue of applying to certain products. Since the grading function of the profile builder module 531″ modifies customer profile datasets to increment customer attribute confidence levels on the basis of the items (here we talk about products, but it should be understood that they may be services as well) purchased, then redeeming an offer will automatically search through a list/database of products to identify the corresponding customer attributes and may use this to modify the customer dataset 300 to reflect the new confidence level. In such an embodiment, the product ID serves as promotional attribute data since the customer attributes associated with the promotion are derived therefrom. Indeed, offering a promotional offer can prompt the building of the customer profile if it is redeemed by the mere fact that the customer purchases an item which purchase is used by the grading function of the profile builder module 531″ to increase the confidence level for certain customer attributes, and thus the promotion attribute data 930 may be contained within the product type or other data in the promotional offer 300 leading to a transaction. However, in the present example, it is preferred to have the promotional attribute data 930 listing actual customer attributes associated with the promotional offer, as this allows a direct searching for an offer corresponding to certain customer attributes.

An exemplary use case will now be described with reference to the above description and to FIG. 6, FIG. 7A, FIG. 7B, FIG. 8A and FIG. 8B.

FIG. 6 shows a finite state machine 600 illustrating some of the functionality of the customer application 500 in accordance with a particular example. When the application is launched, at state 605, the customer application presents a login screen at with which the customer 120 may enter login credentials which are transferred to the system server 170 for verification. Having logged in, the customer application 500 proceeds to establish the location of the customer 120. In some embodiments, this may be based on the GPS location as determined by the location module 520 using the data provided by the GPS unit 440. Location data may be continuously provided to the system server 170, which performs ongoing verification of whether the customer 120 is within a designated commercial zone associated with a store or similar commercial space associated with a commercial account (which is in turn associated with employee accounts). In the present example, however, location is ascertained on the basis of connection to the network 160 of the store 105. The customer application 500 scans available network and determines whether a network corresponding to a commercial account is in range. This may be based on a locally stored network database or network information may be transmitted to the system server 170 through an existing internet connection, which transmits a message indicative that the customer 120 is in range when a suitable network is found. In the present example, this step is manual. When the customer 120 enters the store 105, the customer 120 manually connects to the Wi-Fi™ network of the store 105 and, having open the customer application 500, a connection screen 700, shown in FIG. 7 is displayed at state 610.

The connection screen indicates that free Wi-Fi™ will be provided if the customer 120 connects using the customer application 500, for until the customer 120 does so, the customer mobile device 125 is provided a captive portal when attempting to connect to the internet. In a variant of the present application the customer application 500 is a web app, and launching of the application is done by the captive portal. A clickable connect button 705 allows the customer 120 to log in. If their credentials are stored they may be send automatically, or an equivalent validation via cookies or tokens may be used. If not, proceeding to a registration or login screen may be required. In this example, confirmation of the customer 120's location in the store 105 is obtained by the customer interaction system 100 upon login into the system.

Upon login, an application main page is presented at state 615. The application main page may present to the customer 120 any information that the store 105 or overarching commercial establishment wishes to present. In the present example, it provides the customer 120 with promotional material defined as default promotional material for the particular store 105 or overarching commercial establishment (e.g. store chain) in the server storage 175. This may include a welcome screen comprising promotional data on store deals and/or promotional data that is pertinent to the user's interests.

The system may include push notifications to the user app and/or broadcast of e-mails, text messages, phone calls, or other notifications on the customer mobile device 125 which may be triggered by location information of the user, e.g. based on GPS or upon connection to the store Wi-Fi™ by the customer mobile device 125. This may include presenting the welcome screen in the app and notifying the user, via push notification in the app, or message (e.g. sms/e-mail) broadcast that the app is useful for the customer's location/store 105.

Conversely, push notifications may be provided to the employee 110 to inform the employee 110 that a customer that is connected to the system has entered the store 105. In particular, a notification may be triggered if a customer having a particular status/belonging to a particular tier (e.g. a VIP customer) enters. This may also trigger an opening or prioritization (e.g. move to the top) of a chat window for that customer in the in-store computing device 115.

The application main page also provides a “chat” button (or other GUI tool) for initiating a chat session with an employee of the store. It will be noted that providing the customer mobile device 125 promotional material by transmitting to it promotional data representing promotional material to be displayed, and its subsequent display on the display 455 may be based on the determination of the location of the customer mobile device 125 (and therefore the customer 120) in the store 105 as described herein. In the present example, the transmission of the promotional data is based on the connection between the customer mobile device 125 and the in-store computing device 115, which itself is based on the location of the customer mobile device 125 within the store 105. That being said, sending promotional materials/data to the customer/customer mobile device 125 may be otherwise directly or indirectly linked to the determination of a location within the store 105. For example the system server 170 may transmit promotional data to the customer mobile device 125 for display even before the connection with the in-store computing device 115 is effected. In an alternative embodiment wherein the customer mobile device 125 is in communication with the system server 170 even when not in the store 105, (e.g. the customer application 500 is running and connected to the system server 170 via an internet connection), the system server 170 may transfer promotional data for display at the device to the customer mobile device 125 on the basis of the device's location other than in the store 105, for example based on proximity to the store or travel direction towards the store 105.

Upon clicking the chat button, the customer application proceeds to state 620. In the case of a web app, this is done by transmitting to the system server 170 a message indicating that the chat button has been pressed and receiving in response web page data for displaying a chat interface in web page form. An exemplary chat interface page 710 is illustrated in FIG. 7B. To this end, a connection is established between the customer mobile device 125 and the in-store computing device 115. In the present example, whether by web app or standalone application, the connection is established by the system server 170, and communications go through the system server 170 such that the customer mobile device 125 needs only communicate with the system server 170. In alternate examples, this connection may be established peer-to-peer.

Although not shown here, employee profile information based on employee profile data 300′ received from there system server 170 (or in alternate examples, directly from the in-store computing device 115), may be also displayed in, or alongside, the chat window or application main page. This allows the customer 120 to see who he is chatting with. This has the advantage of permitting the customer 120 to see that the employee he is chatting with is a real person, is really in the store, and optionally to see his expertise, rank or other data to bolster confidence. Moreover this has practical effect when the chat conversation must be supplemented by in-person help as it allows the customer to easily recognize the employee 110 when they meet in person.

Once the connection is established, as described herein, the customer application 500, whether a web app or a standalone application exchanges chat messages with the in-store computing device 115. FIG. 8A shows an exemplary customer management window 800 presented at the in-store computing device 115. As shown, there may be several chat subwindows 810, 811, 812, 813 for holding different concurrent chat conversations. Indeed, the in-store computing device may be connected to several different customer mobile devices simultaneously. This allows the employee 110 to serve several customers at the same time, which is not possible face-to-face where attention must be given to one person at a time. In the example shown, one chat window, chat window 813 is inactive, as only three chat sessions are currently ongoing. Chat window 810 is selected, as indicated by the framing highlight 814. Advantageously, in the present server-based communication embodiment, an arbitrary number of chat sessions may be held over a single connection to the system server 170. The in-store computing device 115 and the system server 170 include a customer identifier with all communications pertaining to customers, whether chat communications, customer profile data-related communications or other, to avoid confusion.

Chat window 810 is currently active and corresponds to the connection with the customer 120. Text messages entered in the text box in this window are exchanged with the customer mobile device 125 and vice versa. A customer profile window 830 shows customer profile information for the customer 120 associated with the selected chat window 810. The customer profile information comprises data obtained from the customer profile dataset 300. In the embodiment where the employee application 300′ is implemented by a web app, the customer profile window 830 may be provided by the system server 170 as web page data. In the present example, it is provided in accordance with the data sharing protocol implemented using the employee API module 545″. The employee application 500′ receives the data and displays pertinent information using the GUI module 510′.

The customer profile window 830 comprises a photo 831 of the customer 120, here downloaded based on the URL received from the system server 170. The customer profile window 830 further comprises customer identification information based on the customer identification data 305. This may include the customer 120's name such that the employee 110 may address them by name. The customer profile window 830 also includes customer preference information based on the customer preference data 330. In this example, this includes a scrollable view of all the activities the customer is associated with along with their interest grade. Clicking on any one activity will reveal in the same window the associations and products linked to that activity. In the present example, this is merely loaded by the GUI module 510′ from the customer profile data already received from the system server 170, although in alternate example, only the displayed data may be received or retained and displaying additional customer profile data requires another request to the system server 170. Such may be the case, for example in embodiments where the employee application is provided by a web app.

In one example, the customer profile window 830 may include an indication of a customer status or tier, which in one example shows whether a customer is a VIP customer. VIP status may be established by the system based on past purchases (e.g. based on records of sales 325 or alternatively built based on products data 350) or may be input into the system based as sales data based on purchase of a VIP package or manually input by an administrator. The visual indication of the VIP status can serve to indicate to the employee 110 that a customer should be treated with priority. The system can thus establish tiered service based on customer status. The system may also implement programmatically a priority based on status, by giving priority to notifications concerning or communications from higher tier (e.g. VIP) clients and systematically selecting higher tier clients to engage in chat if the limit of available simultaneous chat channels is reached.

The employee application 500′ may also comprise a countdown timer counting down a maximum time-to-help within which the employee 110 is to extend a welcome or help to every customer entering the store. This countdown timer may be included in the customer profile window 830. Based on whether the employee has engaged in chat (optionally, or modified the customer data) with the customer 120 (e.g. based on whether the application 500′ has received input in the chat window 810 or the customer profile window 830), the employee application 500′ may generate a communication for the system server 170 indicating the employee 110's responsiveness to the customer 120. For example, the communication may comprise the time (e.g. based on the countdown timer value) it took for the employee to establish contact with the customer 120 and/or whether the employee 110 contacted the customer 120 before the countdown timer expired. This may be done for all tiers of customer (and the message may include a customer tier) or only for VIP customers or the like. The system server 170 may modify the employee profile dataset 300 on the basis of the message, e.g. by providing a log in the files 301′ tracking this performance, and/or by providing a score for the employee computed based on the performance.

The employee 110 may also modify customer profile data by interacting with the customer profile window 830. For example, the employee may use GUI elements to increment, decrement or reassign the interest grade. In the present example an increment and decrement button are provided next to the interest grade and clicking on the grade itself allows the employee to type in a new number. A new activity may be added by using GUI tools. In the present example, a “plus sign” button at the bottom of the scrollable activity lists generates a new element in the list in the form of a text box for entering the activity name. Only activities recognized by the system may be entered and autocomplete to such activities is provided. The employee application 500′ obtains the list of accepted activities by request from the server 170; this may be implemented in the web app embodiment by standard web techniques. Having assigned the new activity name an interest level may be entered; where the interest grade box now becomes a text box. A default value (here, “1”) may be pre-entered in the box.

Likewise, after having clicked on an activity, when related associations are listed, new associations may be added in the manner similar to the above. A new field button allows the generation of a new association entry and text boxes allows the entry of the association details: type, name. The type may be restricted to allowable types as with the activities. The association will automatically be linked to the activity that was selected, although in alternate embodiments associations may be presented concurrently (e.g. in another window) to activities, and the link may be added manually. In the present example, the products associated with an activity are always taken from sales information (e.g. receipts), however in alternate embodiments it may be possible to enter products associated with activities manually as with associations, e.g. to enter products that the customer 120 was found to be eyeing or asking about.

Another way to modify the customer profile data 300 is to enter a note into the system. Events window 840 displays events associated with the customer 120 of the currently-active chat window 810, and allows the employee 110 to enter new events, such as notes. A scrolling list 841 of existing events is shown, which includes sales records and notes previously attributed to the customer 120. These are part of the customer profile data obtained from the system server 170. In the peer-to-peer embodiments customer profile data may be obtained directly from the customer mobile device 125, although some customer profile data (e.g. sales records), may be stored locally or obtained from a local device, such as computer 116.

In this example, the employee 110 may review overviews of events in the scrolling list 841. Overviews may comprise, for example a date and type (e.g. note, sales record or chat log). Sales records may also include a dollar value of the sale. Clicking on a particular event in the list will cause the full description to appear over the events window 840. In the case of a note, the entire note as typed may be displayed. In the case of a sales record, the entire receipt may be displayed. In the case of a chat log, the entire chat log may be displayed. Alternatively only portions of the events may be displayed. Events so displayed may be displayed in scrollable form.

The events window 840 also includes a text box 842 for entering new notes. The employee 110 does not need to include the date and time or employee 110's ID, since the database management module 560″ will automatically add these to the file when storing it in the server storage 175. The employee 110 may input natural language notes which may simply be stored for future reference, but in the present example, the notes are subject to the natural-language analysis also used for chat logs to extract therefrom customer profile data such as activities of interest, associations and optionally products of interest.

A promotion button (not shown) also allows the employee 110 to access the promotion interface window 850. The promotion interface window 850 is used to send promotional materials to the customer mobile device 125 while in the store. this can be a powerful tool. In this example, the promotional interface window 850 comprises a customer subwindow 860 showing a list of customers presently in the store 105. The customers are selectable and currently customer 120 is selected.

A promotion transfer subwindow 870 next to the customer subwindow 860 shows available promotions to transfer to the customer mobile device 125. A list of available promotions 871, in this example received from the system server 170 is shown. By clicking on an available promotion 871 the employee 110 can cause the related promotional data to be transferred to the customer mobile device 125 to be displayed in the form of promotional material in the promotional space (e.g. banner ad) provided by the graphical user interface of the customer application 500. Thus if a customer is seen to be perusing clothing for the fall, and a sale on fall wear is on, the employee 110 may click on the available promotion 871 corresponding to the sale to be displayed on the customer mobile device 125. Alternatively, this promotion may be displayed as a pop-up message or as a full-screen advertisement. In some embodiments display options may be included in the promotion transfer subwindow 870. An indication of the selected promotion and display options, if any, is transferred by the employee application 500′ to the system server 170; in embodiments where the employee application is a web app 500′, this may simply be an indication of the link clicked. The system server 170 then transfers the promotional data, and optionally display parameters, to the customer application 500, where the promotion module 530 causes the promotion to be displayed, in this example by calling appropriate GUI module 510 functions and providing it with the promotional data. In some embodiments, the promotional data may be URL or similar links to web content. In embodiments where the customer application is a web app, the system server may provide the customer mobile device directly with web data to display representing the promotional material in the form desired.

This tool may be very useful, when combined with the chat interface, customer profile window 830 and event window 840. The employee 110 may select promotional material to display based on the contents of either a chat conversation held with the customer 120, on the basis of preferences displayed in the customer profile window 830 or based on past events such as notes entered previously for the customer 120. Alternatively, promotional data may be associated with activities or products and may be automatically selected by the system server 170 based on matches between the customer profile data and the activities or products associated with the promotional data. In such a case the employee 110 may still be able to override the automatically selected promotional material using the promotion transfer subwindow 870.

In the present example, the employee may create tailor-made promotional material for the customer 110 by clicking on the “new” button 872. There the employee may create a coupon by entering a discount amount (in currency or percentage) and a product identifier (or list thereof or category thereof, e.g. “all products”). In this manner an employee 110 may be able to give special deals to particular clients. For example if the customer 120 has discussed with the employee 110 (live or over the chat interface) about a particular product, the employee 110 can entice the client by offering them a special discount. Likewise via the note-entry system, the employee 110 can also enter special conditions of sales such as an extended return period or the like.

In the present embodiment, the customer mobile device 125 has established its location within the store by connection to the network 160. Once inside the store, however, the customer mobile device continually updates the system server 170 on its location by transmitting thereto its location as established by the GPS unit or by other means. To this end, the application core 505 runs a thread constantly obtaining and transmitting its locations to the server.

The system server 170 tracks the employee's movement within the store and provides this information to the promotion module 530″. The system server stores a geographic profile of the store 105 in the server storage 175, including the location of electronic promotion displays such as displays 140. Based on the location data received from the customer mobile device 125, the promotion module 530″ continually computes, via a running location comparison thread, the closest display 140 to the customer 120. An indicator of the closest display 140 is transmitted to the in-store computing device 115, and again every time the closest display 140 changes. The closest display 140 is just one of many possible relative locations that may be used. For example, the promotional module 530″ may compute and base the selection of display 140/promotional material on a physical distance to the display 140 (e.g. closer than 10 meters but further than 1 meter). Another relative distance that may be use includes a comparative distance from the display 140, e.g. the distance of the customer 120 to a particular display 140 as compared to other customers. In such a case, the computation may compute that/whether the customer 120 is the closest one. Other variants are possible. Relative location may also be based on direction of gaze. To that end, where the direction of gaze is provided by the GPS unit 140 (e.g. compass data) or derived therefrom (e.g. based on movements of the mobile computing device 125), the display 140 selected as “closest display” may in fact be the most visible display (closest in terms of being closest to the user's center of focus/attention).

The store display subwindow 880 shows a list 881 of the displays 140, including the closest display 882 to the customer 120 selected in the list of customers 861. The closest display 882 is highlighted by a highlight frame 883. As the customer 120 moves about the store, the closest display 882 may change and accordingly the highlight frame 883 may change as well.

A displayable promotions window 890 shows a list of displayable promotions 891 displayable on the displays 140, in this example by showing thumbnails of the promotional material displayable. By clicking on a display from among the list 881 of displays, the display is selected (as indicated by a darkening of the display entry in the list 881) and a highlight box 893 appears around the current displayable promotion 892 currently being displayed on the selected display 140. In this example, the displayable promotions 891 are received from the system server 170 at startup of the employee application 500′, and whenever the displayable promotion content changes. The system server 170 stores displayable promotions with an association to the particular store 105 or stores (e.g. an entire commercial establishment) in the server storage 175. Displayable promotions may be provided to the system server 170, e.g. by an administrator through an appropriate interface. In embodiments where the employee application 500′ is a web app, the displayable promotions 891 and indeed the entire displayable promotions window 890 along with the rest of the promotion interface window 850 may be transmitted to the in-store computing device as web page data.

The employee 110 can change the promotion displayed on the selected display by clicking on another displayable promotion 891. Doing so causes the in-store computing device 115 to transfer to the system server 170 an indication of the selected displayable promotion. In the present embodiment, the promotion module 530′ does this by calling a method in the connection module 525′ passing it an indication of the selected displayable promotion and of the selected display 140 (or references thereto), which then generates a message containing this data and transfers it to the system server 170. In embodiments where the employee application 500 is a web app, a mere indication of a link click may be transferred.

In response, the system server 170, receives the indication of the selected displayable promotion and display 140. The promotion module 530″ identifies in the server storage 175 the promotion data corresponding to the selected promotion and the connection parameters for the selected display 140 and transfers thereto the promotion data to cause the display 140 to display it. In the present embodiment the promotion data may simply be a URL pointing to the promotional material available on the web, which is transferred to the selected display 140 which is a web-connected display and which downloads and displays the promotional material at the designated URL.

As with the promotion transfer window 870, this tool may be very useful, when combined with the chat interface, customer profile window 830 and event window 840. The employee 110 may select promotional material to display based on the contents of either a chat conversation held with the customer 120, on the basis of preferences displayed in the customer profile window 830 or based on past events such as notes entered previously for the customer 120. Alternatively, promotional data may be associated with activities or products and may be automatically selected by the system server 170 based on matches between the customer profile data and the activities or products associated with the promotional data. In such a case the employee 110 may still be able to override the automatically selected promotional material using the displayable promotion subwindow 890.

In certain variants, the employee may be able to create tailor-made displayable promotional material, e.g. with an image editor or merely as a text editor and transfer these to the system server 170 to create real-time advertisement tailored to the customer 120.

Turning now to the server program 500″, the profile builder 531″ module of the promotion module 530″ may be used to strategically grow the profile of a customer for which additional data is required. The customer interaction system 100 provides a unique platform for interacting with a customer in an engaging way, and the profile builder module 531″ is programmed to take advantage of this opportunity by prompting interactions that will lead to meaningful information about the customer, and specifically knowledge of the customer's customer attributes to be obtained. Specifically, the profile builder module 531″ comprises code, in this case implementing two functions that run for each customer active in the system to create interactions that will yield information on the customer's attributes.

In a first instance, the profile builder module 531″ identifies promotional offers that can be offered to the customer 120 that have been selected for their ability to provide information on customer attributes about which we have too little data. This has been found to be a very effective way to do targeted data acquisition. A customer may buy a particular product that would provide the same information eventually, however this might not be soon and/or the customer might buy it in a commercial establishment outside of the usership of the system 100, thus depriving the system 100 of valuable information, at least for a while, that could be used to tailor the promotional and service experience offered to the customer 120. By providing a promotional offer that targets the particular customer attribute, an incentive is provided to display instantly and at the present store 105 the customer attribute by redeeming the offer. In a way, this offers the commercial establishment, or parties to the system 100, such as product brands, the option to pay, in the form of a discount or other promotion, for information about the customer 120 in a mutually beneficial manner. It will be noted, that as described with respect to the promotion ID data 905, the party offering the promotion needs not be the store 105 or its commercial establishment, and reimbursement for the sale may be provided in the same manner as for coupons, since promotional offer redeeming is tracked by the system 100 and redeeming information is preserved.

To this end, in the profile builder module 531″, a function is called when the system server 170 detects the presence of the customer 120 in the physical store premise, in the manner described herein. This function identifies a particular promotional offer the redeeming of which would yield useful information about the customer 120. To this end, the profile builder module 531″ performs a search through the customer profile dataset 300 and the promotional database to identify promotional offers associated with customer attributes regarding which there is too little data in the customer profile dataset 300 thus of which we have too little knowledge.

In the present example, determination that there is little knowledge regarding a customer's customer attribute is achieved on the basis of the confidence grade for the customer attribute entry associated with the customer attribute in question. For the presently described implementation, the convention that was adopted is that customer attributes having no corresponding entry in the customer preference data 330 are considered to have a confidence grade of zero, indicating no knowledge of whether the customer has the corresponding attribute. As data is gathered by the grading function which indicate that the customer may have the attribute in question, the confidence grade is increased to a maximum value of 9, indicating certainty. However, in certain cases it may be that the customer certainly does not possess an attribute, for example if the customer says so explicitly in a chat conversation. For such cases, the convention here is to provide the customer preference data 330 with an entry for the corresponding customer attribute populated with a confidence score of zero, which indicates certainty that the customer does not possess the attribute.

In order to identify customer attributes of which little or no knowledge is had about a customer, the profile builder function 531″ can search through the customer preference data 330 to identify all the entries that are missing or that have a low confidence score as defined by a threshold set according to implementation preferences (e.g. 2). In order to know which customer attributes are absent, the server storage 175 (or other storage) may store a library of customer attributes, to which the customer preference data 330 is compared. However, this approach can be a bit onerous and return too many results. Accordingly, two further factors are used to narrow down the results.

In a first factor, the profile builder module 531″ first identifies the promotional offers that are currently available to the customer 120. In particular when the function is run as a result of the customer 120 being in a store, the profile builder will search through the promotional database and identify all the promotional offers that are applicable in the store 105. As mentioned above, in the present example, the promotional datasets include promotional attribute data 930 listing the customer attributes associated with each promotional offer such that these can quickly be identified by the profile builder module 531″.

Another factor is a priority value for the customer attribute. Not all customer attributes have the same value as information. For example, having a baby or young children is very useful information for many commercial establishments since many purchasing decisions are based thereon. Having a vehicle, on the other hand, may only be useful information to certain entities such as stores that sell car-related things, venues that are located a driving distance away, or the like. Meanwhile, knowledge that a customer has a preference for one particular product, especially if it is not an oft-replaced item, is not particularly useful in most instances. Accordingly, customer attributes are attributed with a priority value. In the present example, the library of customer attributes includes for each listed customer attribute an overall priority value, which is on a scale. The scale in this example runs from one to ten, but it could otherwise be simply binary (“high priority” or “low priority”). In the present example, a single priority value is assigned to each customer attribute, and may be modified by an administrator (the default being zero) or the like. However, in alternate embodiments, there may be a list of priority values for each customer attribute, each priority value being associated with a different entity, such as a commercial establishment, store or even customer or a combination thereof. As such, a commercial establishment, e.g. a premium user of the system 100, may set its own priority values to derive maximum information from its customers that is most useful to it. Likewise important clients may have tailored priority values. In alternative embodiments, the customer attribute priority values may be stored in the customer preference data 330 as an additional field for the entries, either being identical for all customer, or individualized.

Thus the profile builder module 531″ also goes through for priority values for the customer attributes to identify the highest priority customer attributes.

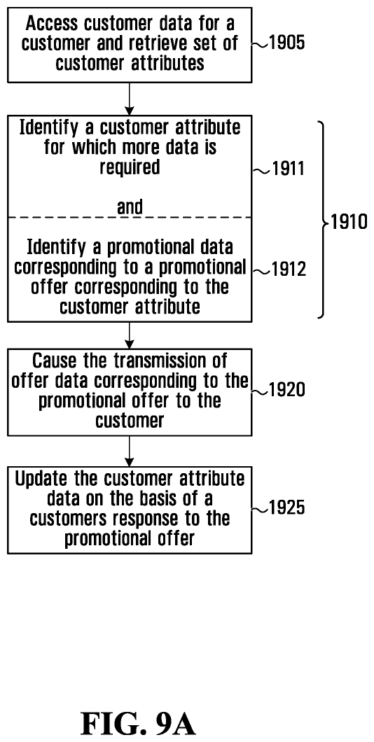

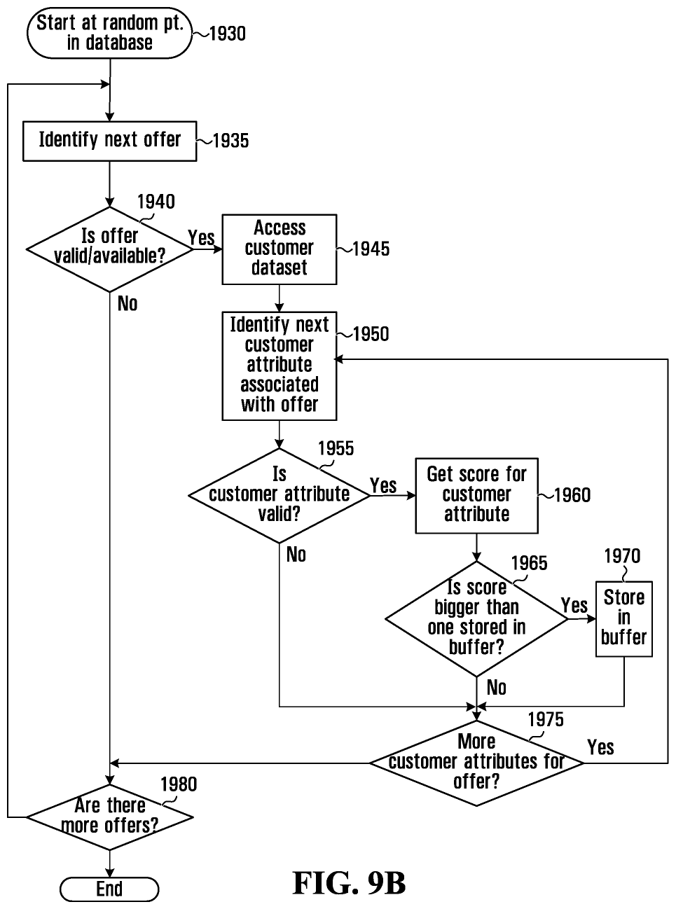

We therefor have a selection of a promotional offer based on three variables: the customer attributes for which we have little knowledge for the particular customer 120, the available promotional offers and more specifically their associated customer attributes, and the priority level of customer attributes. The profile builder module 531″ runs a search algorithm to identify the optimal promotional offer to offer to the customer 120 satisfying these factors. An example of this algorithm is illustrated in FIG. 9B. In the present example, this is done in the following manner: first the available promotions are search by running through the promotional database and identifying the promotions that fit the availability criteria: in this case that they apply to the store 105 and that the other validity factors in the promotion validity data are respected. In this example, the algorithm goes through each promotional offer, identifying the next one 1935 one-at-a time from the starting point onward. For each promotional offer identified it verifies whether this offer is valid/available 1940. In order to avoid an uneven distribution in offers, the search starts 1930 at a random point in the database. Alternatively, it could start after the last point searched in the promotional database in the last search performed, or elsewhere.

When a valid promotion is found, the customer attributes associated thereto are identified in the promotion attribute data 930 and the customer dataset 300 is search to identify the confidence level associated with each for the customer. In this example, first the customer dataset is accessed 1945, the customer attributes are identified one at a time by starting from a first one and going on to the next one 1950 until they are exhausted. The customer attributes are verified for validity 1955. In this example, all the customer attributes having a confidence level above a certain threshold (e.g. 5) are dismissed. Step 1955 is optional and could be omitted if all customer attributes are considered valid. If a customer attribute remains, a score is then obtained for the customer attribute 960. This score can be simply the priority level or confidence level if that is the determining factor for the most important attribute. In this example, the remaining customer attribute(s) is/are searched for in the customer attribute library and the one with the highest priority level is selected. The resulting promotion/customer attribute/priority level is stored in a buffer 970. The process then moves on to the next available promotion, except that before storing it in the buffer at step 1965, it compares the new promotion with the one already in the buffer and keeps in the buffer the one that has the highest priority level. In case of a tie, either one may be selected or optionally, ties can be kept in additional buffers to be supplanted as a group when a higher priority is found. This continues until we have one (or in the optional embodiment, perhaps more than one) top priority available promotional offer that would yield useful information. At step 1975 it verifies if other customer attributes are related to an offer before stopping the search of customer attributes for the customer, and at step 1980 it verifies whether there are more offers to search through before going to the next offer. At this step, it may also verify whether the maximum score has been obtained, at which point it may also stop searching through the offers since no higher-scoring offer may be found.

Thus the searching function may conclude as soon as a suitable promotional offer, that maximizes usefulness of the information that can be derived from it, is found. Other selection algorithms can be used. And algorithms may be optimized by sorting the data in databases. For example, the customer dataset attributes may be sorted by priority level and searched through in order of priority. The same thresholds and inclusion/exclusion principles as described above may be used to obtain the most relevant result. Likewise, the promotional database may also be sorted according to particular fields to speed up searching. Moreover, although in the example of FIG. 9B, the search is ended when the highest score is found, a “good enough” threshold may be implemented instead, halting the search once a score above the threshold is achieved. This has the advantage of finding best or near-best results potentially quicker.

In other embodiments, priority values may be absent, leaving only two variables to deal with and eliminating a step from the above procedure. Thus a weighted function of the priority value and the confidence level of each customer attribute as a function of availability of corresponding promotional offers is applied. The weight of the confidence level in the above example was essentially binary, based on a threshold, but more complex weighting could be implemented, for example the sum of the priority and a reciprocal (e.g. 9−x) of the confidence level could be used as weight to determine which promotional offer to keep.

In the Example of FIG. 9B, a score is calculated based on the determining factor for the most important attribute, which may include the priority level or confidence. Instead of calculating this score while searching, it may be stored in the customer profile dataset, e.g. as a field for each customer attribute. This “attribute selection score” may then be calculated every time on entry of a new customer attribute, if entered, upon modification of a customer attribute (e.g. to provide a new confidence level) or upon external factors (e.g. a change in the priority level of the customer attribute). This shifts the computation work away from the search for faster searching. The score may be computed as described with respect to the search or elsehow and as a function of various customer attribute data and promotional offer data as well as, optionally, thresholds. For instance, in some examples we may not be interested in customer attributes having a confidence level of 7 or above, judging these to be sufficiently confident, in such a case every attribute with a confidence level of 7 or more is assigned a selection score of 0. The score may be assigned as a function of the rest of the attributes. In our example, it is assigned (after passing the threshold requirement) as a function of the confidence level and priority level, e.g. as [((threshold of confidence) −(confidence level))*(priority level)]. In this example, an attribute with a confidence level of 2 with a priority level of 3 would have a selection score of (7 −2)*(3)=15 while an attribute with a confidence level of 5 with a priority level of 6 would have a selection score of (7−5)*(6)=12. We may add additional threshold, including inverse threshold, e.g. to assign a maximum score value (e.g. 99) to attributes that meet additional constraints. For example, we may assign a maximum selection score to any attribute which has a confidence level <7 and a priority level of 10. It should be appreciated that the score computation methodology described here may computed during the search instead of pre-storing scores.

In such a case the searching algorithm is modified to incorporate the thresholds as decision boxes, and the score is calculated for each attribute that meet the thresholds until the highest possible value is reached, until the search has been exhaustively concluded or until a “good enough” threshold is met.

Having found a promotional offer, the promotional module 530″ now accesses and transmits the offer data 920 associated to the offer to be displayed to the customer 120. This may be done in a number of manners, e.g. directly to the customer app 500 or directly to a display 140 near the customer 120. For example, upon entering the store 105 and connecting to the Wi-Fi™, the customer app 500 may display a banner ad for a selected promotional offer.

However in the present embodiment, the in-store computing device 115 is used. Specifically, when the system server 170 communicates to the in-store computing device 115 the available promotions for display on the promotions transfer window 870 an indicator (e.g. a flashing frame) is provided to identify the selected promotional offer(s) that would yield the most useful results. This allows the system to be used very powerfully as it combines the algorithmic data farming power of the system server 170 with the personalized human interaction of the system 100. By providing the employee 110 with a visual instruction suggesting to offer a certain promotion to the client, the employee can weave the offer into his interaction with the client for maximum impact. For example, an employee may look at the client profile and suggest “I noticed that you made a big purchase last October. I'm authorized to offer a special promotion to clients like you. I'll send it to you now.” and use the system described to cause the promotional offer to be transmitted to the customer 120. Likewise, if multiple promotional offers have been selected by the system, this too may be very effectively used, because the employee 110 can offer a choice to the customer. Doing so increases the chances of a customer attribute being discovered since the customer 120 is likely to choose a promotional offer that is useful to them. Moreover by being forced to select an offer, the customer 120 has already made a commitment of sorts to the offer and is more likely to use it as a result.

This selection function may be run in a thread instantiated when the customer 120 enters the store, but may also be triggered by other things, such as the initiation of a chat session or run periodically, e.g. starting with the customer entering the store and ending when he leaves.

Upon offering the customer 120 a promotional offer at the in-store computing device 115, a message is sent by the employee application to the system server 170 indicating that the promotional offer has been provided and identifying the promotional offer ID. Upon reception of this message a function in the profile builder module 531″ is called to update the customer profile dataset 300, specifically to add to the customer promotion data 330 an entry related to the promotional offer, or to update the existing entry if there is one. Since many promotional offers may be provided at the in-store computing device 115, the particular suggested promotion may be highlighted, flashing, outlined, or otherwise provided with a visual indicia indicating that it is suggested and of particular interest.

A response to the offer is received when the customer 120 redeems the offer by performing a transaction. The sales information comprising the customer identifier and the promotion identifier serves as the response and is transmitted to the system server 170 with the profile builder 531″ updating the customer preference data 330 accordingly. In alternative embodiments, the customer app 500 may include an accept/decline step when receiving an offer prompting the customer 120 to provide input indicative of an acceptance or rejection of the offer. This information may be transmitted to the system server in a message comprising the input provided by the customer 120, upon reception of which a profile builder 531 function is called to update the customer preference data 330 accordingly. On acceptance of an offer the confidence level of related customer attributes may be incremented by the strength listed in the promotional attribute data 930, by a fraction of that strength (since the customer 120 has not yet redeemed the offer), by a single point, or according to any other rule depending on design preferences. The increase could also be stored and deducted from a future increase resulting from a transaction redeeming the offer. On a decline of the offer, the confidence level may be left unchanged, may be reduced by a certain amount (again, set amount, strength number, or fraction thereof) or may be set to zero.

FIG. 9A illustrates an example of the profile builder function described above. As shown, the function accesses the customer attribute data to retrieve the set of customer attributes at step 1905. At step 1910 the customer attribute for which more data is required is identified (substep 1911) and the promotional data corresponding to a promotional offer corresponding to the customer attribute is identified (substep 1912). This may be done in the manner described above. At step 1920 the function causes the transmission of offer data for the promotional offer and upon receiving response data at step 1925, the offer customer profile is updated.

As the customer 120 interacts with the employee 110 in the chat session, the profile builder updates the customer dataset 300 with new data as described herein. Updating the customer dataset 300 may be used as a trigger to run the promotional offer selection function described above. However in the present example, another function is used.

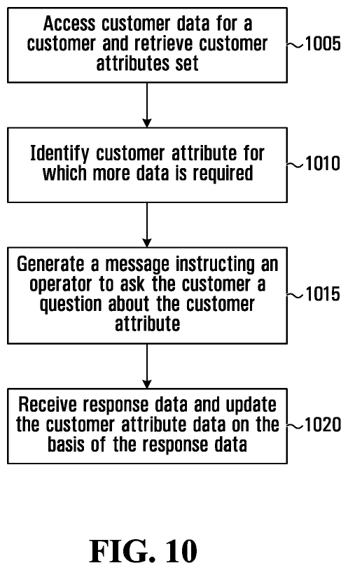

FIG. 10 illustrates an example of such a function wherein at step 1005, the function accesses the customer attribute data to retrieve the set of customer attributes. At step 1010 the customer attribute for which more data is required is identified. At step 1015, the function generates a message instructing an operator to as the customer a question about the customer attribute and at step 1020 upon receiving response data the function updates the customer data for the particular customer attribute. This will now be described in more details.

Specifically, the profile builder 531″ comprises code for running a chat suggestion algorithm. The chat session provides a unique opportunity to obtain data about the customer 120. Here too the system 100 provides incredible strength by combining the data-crunching power of the system server 170 with the personal service of human interaction by supplementing the employee 110 with useful question suggestions that will add useful data to the customer's profile. By providing the questions to the employee to ask the system benefits from human judgment to choose exactly how to ask the question such that it flows with the conversation and potentially choose when not to ask the question because it would not seem natural. In this manner the system 100 can outclass natural-language AI-based system for providing the customer 120 and experience that feels natural and not strangely intrusive as AI systems tend to do.

In this example, this functionality is provided by a second function run in a separate thread that runs throughout the chat session. To being with, the profile builder module 531″ identifies customer attributes for the customer 120 about which more information is required. This can be done on the basis of the confidence level alone, however in this embodiment the priority value is used as well. A weighted function is used, such as the one above, with the exception that the function is not limited to available promotional offers. the search algorithm can be modified accordingly. In this example, the algorithm first searches through the library of customer attributes, beginning at a random point therein to avoid uneven distributions, and goes through the entries until it finds one with a nonzero priority value. The function then searches through the customer preference data 330 for the customer attribute and if it does not find, meaning that no information is known about this attribute, it stores the attribute, the priority level and the confidence score (in this case nil) in a buffer. If it finds it, it does the same but provides the confidence level found in the customer preference data 330 unless it is zero (indicating that it is known for certain that the customer 120 does not have this attribute) or nine (indicating an attribute known for certain), in which case it skips this attribute and continues the search. The function continues the search through the attribute library now stopping only at attributes that have a higher priority value than the one stored in the buffer. When it finds one, the customer preference data 330 is searched for the particular customer attribute. Again, if it doesn't find it, it supplants the buffer with this new attribute, priority level and nil confidence level. If it does find it, the function then performs a weighted comparison of the two. This could involve applying a binary decision on the confidence level (e.g. first select whichever has the lowest confidence level, then if its tie, the higher priority level; or select whichever has confidence less than 5, and if that's tie then the higher priority level) but in this case the priority level is added to nine minus the confidence level for both the attribute in the buffer and the presently-found attribute and the one with the highest score is kept (in case of tie either may be kept). This is repeated until either the highest possible score is attained or no remaining customer attributes are found in the attribute library. Moreover, although in this example, the search is ended when the highest score is found, a “good enough” threshold may be implemented instead, halting the search once a score above the threshold is achieved. This has the advantage of finding best or near-best results potentially quicker. Other selection algorithms may be used.

Having found a customer attribute for which more information is required, the system server 170 now sends to the in-store computing device a message indicating the selected customer attribute. The employee application 500′, having received the message displays a bubble over the top of chat window (or in some other suitable location) a message instructing the employee 110 to ask about the customer attribute. In this example, a bubble saying “consider asking about [the customer attribute, e.g. having young children]”. The bubble may be displayed permanently, until the grading function updates the particular attribute, or for a limited period of time.

The employee 110, seeing the suggestion can formulate a question asking about children. Exploiting the fact that the asker is human, the employee may then find a clever way to ask the question in conversation. For example they may ask “is this for your children” or “ah yes, that sounds like a great plan, do you have any children you'll be taking with you?” Follow up questions such as “Wonderful! I have a 5 year old. How old are yours?” may be used to complete the request for information if a first question doesn't do it.

A response to the question is received by way of the chat session which is fed to the system server 170 and parsed for information as described above. The profile builder module 531″ may monitor the results for information answering the question so as to note that it has been answered (e.g. to trigger removal of the question bubble on the employee 110's screen), however this is not necessary as the suggestion function continues to run and will update the question suggestions according to new needed information as the customer's profile is built.

The function is run continuously throughout the chat session such that the question suggestion may be updated. Optionally, it could run on a scheduled basis but in the present embodiment, it is triggered by the reception of a chat message from the customer mobile device 125.

After the first suggestion, the function may add an extra element to the selection algorithm that selects a customer attribute to ask about. Specifically, it may favor attributes that are related to the conversation at hand. To this end, the customer attributes library may comprise relational information detailing relationships between different customer attributes. A similar system exists in the customer preference data 330 where different attributes (e.g. products, associations and activities) may have links to others. In the case of the customer attribute library, this may be contained in a single field for each attribute listing all related attributes. As the system server 170 parses the chat conversation and identifies in the customer 120's text customer attributes with which to update his profile, the attribute selection function may add as a weight in the weighted selection function a weight for the attributes which have been found. To this end, it may store a buffer (e.g. a circular buffer holding the 5 most recently mentioned attributes). When computing the score, extra points (e.g. 5) may be provided to customer attributes that are found in the buffer. In this manner, the next question suggestion is likely to be related to the conversation at hand, making it easier for the employee 110 to weave it into the conversation and making it less likely that they chose of ignore the question suggestion or that their question comes off as intrusive or unnatural.

A similar system may also be used by the promotion selection function. The function, which may run continuously, e.g. on a scheduled repeat, while the employee is in the store 105, may also access the buffer of recently discussed attributes and provide weight to those making it more likely that a relevant promotion will be used. In one embodiment, the customer attribute selected by the customer attribute selection function is stored in a buffer accessible to the promotion selection thread and upon updating the buffer a signal is sent to the thread to search specifically for a promotion related to this customer attribute. If found, it is transmitted in the usual fashion. As such, the employee 110 may be prompted to ask about an on-topic attribute (e.g. “yes, these boots will do very well for the kind of hike you are doing, tell me are you planning to camp on this hike?”) and immediately see appear flashing in the promotion subwindow a promotion for camping gear. That way, if the customer 120 replies in the affirmative, the employee 110 may immediately offer a promotion on camping gear as an incentive to add camping gear to the customer 120's purchase.

Although in this example, the profile builder module 531″ is implemented in the system server 170, in certain embodiments some or all of the functionality of the system server 170 may be implemented in other devices, with the profile builder 531″ accordingly being provided in another device. For example in a single-store implementation of the system 100, the system server 170 could be implemented in the in-store computing device 115.

Optionally, additional data may be used by the profile builder module 531″ to populate the customer profile dataset 300 with data. For example, where the customer 120 is using the in-store Wi-Fi™, packet addressing information and packet inspection may be used to identify the sites the customer is visiting and what the customer is searching for. These details may be provided to the profile builder module 531″ like parsed data from chat logs to populate the customer preference data 330. Likewise tracking data from cookies used on the store's website or other partner's websites may also be used in the same manner.

It will be appreciate that the current system allows a customer to be served by an employee in real-time via a chat interface, even as other customers may be served by the same employee. If it become necessary for the employee 110 and the customer 120 to meet face-to-face, for example if the employee needs a demonstration on how to use a product, the employee 110 can easily approach the customer. To this end, location data of the customer may be transferred to the in-store computing device 115 by the system server, along with the customer profile data. In fact the customer location may be included in the customer identification data 305 and updated in real-time. The employee application 500 may then display the customer location by any suitable means, e.g. using a map interface or by aisle number or the like. For this latter purpose the system server 170 may also include an employee location reducer method which functions similarly to the method for determining the closes display 140, but instead identifies the aisle (or other landmark or topological feature) most closely corresponding to the customer 120's location (or more precisely to the customer mobile device 125's location).

Optionally, similar location logic may be provided for the employee 110 using analogous logic in the in-store computing device 116 and system server 170 as was used for customer location, and this information may be provided to the customer 120 in the same manner as the customer 120's location was provided to the employee 110.

With or without location information, the customer 120 and employee 110 may easily meet thanks to the ability to communicate location over chat and, optionally, to photographic information provided. This allows a customer service conversation to continue offline when necessary. Unlike with any other system, the current system allows for continuity of record with the offline conversation as the employee 110 enters notes regarding the offline conversation into the in-store computing device 115. Consequently, a notes may be associated with a chat log by the employee to bolster the content of the customer profile based not only on the chat conversation but on offline conversation as well.

Although in the provided example, the chat conversation was text-based, it will be appreciated that existing technology can support voice-based connections between the employee 110 and the customer 120. This has the disadvantage of reducing the ability of the employee 110 to hold concurrent conversations with different customers but may be preferred by the customer. Accordingly a voice communication interface may be added instead of, or as a supplement to, the text-based chat. Voice files may be stored in the same manner as chat logs. In addition, automatic voice-to-text algorithms may be used to derive a text-based log from the voice exchange to be stored as chat logs (linked to the corresponding voice file or alone) and to be treated in like manners for the purpose of profile building.

Moreover, although the system server 170 in the examples shown here was a remote or even cloud-based server accessible through the internet 165, it should be appreciated that the system server 170 may be implemented locally within the store 105 or overarching commercial establishment. In such a case, the customer interaction system 100 may likely be limited to the store 105 or commercial establishment (unless connections by external third-party stores is permitted) and as such will lose the benefit of shared data amongst multiple stores.

In some alternative embodiments, the system server's functionality may in fact be entirely implemented at an in-store computing device that performs both the functions of the inst-store computing device 115 and that of the system serve 170. In such a case the communications between the in-store computing device and server would become unnecessary or merely inter-process or intra-process communication.

In one variant, the employee application 500′ further comprises transfer capabilities to save the context concerning a particular customer and transfer handling of that customer to another in-store computing device. To this end, the entire context, including the contents of the customer management window 800 and the promotion interface window 850 is saved and transmitted to another device. In one example, the computer 116 may have been used to begin an interaction with the customer 120, including a chat, and the operator at the computer 116 (another employee) has decided to transfer the session to an expert on the particular subject at hand, employee 110.

To this end, the employee application 500′ comprises a function to identify another employee, e.g. by employee ID, and to cause the transfer of a session to the employee. In certain embodiments, this may be done by actually saving the context and causing a transfer (e.g. via the system server 170) to the other employee's device. However, in the present embodiment, where chat communications and other parameters all go through the system server 170 where they are recorded in real-time, it is only necessary for the employee application at the computing device to transmit to the server a message indicative of the transfer of employees and identifying the recipient employee 110 and concerned customer 120. The system server 170, upon receiving this message identifies the employee 110 in the server storage 175. In this embodiment, the employee profile dataset 300′, and particularly the employee identity data 305′ comprises a field with the network address of the in-store computing device 115 used by the employees. For example, this field may be updated any time an employee logs on or out of a particular device. The system server 170 then merely needs to transfer the data previously sent to the computer 116 to the in-store computing device 115 of the employee 110 and the employee application 500′ will present it according to its programming. In embodiments where the employee application 500′ is a web app, this may simply be done by including the relevant customer data in the web data sent to the in-store computing device 115.

It will further be appreciated that although the present examples concerned a particular physical store 105 and an in-store computing device, in some instances the device may not be in the store 105. It has already mentioned that the store 105 may be any kind of commercial venue, but in addition, the employee 110 may be located outside of the store 105. This loses some of the advantages of, e.g., having immediate access to the employee 110 for face-to-face discussions if needed, but has the benefit that it allows even more flexibility to the customer interaction system 100. For example, if a particular expert is needed to answer a customer question, the employee 110 using the above-described embodiment, may transfer the customer 120's session to a remote expert (e.g. a company-wide expert at national head office). Or if a customer complaint needs to be escalated to higher management outside of the store 105, or if it merely needs to be escalated to a manager but none is present, the relevant person may be reached using this system. Likewise, in an alternative embodiment, customers may be first connected to a call-center-style employee beyond the store 150 and transferred to someone in the store 105 if the conversation requires it.

In yet another variant, the system 100 may be accessible to customers even when they are beyond the location of the store 105. In such a case, customers may log in and be connected to an employee at the nearest store, or alternatively at a main office (e.g. call center) or alternatively still, at a store chosen for availability of employees (or the last store the customer visited).

FIG. 2C illustrates another exemplary implementation where the customer interaction occurs over a web page, rather than in a physical store premises. To simplify illustration of this aspect, the physical store premises and related devices have been omitted in FIG. 2C, however, the particular aspects illustrated and described with respect to FIG. 2C need not be isolated but may be included in a holistic system, using a same system server 170 and server storage 175 to provide expanded capabilities to the above-described technologies.

In this particular implementation, the customer mobile device is a customer computer 125a. The customer computer 125a is a web-capable device having a web browser such as a laptop or desktop computer, although many other devices can be envisaged, including the customer mobile device 125, which may serve as customer computer 125a, or which may be used alongside the customer computer 125a, for example as described in the examples above.

In the present example, a web interface is provided to the customer 120 linking the customer 120 to the features of the system already described but via the web from any location.

In a first embodiment, the system server 170 is in communication with a web server 205 to exchange therewith database data such as customer profile data and promotional data. Although shown here as a separate physical device, it will be appreciated that a same computing device, multi-server array or cloud-based system. In any event the web server 205 hosts a web interface that is accessible through a web browser by remote internet-connected devices such as customer computer 125a. Moreover, although shown here as unitary, it will be appreciated that web servers can be implemented using distributed architectures such as using cloud hosting services that may provide redundant servers accessed through a load-balancing server. However a single server is shown here in the interest of simplifying the present explanation.

In this example, the web 205 server provides a web-interface for the commercial establishment of the earlier examples. If the customer interaction system is used for multiple different commercial establishments, as is beneficial as it allows them to share data in a mutually-beneficial way, then the web server 205 may host several different web-interfaces using different web sites for each commercial establishment. To this end, there may in fact be multiple web servers 205 hosting different web interfaces, although sharing hosting space is also possible as is the case in the illustrated example, where a single web server 205 hosts the web interfaces of several different commercial establishments using the customer interaction system.

Alternatively a single web interface may provide a single point of contact for multiple commercial establishments sharing web space such that a single web site accessed through a same URL provides access to products/services/promotional offers of multiple different commercial establishments.

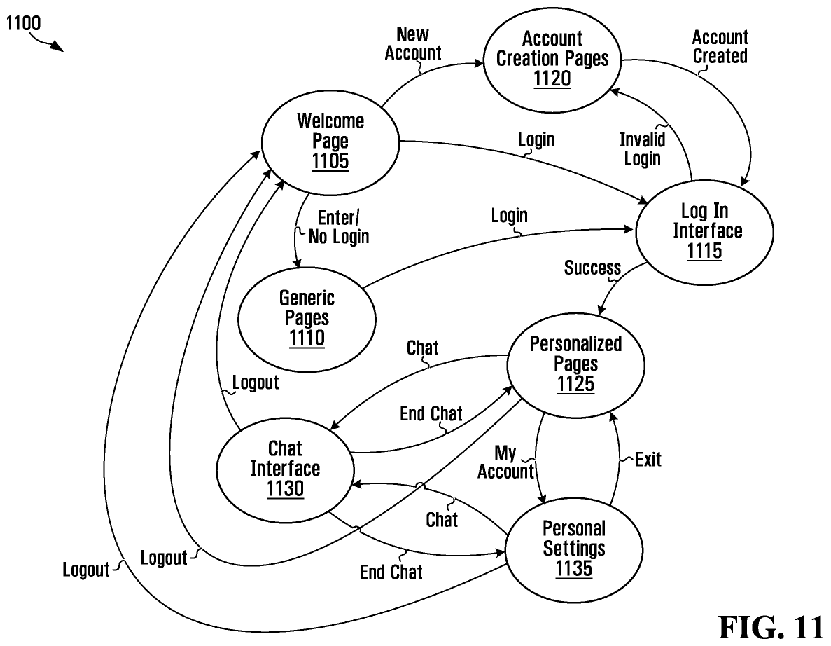

FIG. 11 shows a state transition diagram 1100 of the web interface provided by the web server. Each state in the diagram represents one or more different presentations to the user. In the present example these are provided via individual html-coded pages, however the reader will appreciate that modern website design technology offers varying ways of providing a user with presentation subject matter (referred to herein as pages for simplicity), e.g. using embedded executable code running a GUI within a single web page. In this example, the customer 120 is using the customer computer 125a at their home.

A welcome page 1105 is made accessible to the customer, preferably through a convenient URL. The welcome page 1105 is any page upon which a non-logged in user may arrive by default. In the present example, the welcome page presents a “login” button and a “proceed without logging in” button.

Upon clicking the login button, a user is taken to a log in interface 115, which in this example is a simple page with input tools for entering an identification method, e.g. a username and a password in respective text boxes. Validation is requested by typing enter or clicking an “OK” (or similar) button.

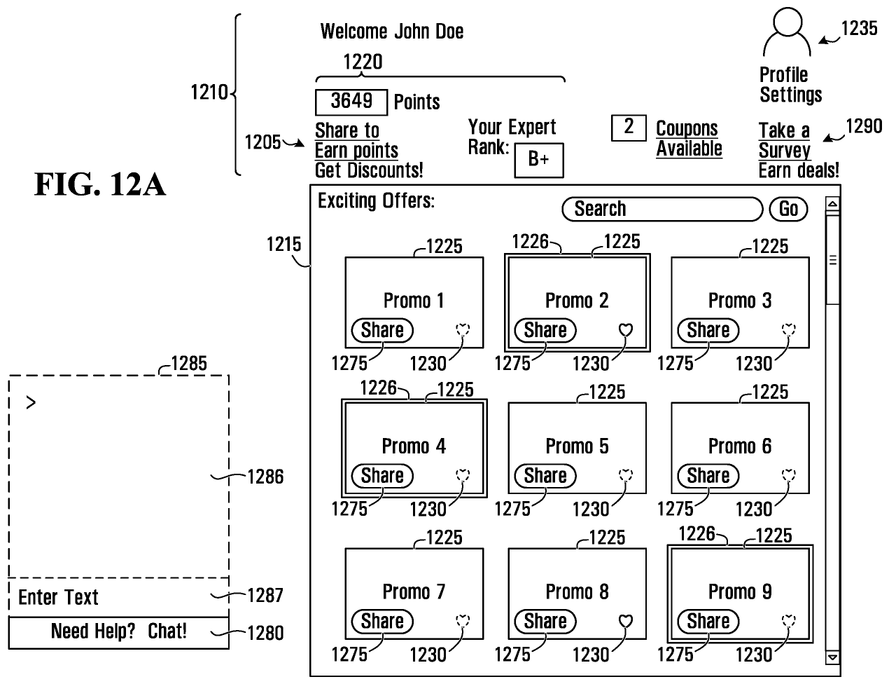

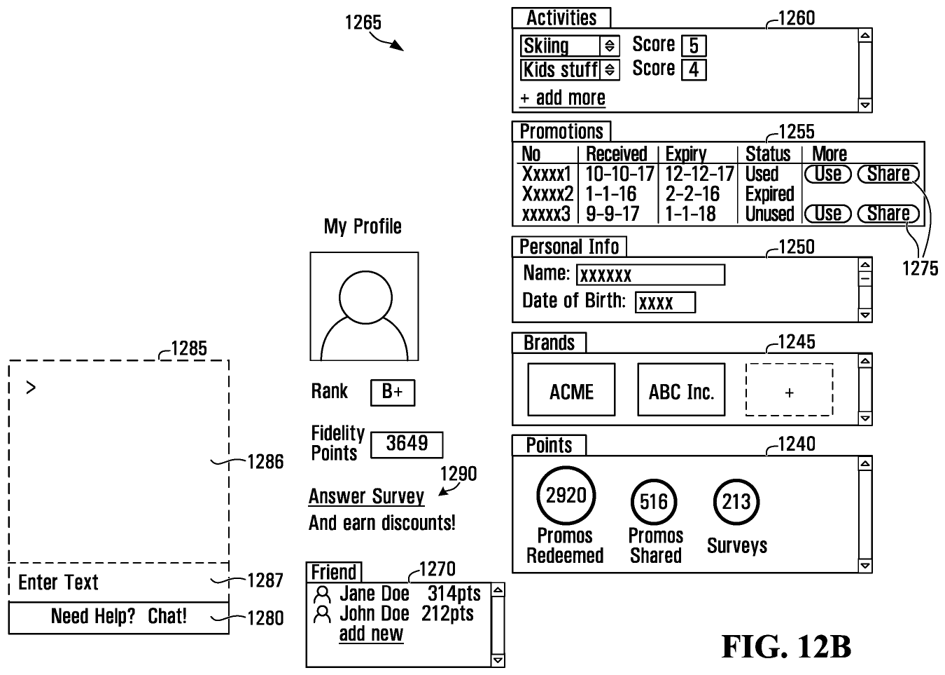

From the welcome page 1105 it is also possible to create anew account. A button or other input tool therefor is provided. Choosing to create a new account brings the user to account creation pages 1120. The account creation pages 1120 are one or more page providing the user with input tools such as text boxes and scroll lists with which to enter personal information to create an account. During the account creation process basic information such as the contents of the customer identification data 305 in the customer profile dataset are received from the customer via the web interface. Optionally, certain preference information may be entered, e.g. by including preference related question in the account creation questionnaire (e.g. how many children do you have? age? etc. . . . ), by directing the user to a survey with preference-related questions. In the present example, the account creation pages 1120 include a representation of the user's profile page with overlaid instructions on filling the profile page with information, including preference information. The profile page will be described further below with reference to FIG. 12B.

The web server 205 is in communication with the system server 170 to exchange therewith data requests, instructions and information messages concerning customer data, promotional data and, in some embodiments, employee data.

Once user information has been collected from the new user, a create_user message is transmitted from the web server 205 to the system server 170 transmitting this information with instructions to create a new customer profile with the data. The system server 170 may apply any validation or constraint deemed appropriate. Upon successful validation, if required, the system server 170 creates a new customer profile dataset for the new user in the customer profile database and populates the customer profile dataset with the information received from the customer and from the customer computer 125a via the web server 205.

Login data (e.g. username and password) collected from the user is provided by suitable means to the system server 170 in this example by transmitting it in a login message. The Web API module 555″ accesses the customer profile database to validate the login information and, if validated, transmits a message confirming that the login information is correct and comprising user profile data used by the web server 205. In this particular example, the entire customer profile dataset is transmitted to the web server 205, although in alternate examples only portions thereof may be provided. In response the web server receives a message validating the login data created and transmitted by the system server 170 and receives customer profile data.

In the present example, upon unsuccessful login, the user is directed towards the account creation pages 1120, although other implementations are possible.

Upon a successful login, the user is taken to personalized pages 1125. In the present example, the personalized pages 1125 include a custom web page containing promotional offers customized for the particular customer according to the customer preference data 330 and customer promotion data 390 in the customer profile dataset 300. In this particular example, a promotional page 1205 is first presented.

The promotional page 1205 is generated automatically by the web server using automated web page building techniques. The promotional page 1205 is populated using some customer identification data 305 in a customer profile portion 1210 and customer promotion data 390 in a promotion portion 1215.

The customer profile portion 1210 comprises a welcome message bearing the customer 120's name. Customer metadata 1220 is also provided, which is compiled based on the customer preference data 330 and customer promotion data 390. In this example, this includes a point score and an expert rank, although any incentive system may be used. Here the points are computed as a function (any suitable function may be used, e.g. simple sum or weighed sum) of promotional offers used, promotional offers shared and surveys answered, although other score-contributing factors may be used. Here the expert rank is computed as a function (any suitable function may be used, e.g. simple sum or weighed sum) of past purchases made and time spent viewing products/promotions or number of products/promotions viewed. Again, this is merely an example and many other incentive systems may be used. The customer profile portion also includes information derived from other sections of the customer profile dataset 200, in this example, it includes an indication of how many “coupons” or redeemable promotions are currently available.

The promotion portion 1215 comprises one or more representation of a promotional offer. In this example, each promotional offer displayed is presented as a visual indicium 1225 in this case an image representing the promotion. The image may include a picture of the item(s) or representing the service(s) concerned and text details such as a price (e.g. 599$), a discount (e.g. -50% or 30$ off), a descriptor (e.g. All Acme Leather Boots) and other promotional or descriptive information. In this particular example, each visual indicium 1225 is associated with an actuatable indicator of interest 1230, in this case these a heart icon superimposed on the visual indicium 1225. The indicator of interest 1230 can be actuated using a user input device, in this case by clicking the heart icon.

The promotional offers presented in the visual indicia 1225 are obtained by the web server 205 by querying the system server 170. In this example, a specific query is not required as the system server provides a complete set of applicable promotions upon successful login. However, in order to avoid caching more information than necessary at the web server 205, promotional data may be specifically requested as required. The Web API module 555″ of the system server 170 consults the promotional database to derive in this example all applicable promotions (again, the volume of data obtained could be reduced by implementing a request-based promotion seek) to the particular customer 120 for the concerned commercial establishment(s) and transmits these to the web server 205. In this example, the web server 205 comprises program code for selecting the promotional material presented based on locally-selected parameters and preferences, although in alternate embodiments what the web server 205 displays could be dictated entirely by what the system server 170 provides.

The promotional data provided by the system server 170 in this example includes promotional data associated with the customer 120, as would be found in the customer profile dataset 300 as well as data for other promotions, which may be selected, for example, on the basis that they apply to the particular commercial establishment(s) served by the web server 205 in the particular request at hand. The web server 205, receives the promotional data and generates the presentation of the promotional portion, generating the visual indicia 1225 based on the promotional data (e.g. using images stored with the promotional datasets 300) selecting certain available promotions on the basis of programmed selection rules. The program selection rules may include rules to select particular promotional offers that the concerned commercial establishment(s) are prioritizing (e.g. we just received a new brand and want to promote it intensely this season), rules to include a certain number of customer-specific promotional offers (e.g. place at least three customer-specific promotional offers), rules to include promotional offers not specifically linked to the customer account but selected according to the customer preference data 330, and any other rules including rules to select random promotions when no other rules apply. Promotional offers can also be ranked by relevance to show the most relevant ones first. Finally, the web server 205 may rank promotions and provide visual cues to emphasize certain promotions by, e.g., selecting one or more to use in an enlarged add or by adding accent frames 1226 around the corresponding visual indicia 1225 as is the done in this example. All these rules may alternatively be implemented at the system server 170 at the Web API module 555″ the result of which is transmitted as instructions to the web server 205.

Now the logic implemented with respect to the promotion selection described earlier may be used here. For example, the logic used to populate the promotion transfer subwindow 870 and the displayable promotions subwindow 890. In this particular example, the functions of the profile builder module 531″ are used to select promotions that are considered useful to build the customer 120′ profile. Indications of which promotional offers are considered useful to build the customer 120's profile is transmitted along with the promotional data by the system server 170 to the web server 205. Either dictated by the system server 170, where the system server 170 has control over presentation by the web server 205, or as selected by rules programmed at the web server 205, such useful promotional offers may be prioritized by specifically selecting them for display, by providing them with a prominent display (e.g. high rank/relevance, or emphasis cue such as the accent frame 1226 or enlargement or prominent positioning).

In the present example, the web server 205 either under its own programmed rules or based on instructions received from the web server 170, has selected promotional offers numbered 1-9 in the figures, of which promotional offers 1-3 are already linked to the customer 120 in customer promotional data 390 with promotion 2 corresponding to a particularly relevant or soon-expiring promotional offer. Promotion 4 corresponds to a promotional offer selected by the profile builder module 531″ as useful to building the customer 120's profile. Promotions 5-9 are other applicable promotions and promotion 9 is specifically a promotion prioritized by the commercial establishment. Promotional offers 2, 4 and 9 have been provided emphasis cues; 2 because it is particularly relevant or expiring soon, 4 because it is useful, and 9 because it is prioritized. Other rules for selecting emphasis may be applied.

The web server 205 gathers response data concerning the customer's response to promotional offers. Any customer interaction with the web interface may be used as response data and existing techniques may be applied. In the present example, the web server 205 compiles data concerning user interactions including: use of one or more user selection tool (in this case, this includes location of the mouse cursor and specifically whether it is hovered over the visual indicia 1225), user-actuation of the indicator of interest (clicking the heart icon 1330 to symbolize the user likes the promotional offer), user-activated downloading additional offer data (in this case prompted by clicking on a visual incidium 1225 —another user selection tool use—which links to a page on the particular promotion) and user-initiated transactions concerning the promotional offer.

Concerning this last user-interaction, the web server 205 may include an online store interface for purchasing products. Any known online store technologies may be used to implement the online store. Where the web server 205 implements an online store, clicking on a visual indicium 1225 may not only open a page providing information on the promotional offer but the page may also provide the opportunity to by a related product or service. Where the web server 205 implements an online store, the promotion portion 1215 may be include purchasable products represented, for example, as any other promotional offers vial visual indicia 1225. Additional interface tools to browse products may be included. Promotional offer data derived from the system server 170 may be interspersed with products for sale which, although product information could be stored on the system server 170 as promotional data, may be hosted locally at the web server 205. Alternatively, the promotion portion 1215 may be implemented by the web server 205 as a particular portion of an online store web page dedicated to pushing promotions. In such an example, the web server 205 may be an existing online store interface which is supplemented by the customer interaction system 100 via the powerful tools provided by the system server 170's web API module 555″ which allow the web server to obtain augmented user-centric promotion presentation and to obtain multi-sourced user data for use in other desired ways by the web server 205 at the web server 205's designers' choosing and to cooperate with the system by reporting back user interaction data as user response data which may be used to populate the user profile database to continually improve the system. Thus the system server could be a wholly third-party server subscribed to the services of the customer interaction system 100.

Having said that, it should be noted as well, that although the web server 205 in this example is a separate server, the functionality of the web server could be implemented within an enlarged variant of the system server 170. In particular the web server 205's functionality could be implemented in a web server module of the system server 170, in which case communications between the system server 170 and the web server 205 would be replaced by internal communications performed using function calls and common access by the different modules to internal memory.

Turning now to the response data, as the web server 205 gathers response data using known techniques, this data is transmitted back to the system server 170 to be used by the profile builder module 531″ to augment user profile data in the server storage 175. In this particular example, any time one of the above-mentioned user interactions, or indeed any user interaction that is monitored by the web server 205 and/or is deemed useful and reportable according to the API implemented by the API module 555″. In this particular example, the web server 205 generates a data report in the form agreed upon according to the API to the system server 170 for every noteworthy user interaction and transmits them thereto upon generation. In alternate embodiments, the web server 205 may compile user interactions and transmit them in groups, e.g. using periodical reporting or event-based reporting (e.g. whenever a certain number of user interactions have been reached or a particular maximum delay has been reached, whichever occurs first).

At the system server 170, data reports comprising response data is received by the API module 555″ and transmitted to the profile builder 531″ which uses it to build the customer data in the manner already described herein.

The web interface also implements personal settings pages (in this example, one page) which may be accessed, for example, through a personal settings icon 1235. The personal settings page 1265 may include several different elements of the customer profile data from the customer profile dataset 300 and incentive data, including the expert rank, points. In this example, the personal settings page comprises a points subpage 1240 showing the breakdown of the customer's points, including the breakdown of how those points were accumulated. The page also comprises a brands subpage 1245 showing a list of the different brands that have been liked, and including a user interface tool through which to add more brands to indicate interest in additional brands. The page also includes a personal information subpage 1250 showing the customer 120's details, e.g. from the customer identification data 305, which in this example are updateable fields that can be modified by the customer 120. The page also includes a promotions subpage 1255 which shows promotions available to the customer, e.g. from the customer promotion data 390 obtained from system server 170. The page also includes in this example an activities subpage 1260 showing a list of activities, e.g. corresponding to the activities data 340 from the particular customer 120's customer profile dataset 300. Here too new activities can be added via a user interface tool. Moreover in this particular example, the level of interest score is displayed and modifiable by the customer via a user interface tool (and editable toolbox). This, or any other part of the personal settings page 1265 may be omitted in other embodiments, and other details may be added. Likewise the presentation need not be laid out as shown; for example the subpages may be displayed as tabbed categories in a single window.

In this example, modifications made by the customer 120 in the personal settings page 1265 are transmitted to the system server via data reports similar to those described above. Specifically here every user interaction is tracked and the web server 205 generates a data report according to the API and transmits it to the system server 170 detailing any modifications made as they are made. Alternatively, reports may be delayed. For example, modifications may be held as form data submitted by a “save” icon (not present here) and the report may transmit all modifications (or alternatively, the entire form containing all data in the page) upon submission of the form. The data report is received by the system server 170 at the web API module 531″ and treated like response data and submitted to the profile builder module 531″.

As shown, the personal settings page also comprises a friends subpage 1270. Indeed a social network-like interaction system may be implemented by the customer interaction system 100. The associations data 360 in the customer profile data stores a list of associated people. Additional associations may be created by the customer 120 using the web interface, e.g. by searching a list of existing users of the system and requesting addition of individuals to their associations list. In response, the system server 170 may note the request and provide a message requesting confirmation from the other user at their next login (e.g. through a customer mobile device or customer computer). Upon confirmation the two individuals may be mutually added to their respective associations data 360. In the present embodiment, promotional offers offered to one particular customer may be shared by the customer with the other customers in their friends list, which may action may contribute to incentive, e.g. by providing them points or expert rank increase. In the example shown here, a user interface tool (icon 1275) next to visual presentations of their promotional offers opens a dialog box allowing them to select a friend to share with or an e-mail address (or other communication tool) to communicate the promotion to.

A chat interface 1130 may also be provided through the web interface. In the present example, this is accessible by actuating a chat request tool, in this case by clicking the chat icon 1280. In this particular embodiment the chat icon 1280 is provided in each of the pages. Clicking on the chat icon 1280 will open a chat interface 1130, here a chat box subpage 1285 which comprises a chat window 1286 and a text entry box 1287. User actuation of the chat request tool puts the user in contact with an employee at a computer 116a, which may be the same as computer 116, although it is not necessarily located on premises but may be located elsewhere, e.g. at a head office, at a call center or even in a virtual office or other employee locations. In other respects the computer 116a may be similar to computer 116, providing the employee similar access to the customer profile data and having similar interactions with the system server 170 and implementing the same profile building tools.

It should be noted that in the present example, the chat interface 1130 of FIG. 11 is presented as a subpage and may is simultaneously presented with the current page (e.g. personal settings page or promotional page 1205) and not as a separate page. This allows the customer to keep shopping or providing customer profile data while chatting. Alternatively, the chat interface could be presented in a full page.

In one particular embodiment, upon actuation of the chat request tool, the web server 205 transmits a request to the system server 170 to put into contact the customer computer 125a with an employee, and the system server 170 acts as a bridge for the chat as in the earlier examples. Of course, the chat functionality of the system server 170 may be off-loaded onto a dedicated server communicating with the rest of the system server 170 via a dedicate API formalizing the interactions and information sharing otherwise done internally. In some implementations, the web server 205 may itself contain the functionality of such a chat server.

Finally, the web server can obtain more customer data by providing a customer an opportunity to answer surveys, e.g. by offering a survey link 1290. The survey may include a generic set of questions presented in a usual survey interface. However, in this particular example, the power of the profile builder module 531″ can be exploited to create custom surveys asking for specific information that is found to be required or useful using the profile building algorithm already described above. Survey questions presented to the user may include one or more survey question identified using the profile builder algorithm used to suggest questions to the employee 110 when chatting with the customer. As such the customer interaction system 100 also creates custom surveys by generating questions corresponding specifically to information about customer attributes which are unknown for the customer 120 (or about a customer attribute associated with which a low degree confidence), about customer attributes for which a high priority level is established, or about customer attributes which are considered likely attributes in light of other customer data (e.g. other customer attributes). These are compiled together into a survey, either on their own or along with generic questions. The web server 205 receives customer interactions indicative of answers (e.g. in any manner customer interactions are received described above) and transmitted to the system server 170 as a data report (e.g. in any manner data reports are provided described above). The system server 170 receives the data report at the web API module 555″ and provides the information therein to the profile builder module 531″ which derives therefrom profile data for the customer profile dataset 300 in the manner already described.

When at the welcome page 1105, the customer chooses to proceed without logging in, the web server 205 may present generic pages 1110 which may be similar to the personalized pages 1125 except without any personalized information, and without specially-selected promotional data. At any time the user may log in, by clicking on a login button provided on every page. The option of proceeding without logging in is optional and may be omitted in some embodiments.

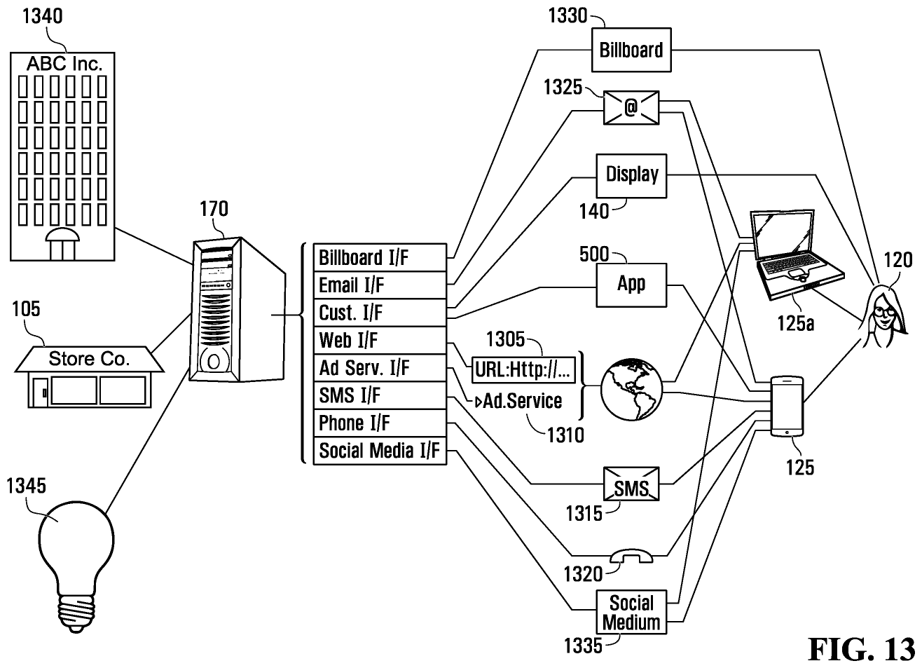

Thus the customer interaction system 100 provides multiple different ways of reaching out to the customer 120 with targeted promotional data and information. In one embodiment, this is not merely limited to application-based and web page-based communication, in fact the customer interaction system 100 provides a multi-dimensional approach to client engagement. FIG. 13 illustrates the customer interaction system 100 in this context.

As shown, the customer interaction system 100 may provide a large variety of different channels for communicating promotional data or other information to the customer 120. The customer 120, has multiple different access points through which to receive information, including through the customer application 500, through a web page 1305, or through an in-store display 140, all of which have already been described above. To this end, the system server 170 comprises a customer interface, implemented here by the customer API 540″, and a web interface, implemented here by the web API 555″.

Other communication dimensions are added to the system to allow different methods of reaching out to the customer 120. The additional dimensions may include telephony services 1320, SMS and like text message services 1315, e-mail services 1325, an electronic billboard services 1330, and one or more social media services 1335. In one embodiment, the customer interaction system 100 is configured to communicate with the customer over this plurality of services in a multi-dimensional customer interaction approach.

Having access to these different services allows the system to select how to contact a customer 120 according to different criteria, e.g. as a function of what means are available to reach the customer 120 or as a function of a contacting strategy according to a most effective way to reach the customer 120. According to the present example, the customer interaction system 100 implements a selective contact algorithm which implements a proactive, rather than a solely reactive, customer approach. In the present example, this is implemented by the system server 170 by the program core 505″.

In particular, the selective contact algorithm receives input indicative of a type of communication to be performed to the customer 120, specifically here the transmission of promotional data to the customer 120, and selects a channel by which to effect the transmission.

The input may be provided by an external input, such as by a user input whereby a system operator indicates a promotion that is to be provided to a particular customer. However, in the present example, a client outreach process runs constantly in the back ground and performs ongoing audits of the customer base to determine for each customer when and whether to contact the customer and what to communicate to the customer. In the present example the client outreach process continuously scants the customer profile database reviewing each customer profile dataset in order. For each customer profile dataset, the customer outreach process consults the customer preference data 330 to identify promotional material to provide to the customer, e.g. customer 120. In the present example, this is done in the same manner as already described above. However, in addition, the customer outreach process also consults the customer promotion data 390 to determine whether and how to contact the customer 120.

The customer outreach process may apply additional factors to those used in the promotional data selection described earlier. One such factor may be past promotional data communicated to the customer. The customer outreach process determines whether to communicate a promotional offer in part on the basis of whether and when it has been communicated to the customer in the past. For example, it may chose to communicate it if it has not been communicated more than x number of times n the last y days. Another factor is the time since the last communication. This is to avoid the system “bouncing” on a particular communication (repeated transmitting to a same customer 120) if it is not busy. To this end the customer outreach process determines when was the last time it has transmitted a promotional offer to the customer 120 and avoid doing so if it has been less than a particular threshold. To this end, the customer promotional data 390 may include for each entry a field indicating whether the offer transmission was requested by the customer outreach process.

Thus, the customer outreach process determines for each customer whether to contact the customer and which data (particularly here, which promotional offer) to communicate to the customer. The above process description is only an example and different approaches may be used. For instance, the above example adopted a customer-centric approach whereby decisions are made primarily based on the customer profile. However, a promotional data-centric approach may be used instead whereby the customer outreach process scans the promotional offers identifying the highest-priority ones and then searching for eligible customers to receive the promotional data (e.g. using the same scrutiny of customer promotional data 390). Alternatively, a commercial establishment-centric approach may be used, whereby the constraints and/or preferences of a commercial establishment (e.g. “contact all my clients with this particular offer this week” or “contact all my clients and offer them a deal related to their favorite applicable activity this week”) may be used as well.

The customer outreach process of this example is an independent process running on the system server 170 which communicates with the program core 505″ via inter-process communication. However, in other embodiments this may be implemented as a subroutine of the server program 500″ or may be implemented on another device and communicating with the server program 500″ via an API provided therefor.

Regardless of how the input is provided, the selective contact algorithm, which in this example is a subroutine of the program core 505″ receives input indicative of a particular customer (for this example, customer 120) and particular promotional data or a particular promotional offer to communicate to the particular customer 120. The selective contact algorithm then identifies the best way to reach the customer 120 to communicate this particular promotional offer.

To this end, the customer interaction service may comprise a plurality of interfaces each being adapted for communicating with the customer 120 over one or more of the customer communication services. In this example, these interfaces are provided on the system server 170. The selective contact algorithm determines which customer communication service to use to communicate with the particular customer 120 and instructs the corresponding interface to communicate the particular promotional offer to the particular customer 120.

To this end, the selective contact algorithm accesses the promotional database to retrieve promotional data corresponding to the promotional offer to communicate to the particular customer 120 and provides it to the selected interface. Specifically, having selected an interface the selective contact algorithm retrieves one or more sets of offer data 920 appropriate for the particular customer communication service. For example, for an e-mail it may select a textual description and a display image. For an internet ad service it may provide multiple sets of promotional data including a display video (to display as a video streaming service ad on a computer), a mobile video (to display as a video streaming service ad on a mobile device), a mobile image (to display as a banner ad on a mobile device) and a display image (to display as a page ad on a website). The selective contact algorithm also provides an identification of the particular customer 120 to the interface. To this end, the customer identification data 305 may comprise different sets of customer ID's suitable for the different interfaces. This may include for example, an e-mail address (already described) for e-mail services but may also include tailor-made ID's, e.g. an ad service identifier used by an internet ad services provider to associate customers with particular cookies.

The selective contact algorithm instructs the selected interface(s) to communicate with the particular customer the particular promotional offer and provides the selected interface(s) the customer identification and promotional data so obtained. In this particular example, the interfaces are provided as software module of the server program 500″ and as such this communication is done by intra-process communication over a shared memory, the data and instruction being provided on the shared memory. In other embodiments where the interfaces are individual processes, this may be performed by inter-process communication using any suitable protocol. Alternatively still, where the interfaces are provided externally, a suitable API may be used to communicate therewith through, e.g., the network interface 420″.

Some exemplary additional customer communication services will now be described.

In this particular example, the customer interaction system 100 uses one or more ad services 1310, which are internet-based ad placement services which sell ad space on the internet. Ad services 1310 may display ads on a variety of media including on website (e.g. banner ads), in video streams (e.g. as ad breaks or overlays), in apps (e.g. ad breaks or banner ads), in telephony applications and elsewhere. In particular, ad serves 1310 may be used to provide targeted advertisement based on user identification details as may be derived from cookies (e.g. in web browsing) or account information (e.g. in apps).

In order to take advantage of ad services 1310 for targeted interaction with the customer 120, the system server comprises an ad services interface. The ad services interface is configured to interact with one or more ad service server according to its API and to provide the ad service 1310 with requests to present promotional offers to customers. In one embodiment, this request may include identification of the particular customer 120, e.g. trough an agreed-upon identifier such as a cookie-based identifier, account-based identifier or another identifier provided by or to the ad service server.

The customer interaction system 100 of this example also uses an e-mail service 1325 to communicate with the customers. To this end, an e-mail interface is provided. The reader will appreciate that there exists different way of coordinating e-mail communications with a customer base. In this particular example, an external service is used, which provides an API for transmitting e-mailing instructions which the external service receives and executes by generating and transmitting e-mails according to the instructions. The e-mail interface therefore receives from the selective contact algorithm instructions comprising one or more e-mail address and promotional data and communicates it to an e-mail service server according to the e-mail service's API.

The customer interaction system 100 of this example also uses a text message service, specifically here an SMS service 1315, to communicate with the customers. To this end, an SMS interface is provided. In this particular example, an external service is used, which provides an API for transmitting instructions which the external service receives and executes by generating and transmitting SMS's according to the instructions. The SMS interface therefore receives from the selective contact algorithm instructions comprising one or more phone number and promotional data and communicates it to an SMS service server according to the SMS service's API.

The customer interaction system 100 of this example also uses a phone service 1320 to communicate with the customers. The phone service may communicate with the customers by phone and provide the customers recorded messages (to which end the offer data 920 may include an audio track), or may offer call center services wherein call center attendants contact customers to convey offers (to which end the offer data 920 may include a script). To this end, a phone interface is provided. In this particular example, an external service is used, which provides an API for transmitting instructions which the external service receives and executes by causing phone communications to take place according to the instructions. The phone interface therefore receives from the selective contact algorithm instructions comprising one or more phone number and promotional data (e.g. in the form of an audio track or script) and communicates it to a phone service server according to the phone service's API.

In some embodiments, the customer interaction system 100 may also include billboard services 1330. The billboard service 1330 may be a service of electronic billboards similar to what is implemented with respect to the in-store displays 140 but being provided on external billboards, that is billboards not under the control of the customer interaction system 100. In one example, a billboard company has a plurality of billboards with known locations and provides an API interface to their servers whereby clients (such as the customer interaction system 100) may request something to be displayed on a particular billboard at a particular time. These billboards may be electronic displays like displays 140 mounted, for example, in public spaces. Besides visual displays these may also include sound outputs, i.e. speakers mounted in public places such as in trains. The billboard service API receives requests for advertising and processes them in real-time or near thereto. To use this service, a billboard interface is provided. The billboard interface receives from the selective contact algorithm instructions comprising one or more identifying information and promotional data and communicates it to the billboard service server according to the billboard service's API. In this particular case (and elsewhere, where appropriate), the identifying information may be related to the service, rather than the particular customer 120, identifying the service's service or equipment requested. In particular, the identifying information may identify a particular billboard on which to display the promotional data.

The customer interaction system 100 of this example also uses one or more social media services 1335, such as Facebook™ or Twitter™. Although ad services may include ads presented within social media, the customer interaction system 100 may also have an active presence on social media. For example, an external service may be used to manage social media presences for which social media interfaces may communicate requests through an API as is done, for example, for SMS messages (requests including a social media identifier, provided in the customer identification data 305, and promotional data to share, and optionally, the manner in which to share it such as wall posting or private message). To this end, the social media API(s) 550″ may be implement the social media interface. In another example, the social media presence is managed internally and the social media interface(s) receive from the receives from the selective contact algorithm instructions comprising one or more social media identifier(s) and promotional data (and optionally, the manner of communication, e.g. wall post or private message) and generates instructions to a social media coordinator to communicate the promotional data to the particular customer. This may be done, for example, by updating a spreadsheet, accessible to the social media coordinator, containing the list of interaction instructions. The social media coordinator has access to this spreadsheet and goes through it, removing entries as they are processed.

The upon receiving input indicating an particular customer and a particular promotional offer, the selective contact algorithm then determines which customer interaction service(s) to use to effect the communication. The selection may be made on the basis of several factors, an in this example it is a function of services subscription, services availability, and services preference/effectiveness. Upon receiving the input, the selective contact algorithm assesses these factors.

Services subscription describes which customer interaction services are available to communicate with the particular customer 120. The selective contact algorithm consults the customer profile dataset 300 to assess which services are available. In this particular example, each customer interaction service depends on the availability of respective data in the customer ID data 305. For example, SMS services 1315 and phone services 1320 require a valid phone number to be present. App 500, display 140 and web page 1305 services are always available in this example, but could be determined based on the presence of a system ID. Internet ad services 1310 are similarly always available in the present example, but could otherwise be determined based on the presence of a respective ID. And billboard services 1330 availability may be determined based on the presence of up-to-date location data, which in this example may be stored in the customer ID data 305. Optionally, opt-in variables, e.g. stored in customer ID data 305 may also indicate whether the customer has agreed to being contact using each service. The selective contact algorithm first identifies which of the customer interaction services are available (i.e. “subscribed-to”).

Services availability describes which services are currently available for communicating with the customer 120. Some services, such as e-mail may be considered constantly available, while others may not. The selection contact algorithm goes through the subscribed-to services and assesses which ones are currently available for contacting the customer. This may involve, for example, assessing whether the customer app 500 is currently running and/or responding to inquiries. Based on this, it may be determined whether an in-app communication is currently an available medium. This may also involve assessing the customer's location, e.g. as provided by the customer app 500 and stored in the customer identification data 305. Preferably, the customer identification data 305 stores the latest location and the time at which it was obtained. Based on the presence of location data within a threshold of time, it is determined whether location is available at all. If it is, the location may be used to determine whether certain services are available. For example, for the billboard service 1330, it is considered available if the customer location is within a certain threshold of an available billboard. Service availability may also be based on online presence, as described below.

In order to assess availability of certain services, the selective contact algorithm may also communicate with interfaces to obtain information on whether the service itself is available. For example, it may cause the interface to request whether a particular billboard is available from the billboard service 1330. It may also cause the social media interface to ascertain whether the customer 120 is online according to a social medium (e.g. Facebook Messenger™). It may similarly query the web interface and ad service interface to whether the customer 120 has been observed to be browsing the web page 1305 or web pages for which ad services are available.

Finally, availability of services may also be based on the available promotional data for the particular promotional offer. Specifically here the selective contact algorithm consults the promotional dataset for the particular promotional offer and identifies which customer interaction services may use the available offer data 920. To this end a set of selection rules may be applied. For example, if there is no text description, or no short text description, then SMS and e-mail might be considered unavailable. If there is no audio track or transcript then the phone interface may be considered unavailable. And if there is no image or video in a format suitable for any particular service then these too may be considered unavailable.

Having determined which services are generally available and furthermore which ones are currently available, the selective contact algorithm then makes a selection from the currently available services based on effectiveness or preference. For example, promotional data associated with a particular promotional offer may indicate a preferred service of distribution. In such a case, this service may be used. The selective contact algorithm may also consult the customer profile dataset and particularly the customer promotion data 390, to determine which service has been used in the past that was effectively redeemed by the customer 120 (presuming for this example that the service used to communicate the promotional offer is included in a field for each entry). The selective contact algorithm may then select a service based on the greatest past effectiveness. Finally, e.g. failing in both the above, the selective contact algorithm may select a service based on general rules of preference.

As such, the customer interaction system 100 may be used to selectively reach out to customers in a multi-channel manner choosing the most effective way to reach out to each customer on a personalized customer-by-customer basis. It should be noted that particular implementation was exemplary only. Indeed, there the customer interaction system 100 is unique as a multi-dimensional customer outreach tool and may be utilized in different ways.

Although the multi-dimensional outreach provided by the selective contact algorithm and interfaces were provided here by the system server 170, it will be appreciated that this functionality could be offloaded and provided on a separate server or servers which may in turn use the system server 170 or merely the server storage 175 to effect their services. In this manner, the tasks of profile building and multi-dimensional customer outreach may be split up.

Having provided such a system, it should be appreciated that the power of the customer interaction system 100 may be exploited in different manners. In one example, the powerful multi-dimensional customer interaction system 100 is used to provide other entities with the ability to contact their customers in a real-time medium-optimized manner as described above. To this end, the customer interaction system 100 may receive input for the selective contact algorithm from other sources such as a commercial establishment 1340, the particular store 105, or even an advertising agency 1345 or the like. Specifically, the system server 170 may implement a request API through which it may receive requests for real-time medium-optimized communication with customers. The API includes a protocol for receiving requests which includes a customer identification (preferably a customer ID which is comprised in the customer ID data 305, for which end the customer ID data 305 may include specific ID's for different possible requesting clients) and promotional offer (e.g. identifier of a promotional offer dataset corresponding to a promotional offer already stored in the promotional database, or new promotional offer data if the promotional offer is not in the promotional offer database —in which case the program core 505″ may optionally generate a new promotional offer dataset therefor). Other instructions may include constraints such as a particular preference of media (or order of preference) as well as a list of acceptable media, a number of different media to use, etc. . . . . This request API may be implemented as part of the employee API 545″ (which already defines many promotional data-related communications) or may be a standalone API. Optionally, a confirmation message may be defined by the request API by which the system server 170 returns confirmation that the customer has been contact and the details such as medium used and time of contact and, further optionally, responses received from the customer.

Customer relationship management (CRM) systems generally accumulate and classify customer-related data based on human operator input or customer interaction from the virtual world. To this end, the customer interaction system 100 may implement or serve as a customer monitoring system 2000, implemented by the server program 500″. In so doing, the customer interaction system 100 may augment the capabilities of existing customer relationship management systems by populating them with data derived from and representative of interactions with and behavior of customers in the real world. Using mobile devices, and network equipment such as WiFi infrastructure the position of customers may be tracked such as to not only have real time information about the presence and location of the customer 120, but also capability to infer information about the customer 1200's behavior before entering the store 105 and within the store 105.

The customer monitoring system 2000 detects patterns and uses triggers to populate the CRM system database, based on the relevant information obtained about the customer 120, including real world information including, e.g., user geolocation data. In order to avoid populating the database with useless information, the data collected may be processed and filtered to derive more specific information. To this end, patterns may be detected and converted into specific activity. In such a way, it is possible to provide the CRM with information about what the customer 120 did during his visit, without flooding the CRM with specific positional information about the user which, if unprocessed, does not necessarily provide relevant data to the CRM. For example, activities can be derived from patterns such as the customer 120 idling for 10 minutes in a food court, by deriving from the latter that the customer 120 is eating. Likewise by analyzing customer 120's location over time, it is possible to derive, for example, that the customer 120 is walking slowly inside a shopping center, from which the customer monitoring system 2000 may ascertain that the customer 120 is window shopping. Likewise, other patterns such can be detected, e.g. from a user entering through a door facing the bus terminal, from which the system may derive other activities such as arriving via public transit.

For the most part, commercial enterprises desiring a measure of customer tracking and relationship management already use their own customer relationship management systems. These systems are limited to virtual interactions with customers and cannot easily be modified to break out of the virtual world. The present technology allows commercial enterprises to augment their CRMs to comprise real-world information obtained from customer monitoring systems, and moreover to derive from such information relevant data with which to populate their CRM systems without requiring either a change of CRM system or an expensive and heretofore unaccomplished redesign of the CRM system paradigm. This may be accomplished by using data already derived by the customer interaction system and by processing data from network tracking systems and exploiting customer relationship management system APIs.

By their nature, geolocation data are bloatful and expensive to store. Given the nature of human movement, geolocation changes frequently and consequently high-resolution systems generate large amounts geolocation data often with multiple entries per device/user in order to have enough precision to have sufficient and meaningful information. To this end, network tracking systems may provide large amounts of data, in frequent dispatches (e.g. every minute maximum) for, e.g., each access point. Even if such data could be interpreted by the CRM or its users, maintaining and storing such data would be wasteful and cumbersome and would bloat the system possibly to the point of overshadowing more relevant information. Advantageously the customer monitoring system 2000 intelligently derives useful information in the form of patterns, from which moreover activities may be deduced, and populates the CRM only with relevant information.

It should be noted that raw data from network tracking systems generally does not provide relevant information on specific users. For the most part, this data is used to generate heat maps of the most frequented geographic areas in a shopping center or the like. However, by deducing patterns for specific individual or devices, more relevant information can be obtained. Moreover, the geolocation data from the network tracking systems may be combined with customer profile data or with geographical information by the customer monitoring system 2000 to derive relevant information. The present technology replicates human intelligence to derive meaningful information for the CRM. For example, if a human views a map, they may recognize is an entrance, what is a store, what is a food court and what is a crosshair showing a user position because those symbols are understood by the human. Likewise, a human viewing a path of this user drawn on the map will easily recognize patterns such as that user came from entrance 1, went to store 13, went to the bathroom, left using the exit 2. From a computing perspective, the information provided by a network tracking system may be discrete geolocations representing a circle of the area in which a user probably was at, e.g., every minute. In order to derive meaningful information from such data a technological solutions is proposed.

To begin with, the uncertainty of the geolocation technology is compensated by a strong pattern recognition/detection algorithm. To this end, the system may be used to detect simple situations which have a strong business meaningfulness, however more complex situations may in time be built into the pattern recognition algorithm. For example, one meaningful pattern may be to detect whether a customer goes to a competing store after leaving the store 105 without buying anything, and which one. To this end, pattern detection may be implemented by defining an area representing a competing store and by monitoring geolocation therein to detect a customer staying more than 5 minutes. Such a pattern can be detected using only 2-dimensional data and with time.

As mentioned, Wi-Fi providers often offers visibility about proximity marketing through a heatmap showing the density of people by area. Such data may be useful, but it would be even more helpful to have visibility over what users are doing in those areas, such as whether they are moving or whether they are lingering and for how long. To this end, the customer monitoring system 2000 allows visibility not just to see “clients” across the entire shopping center, but also on whether these clients are actually shopping, are eating, waiting for the bus, or resting in the common areas. With the present technology, such relevant information may be stored in a customer relationship management system as activities. For example, for each of a customer, the CRM may store several activities such as that the user came by bus, shopped for 1 hour, stayed to eat and then went to the cinema. This type of interaction may be derived on location and time spent within areas.

Using points of interests (POIs), patterns and activities, it is possible to derive relevant data based on the user geolocation data. Time information may be usefully used by the pattern recognition algorithm to define which pattern is determined, which activity is deduced, which data to use for pattern recognition and, which data to send to the CRM. To this end, the customer monitoring system 2000 implements triggers which are used to initiate a sequence based on a specific event defined by certain criteria. Triggers may be used to complete a user profile, or to communicate to a CRM that it should communicate with the customer (send some promotional content) or with a third party (e.g. a store employee, e.g. using the in-store computing device 115), or to indicate to the CRM the information to communicate with the customer/third party.

It will be appreciated that the schematically illustrated components of FIG. 14 can provide an interface system (including the customer monitoring system 2000) that interconnects the data management system associated with a network of access points, for example a server running the above mentioned CMX software from Cisco, with a CRM system. The interface system reads data about mobile device movement from the data management system associated with the access points as well as data about customers from the CRM system using the pull API module. The interface system filters and/or analyzes the movement data about customers and reports on predetermined customer movement events to the CRM system using the push API module.

One simplified example can be given in the context of a hardware store having a plurality of departments. The interface system can determine whether a customer's location dwell time corresponds to looking for an item in a department. Real time location data is not streamed to the CRM system. Instead, the real time location data over time is monitored to determine store department or section interest. Department interest can be reported as an event to the CRM that can in turn decide on how to act now or at a later time in response to the department interest. The interface system can also combine department interest events and/or customer movements into a more complex event determination. For example, department interest shown in multiple departments can indicate an interest in a type of home renovation, namely dwell time in the plumbing pipes and materials section, electrical wiring section and building materials section can be used to determine as an event an interest in a house extension, whereas dwell time in the plumbing hardware and tile/flooring sections can be used to determine as an event an interest in a bathroom makeover.

In one particular embodiment, two types of triggers are defined.

A first type of trigger are real time triggers. Many combinations are possible. These are based on device position and time through pattern detection. Triggers may be based, on entering a specific zone, or staying more than a specific duration within a specific area, for example. Triggers may also be based on a combination of different parameters such as leaving the store 105 within 2 minutes of entering the store 105. Real time triggers are useful in situations with large numbers of visitors/users, to derive data which is time sensitive and has an immediate business value. In other instances, it may be more useful to use scheduled triggers to send data to avoid overloading the server and database.

A second type of trigger are global triggers (or scheduled triggers). Such triggers may be run regularly or at a specific frequency, for example every day at 8 pm. Such triggers may be used to analyze additional patterns, and send heavy information if required to build a global view of what a user did during the day. These triggers can be applied to past data as well, to find for example if a customer has been visiting the store 105 repetitively, or when they last did.

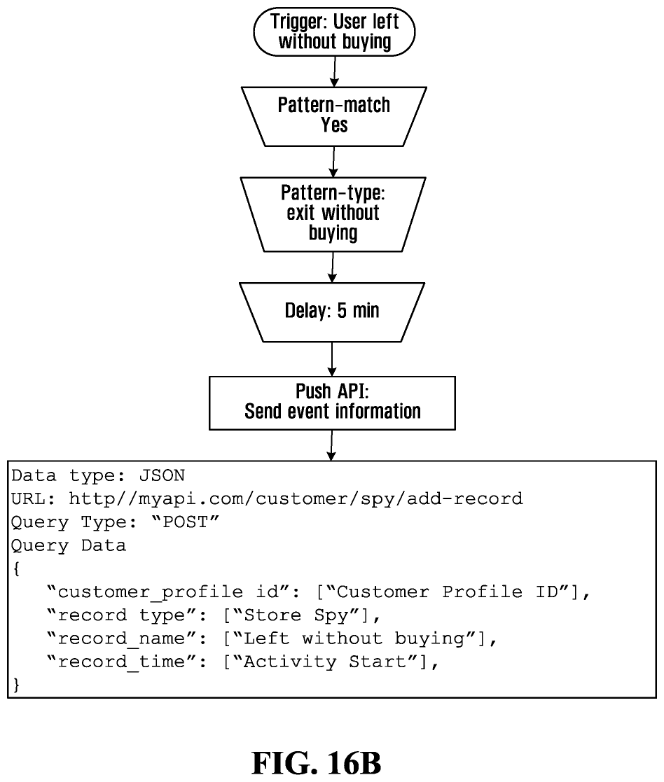

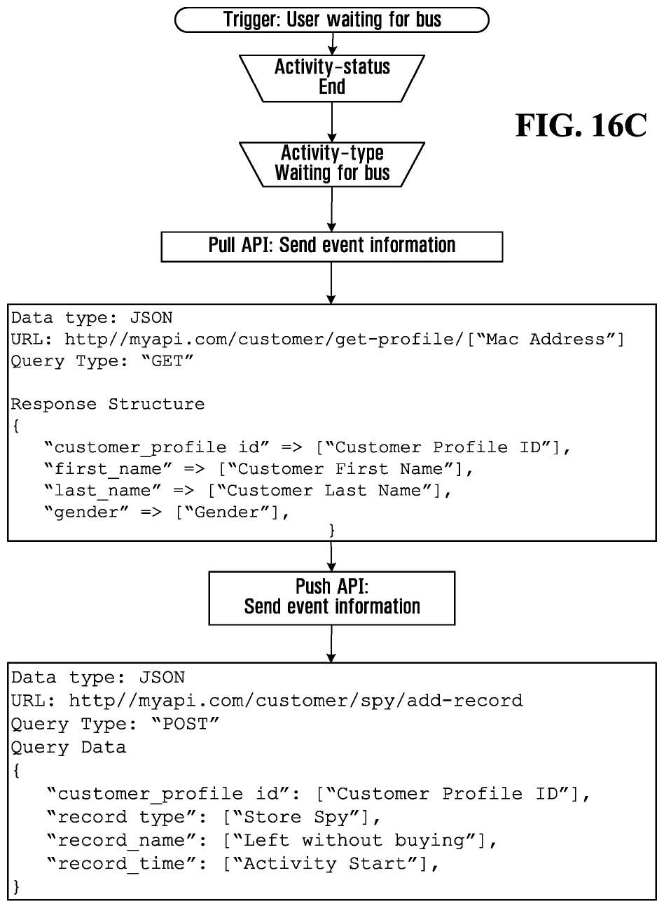

Real time triggers may be associated to patterns and/or activities with additional parameters such as when we want to trigger the event with respect to the activity start and/or end. Triggers can be used even more powerfully by adding additional delays or advanced condition modifying when to trigger an event. Since triggers may be used to send information to the CRM system, timing may be an important consideration important to avoid flooding the CRM. For example, the system may define that it should send data to the CRM as soon as an “eating” activity is detected. Since the relevant information is that the user is eating, this may be provided as real time information and therefore it may not be required to include the time of this activity (the server may use its own current time when it receives the API call). However, if a relevant information is to know how long someone has been waiting for the bus, it is better for the system to wait until the end of the activity to trigger an event which may include the duration of the activity as a parameter. Many other kinds of triggers may be defined, and in one embodiment, a graphical user interface allowing a system operator to build trigger configurations is provided. This graphical user interface may allow an operator to enter trigger configurations by inputting trigger parameters such as duration, location, repetition of particular parameters (e.g. a location visited 2 times), etc. . . . . Examples of triggers and related flows are illustrated in FIG. 16.

Although the customer interaction system 100 may derive customer geolocation, in the present example, geolocation data is provided by the network tracking system 1405, which may be provided by the network equipment maker through both software and/or hardware technologies. Multiple exemplary implementations are possible, e.g. using a controller using one or more APIs.

In one example, a server is used as the controller (physical or virtual). Basically, the server asks regularly (let's say every minutes) information about the devices connected and near every AP. Data is stored on the server and accessible through API on demand. For such controller, the network tracking system API module 565″ uses calls to the API to receive the data.

In another example, which will be used for illustration herein, the logic is inverted. There is a server gathering data from the AP which may be a cloud solution and will be called the cloud herein. In such an example, the cloud may call an external API, such as an API of the customer interaction system 100 implementing the customer monitoring system 2000, to supply network tracking data such as access point data. This data is stored by the customer monitoring system 2000 in order to have continued access to it. With such controllers, it may not be possible to request previous data even if it's stored somewhere else.

To this end, the server storage 175 may include an architecture where the data is split with a multi-layer table structure. From the raw data (e.g. MAC addresses, coordinates, and time) the data is aggregate by the customer monitoring system 2000 to create information compatible with a visitor profile. For this reason, layers are built on top of it.

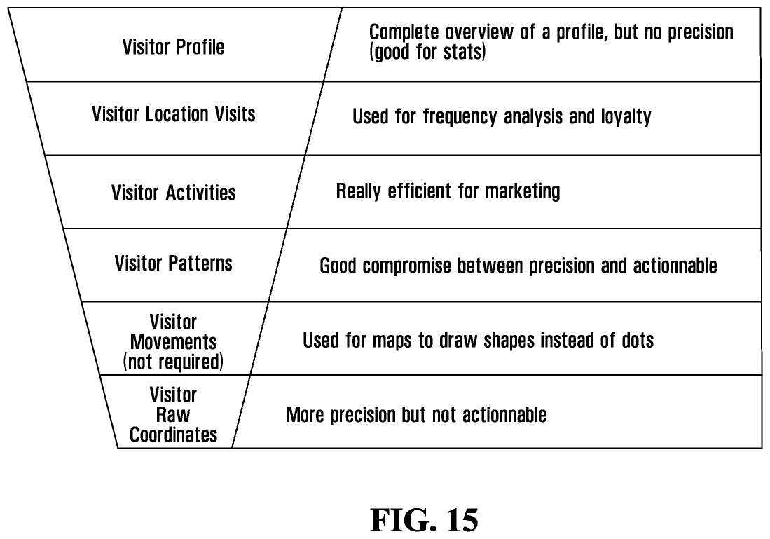

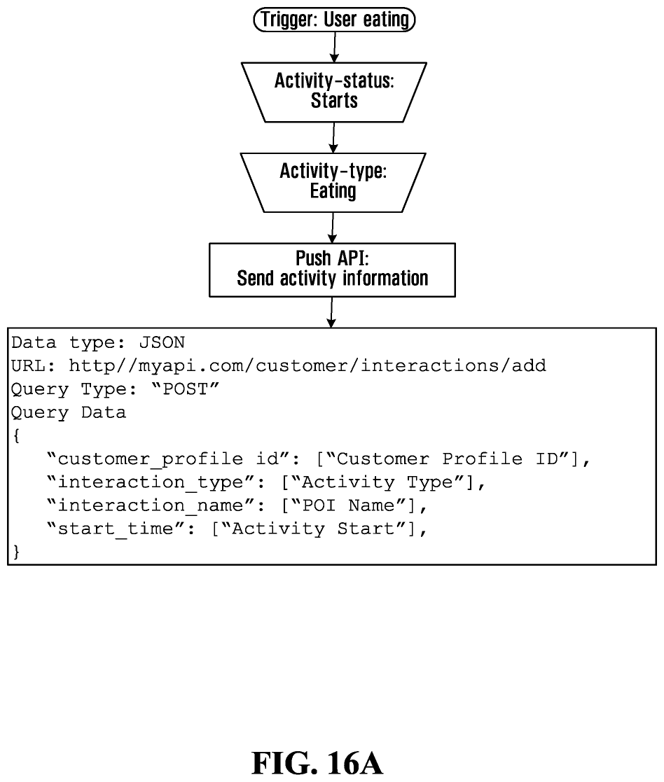

Depending of the complexity and type of information desired, a different table may be provided to collect that information. FIG. 15 illustrates the different layers of data that may be provided by the system. Advantageously, the system may have access a lot of data of the sort, however building data over data can be expensive. For this reason, although the customer monitoring system 2000 is illustrated as being implemented within the customer interaction system within a single server unit, this functionality may be distributed over to a dedicated server unit. Moreover in order to ensure that the system may grow other time, it may be implemented using a cluster approach, so as to build-in cluster support. The customer monitoring aspect may therefore be autonomous, with an architecture similar to that of the server program 500″, but implemented on separate equipment, and may, optionally in order to facilitate integration with the customer interaction system, access the same server storage as and/or communicate with the server program 500″.

In order to derive more intelligence from customer tracking data provided by the network tracking system 1405, the customer monitoring system 2000 may be provided with contextual information such as geographic data (e.g. map data) and economic data. In one particular example, the system is provided with electronic map data corresponding to the areas monitored by the network tracking system 1405 which associates geographic locations therein with particular geographic features (e.g. stores, hallways, advertisement points, food courts, doorways, other points of interests, zones, etc. . . . ) which may include a decomposition of the map with zones. This contextual (e.g. geographic) data may be stored on the server storage 175 in any suitable format.

Data may be received by the customer monitoring system 2000 are regular frequency (e.g. every minute) from the cloud. This data may comprise a list of information for every device located near an access point (AP). The main identifier may be the MAC address, and coordinates which may be global (latitude and longitude) or local (x, y; with a space reference used to treat those information, which could be a map or just scale information with a global reference point). In order to provide useable value to map data, we may implement a system of points of interest (POIs), which associates data to coordinates/locations. Basic points of interests may be defined with x and y coordinates plus an optional radius, and may include a type, name and description. In certain cases, zones may be defined as an extension of the POI system using, e.g., SVG type shaping: which links together list of coordinates to form a specific shape that can be drawn. To make this step faster and easier, advanced per pixel reading algorithm may be used on the map to decompose the map into zones.

As described, the MAC address may be used to attempt to link the device to an existing customer profile in the customer profile database. If a matching customer profile is not found, a new one may be created for the MAC address, or the data with respect to the MAC address may be ignored.

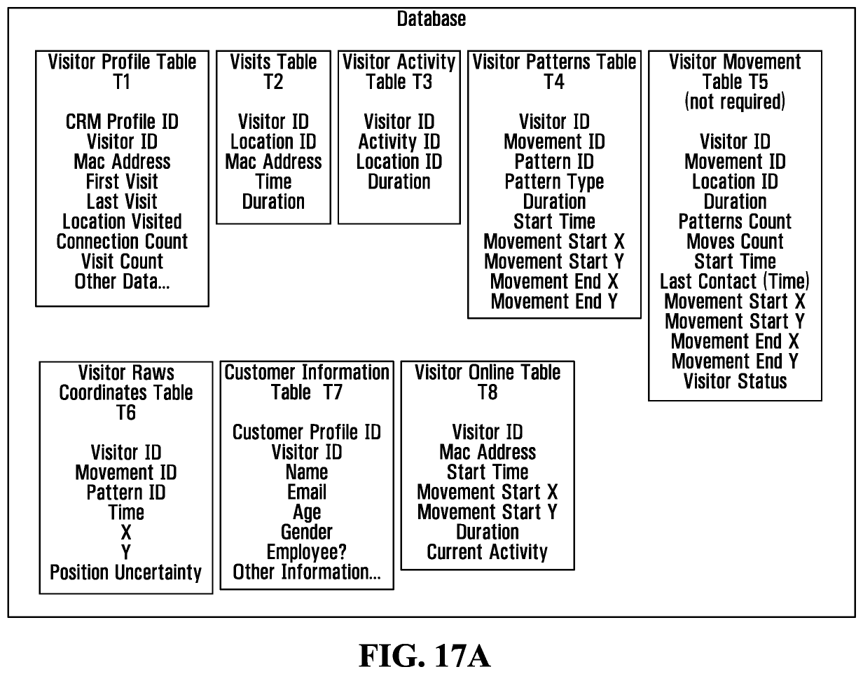

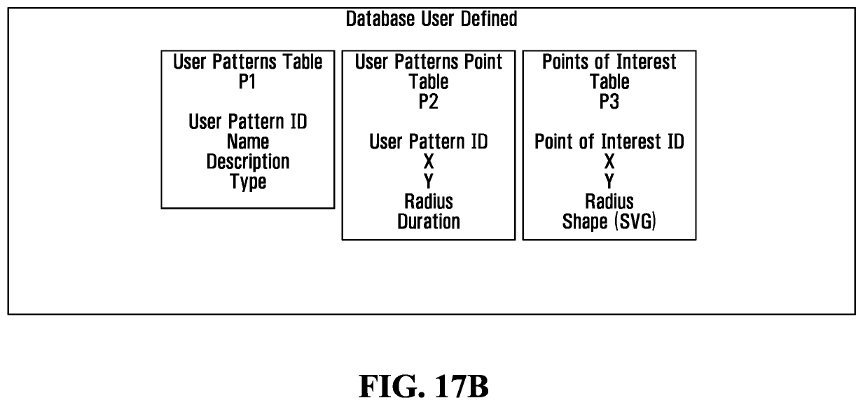

FIG. 17 illustrates database data created and used by the customer monitoring system 2000. In one example, this data is created by the customer monitoring system 2000 in a separate customer monitoring database implemented, e.g., on the server storage 175, and is linked by reference to the customer profile database, however in alternate embodiments this information may be nested within the customer profile database. The Visitor Profile allows to have statistics and a global view on who is the user, such as whether it is a new or returning customer, and in the latter case, how many times have they come.

In this example, the visits are decomposed into different steps, the main container being the visit itself which includes the current location the start and end time and may also include a geolocation for the beginning and end of the visit. In order to able to understand what the user did, we may decompose further the visit using patterns and activities.

A pattern may provide a layer that is machine readable, while activities may be comprise descriptions that can provided to and/or read by a human or a customer relationship management system. The present technology thus may be used to convert device movement into activities and then provide these to a CRM.

Patterns may be defined as mathematical and geometrical rules converting user data, such as geolocation and time data to machine defined statements about what the user is doing. Through the use of patterns, the system enables the analysis of movement and activity rather than mere positions.

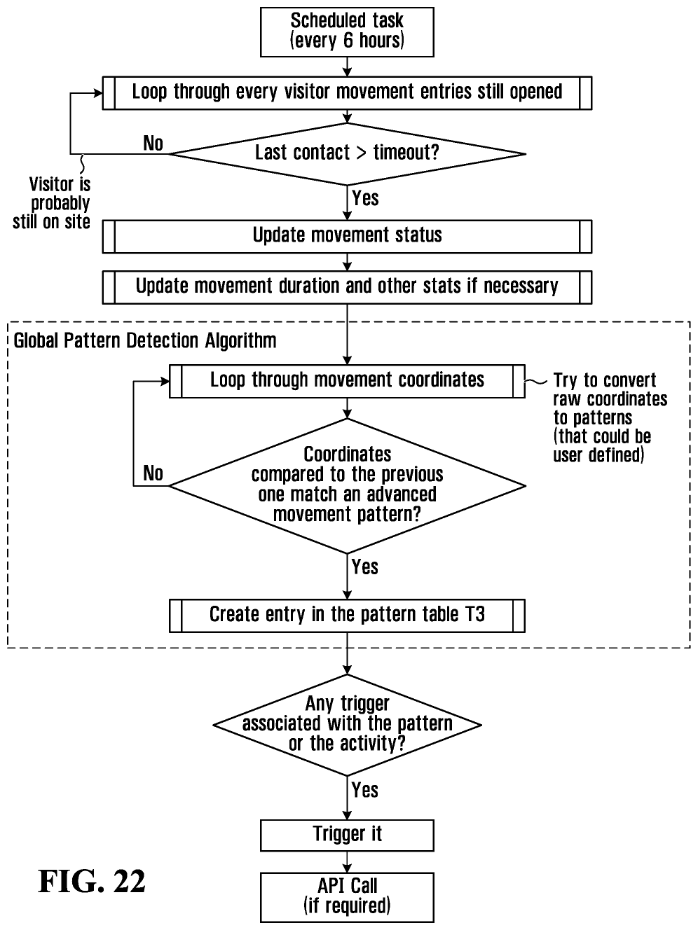

When performing pattern recognition, one situation that may be handled is when customer appears to leave the map (e.g. region of tracking) and then reappears. In this example, we implement a timeout mechanism for which we configure a timeout value to be counted to upon “disappearance” of a customer after which the customer is considered to have left the location. If a customer disappears for the duration of the timeout value and later reappears again after a delay that is higher than the timeout, then the system creates a new visit in the database. FIG. 22 shows a flow chart illustrating the event chain implementing a trigger mechanism and a timeout loop, according to one particular example. References to tables (e.g. T3) in this example refer to the tables defined earlier e.g. in FIG. 17A.

Patterns may be defined by a period of time during which a customer is moving based on a distance or POI proximity. More particularly, patterns may be built by comparing the current position with previous one, to identify whether the movement matches a particular pattern of movement. POI can provide additional color to patterns by providing something against which to measure customer position or movement, to allow further patterns recognition like entering or leaving a zone. Following the same logic, a pattern may be an ongoing movement (user walking), or a new one (user leaving area). In the present example, when customer data does not match a particular pattern, the customer monitoring system 2000 simply does not recognize a pattern and no particular action is taken.

Some exemplary patterns will now be described using the example of a shopping mall. In one example, a customer may enter a store area (defined as a POI zone). This may be a pattern. In another example, a customer may be immobile, which may correspond to another pattern. A customer may also be moving slowly, or be moving fast, even exit a store area, all of which may be defined patterns. Some patterns may be prebuilt but in one example, an operator may define pattern based movements, POI and/or time, etc. . . . . To this end, in one embodiment, a graphical user interface allowing a system operator to build pattern configurations is provided. This graphical user interface may allow an operator to enter pattern configurations by inputting pattern parameters.

Customer movement may be determined by comparing geolocation and time data obtained in this example from the network tracking system 1405. The network tracking system may provide such data as described herein in data packages which in this example are packages of information sent at a regular frequency (e.g. once a minute) which contain geolocation data for all devices tracked by the network tracking system. Therefore, pattern detection may begin by first receiving such data packages and parsing them for geolocation data for individual devices and further parsing these to find a tracking ID and to identify a related customer based thereon. In alternate embodiment, particularly where the customer interaction system 100 derives its own geolocation data and where it implements the customer monitoring system 2000, the data packages comprising information about a customer may be derived by the system itself.

As described, the system also provides activities matching certain patterns. In certain cases, an activity may be also called an interaction because it may describe what the user is currently doing based on its current and recent position. To this end, the customer monitoring system 2000 combines POI information and customer movement patterns to derive therefrom a guess as to what the customer could be doing right now. The system may provide a statistic behavioral idea about what the customer is doing, although given the estimative nature of the technology, there is a risk that such information might occasionally be inaccurate. For this reason, a certainty estimation may be incorporated within the algorithm, which may thus provide a certainty estimate or trust percentage.

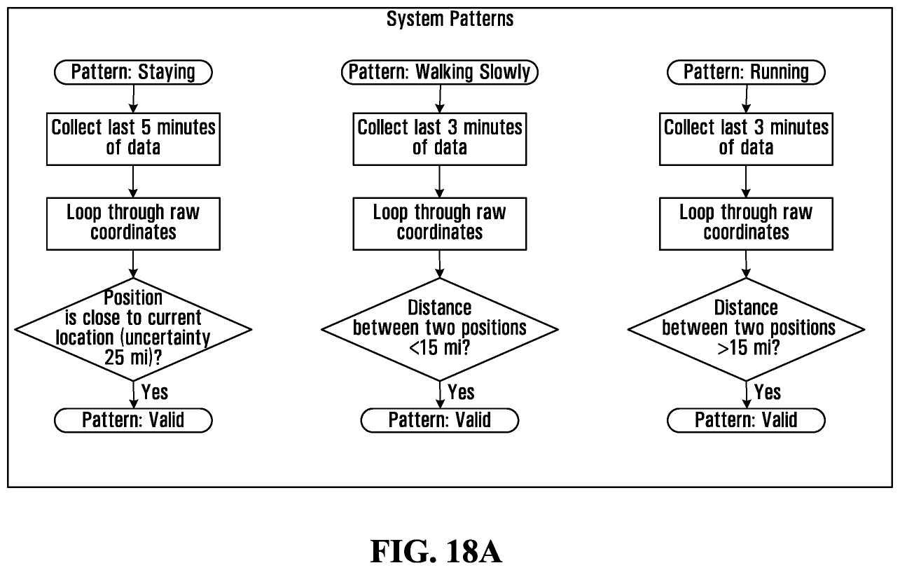

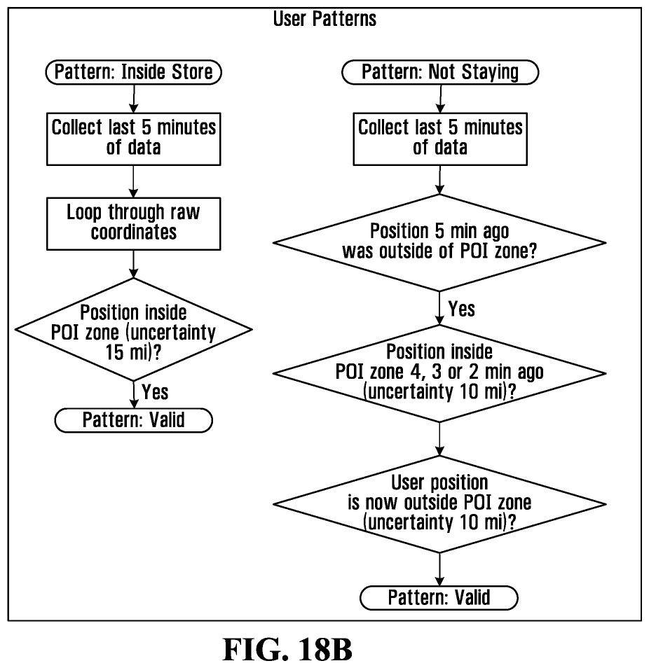

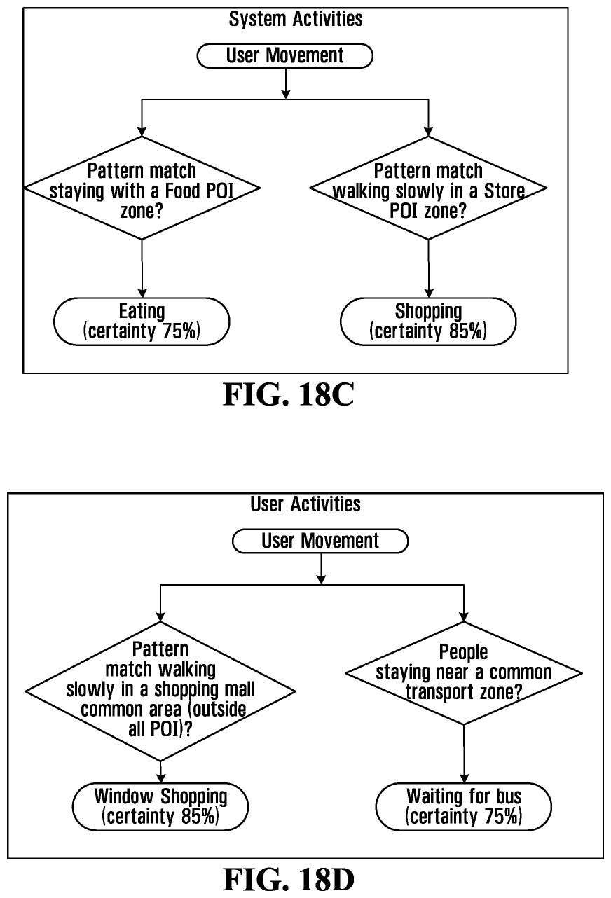

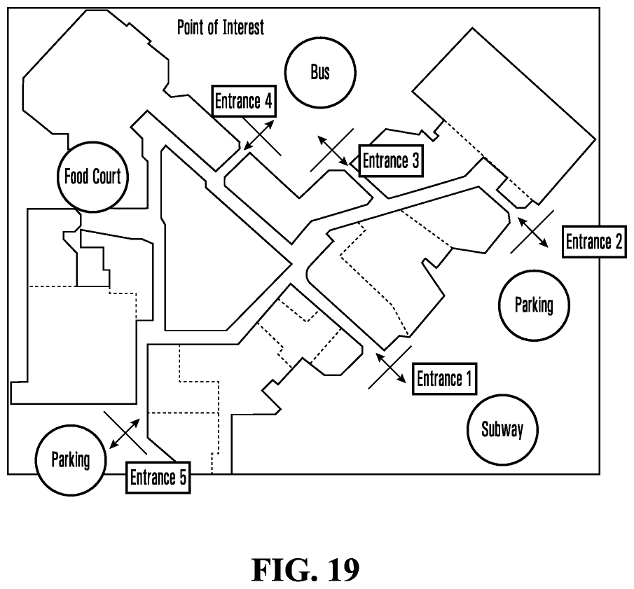

In the present example, an activity may be derived from one or more pattern, and optionally other customer-related data (e.g. profile data) on the basis of certain activity characteristics which define the activity. On obtaining new data about a customer (in this example, when a new pattern is derived), the customer monitoring system 2000 compares the data obtained (in this example, at least the new pattern and typically also at least one earlier pattern, activity and/or other data), to an activity definition and where there is concordance with the activity definition it derives an instance of this activity. Examples of flow charts of patterns and activities are illustrated in FIG. 18.

Now given the foregoing, it should be clear that using patterns the system is capable of ascertaining when a customer is not moving. If this pattern is combined with the context data to identify the closest POI to the customer when not moving, then it may be possible to ascertain therefrom what the customer is doing in the shopping mall. For example, if a customer is immobile in a food court area: it may be derived that the customer is eating. If the customer is immobile in a particular store, it may be derived that the customer is buying something. If the customer is immobile in a megastore near a cash register, it may be derived that the customer is in line to buy something. Thus, patterns may be layered such that sub patterns may combine with additional data (customer, context or other) or patterns to derive supra-patterns to build activities.

The system of pattern may include special cases. Returning to the food court example, if a customer is immobile in a food court, they may indeed be eating. However, it is also possible that the customer is merely there to rest or maybe chat with a friend. Thus, additional information may be used to build the activity. For example, if a customer stayed there less than 30 min, it may be derived that they were eating, whereas if they were there longer, they may have been resting. Alternatively, past data and past patterns may be used to inform future ones. For example, if the geolocation data of a customer indicates that they entered the food court without nearing a restaurant prior to being immobile in a table area, then it may be derived that the customer was resting, whereas an earlier pattern indicating immobility by a restaurant outlet may be used to derive that the customer is eating.

Time data management may further be helpful. In addition to using time data to ascertain a quantity of time spent doing something or a speed of travel, the actual time value itself (e.g. time of day) may be used in pattern recognition. For example, time of day may be used to ascertain adherence to a particular pattern. For example, a stroll through a shopping mall after 10 pm when stores are closed may be used to derive that the perceived customer is in fact not a customer (but maybe a security guard). Likewise, time data (and any other data used by the system) may be used by the certainty estimation to add certainty value to pattern. Using the food court example, although time of day (within opening hours) cannot alone guaranty that a customer is eating when idling in the food court, it is much more likely to be the case around meal times. Therefore, a certainty for a conclusion that the customer is eating might be increased by the fact that the customer is there during mealtime while the certainty of a conclusion that the customer is resting may be decreased at meal time.

Using past data, including patterns, in activity/pattern recognition may also provide great benefit and result in more actionable information. In such a way the system implements artificial intelligence in its pattern recognition. Such techniques may make the difference, e.g., between detecting a customer as or an employee as a client. Both may stay more than 5 min at the store 105 (a pattern, in one example) and occasionally, a customer may stay for an hour or even longer, while someone spending less time at the store 105 may be an employee working a short shift or coming in and out of the store 105, e.g. to run deliveries. Yet distinguishing employees from customers has a significant business value. In one example, the customer monitoring system 2000 does so by combining some or all of the frequency of visit (and, optionally the time and day of the week), the time of the arrival or exit, the time spent on site in order to detect patterns of patterns characteristic of an employee. For example, a “customer” that visits with a precise regularity (e.g. comes a certain number of times a week, or arrives at a regular scheduled day/time) may be flagged as an employee. For example, if a customer stayed almost 9 hours in a store, it may be derived to be an employee by virtue of the mere duration of the visit. In another example if a customer is perceived arriving at the store 105 before opening time, this too may be a pattern that indicates an employee of the store (perhaps with the exception of special events, such as Boxing Day or Black Friday sales). In another example if a customer is perceived staying for two hours at the store 105 every Monday and Tuesday, here the repetition of the pattern may be used to derive that the individual is in fact an employee. The customer profile may be flagged accordingly by providing it with a data indicator that the customer is in fact an employee.

Moreover, other data from the customer interaction system 100 may be used to ascertain that a customer is in fact an employee, such as if identifying data (e.g. the MAC address) of the customer is registered in the employee profile database (which may be done in a manner similar to the way customer identifying data may be stored).

Although activity definitions may be operator-defined in certain examples (e.g. an operator may add additional activity definition or modify existing ones using an interface as with the triggers), in the present example, the activities are predefined. These may be predefined in a manner tailored for a particular application. Areas where the customer monitoring system 2000 may be implemented may often be designed for specific activities and activity definition may take the form of reverse engineering what the physical infrastructure architects did when they thought about where users would do what.

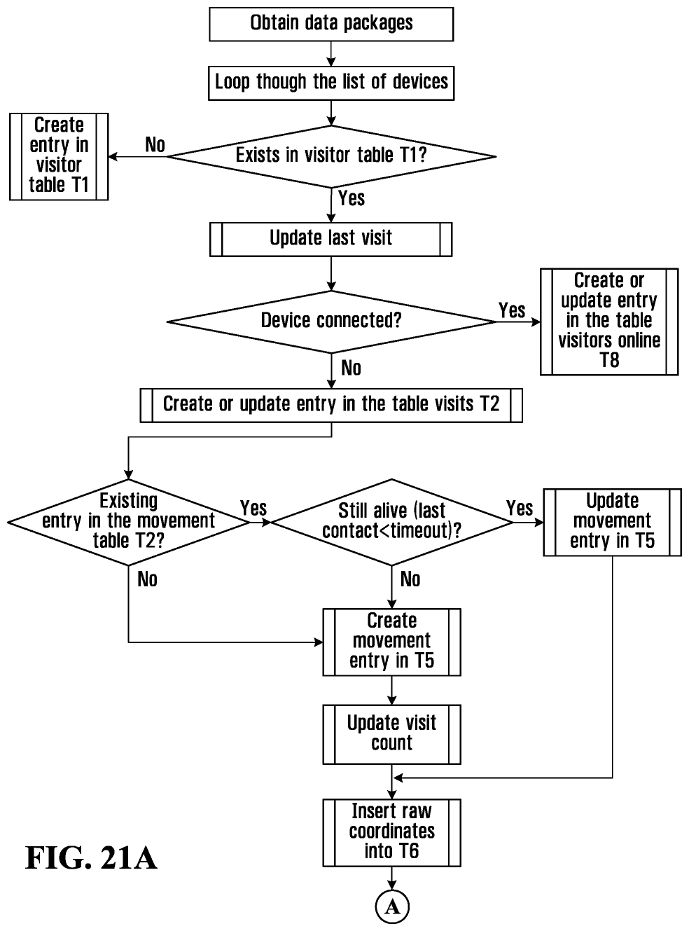

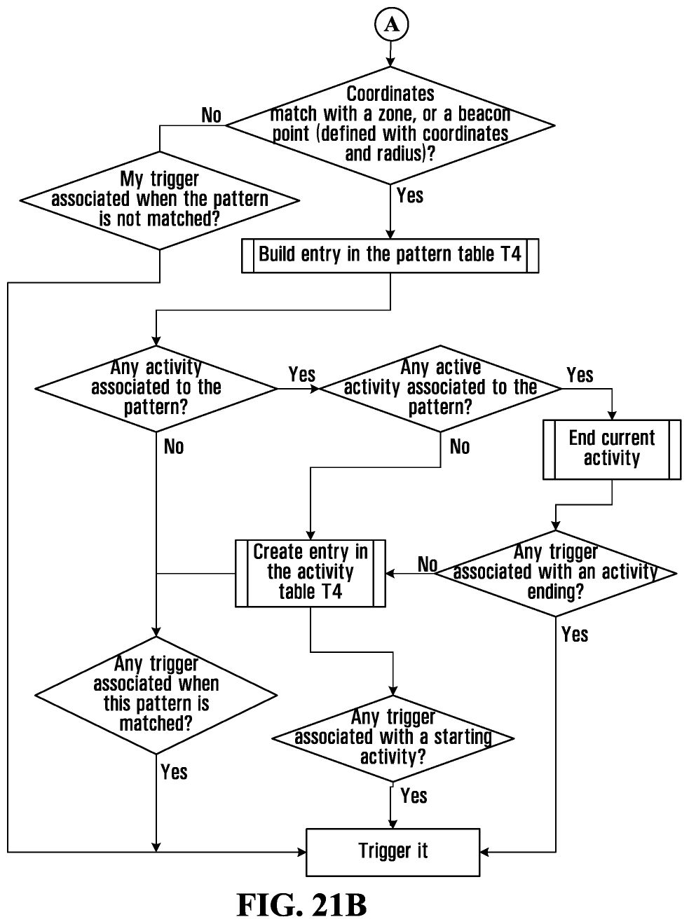

FIGS. 21A and 21B together show a flow chart illustrating the event chain from obtaining data packages with information about a customer (in this case received from the network tracking system 1405) to triggering an API call to push data to a customer relationship management system 1410, including pattern detection and activity determination, according to one particular example. References to tables (e.g. T1) in this example refer to the tables defined earlier, e.g. in FIG. 17A.

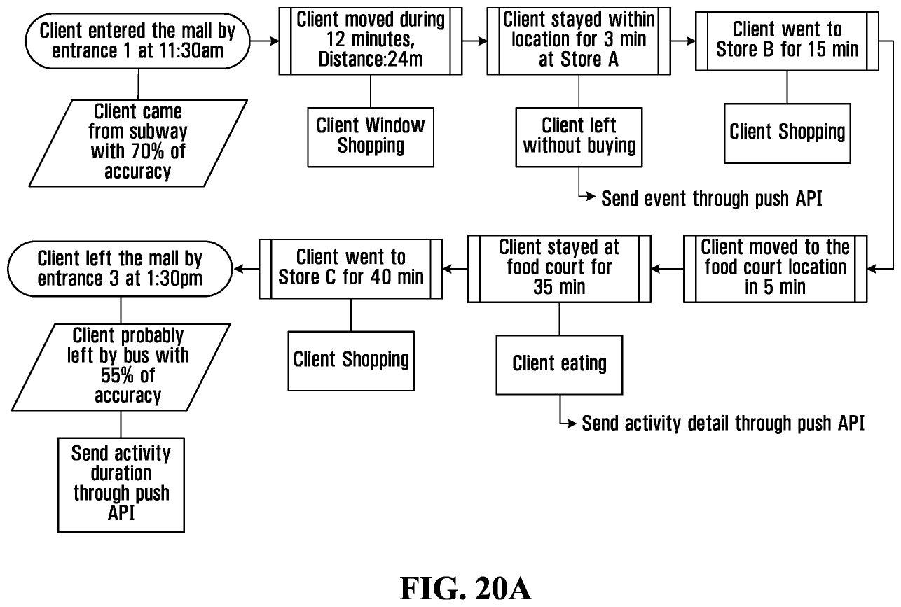

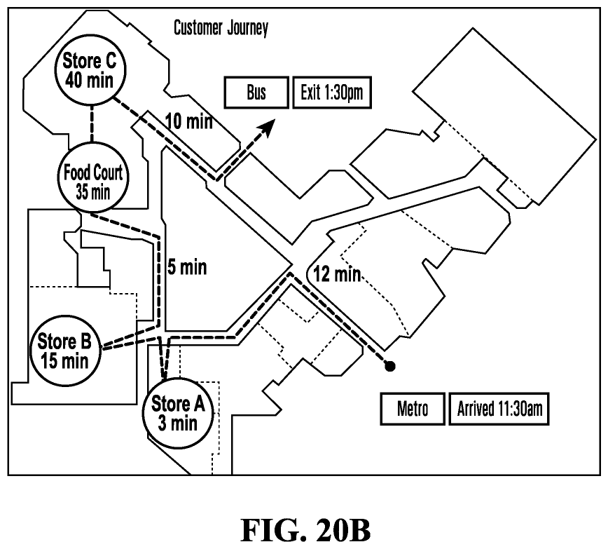

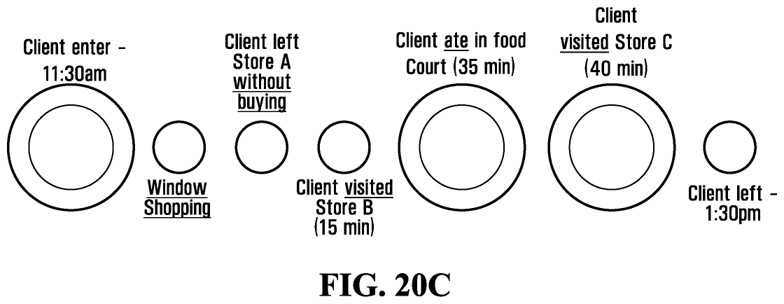

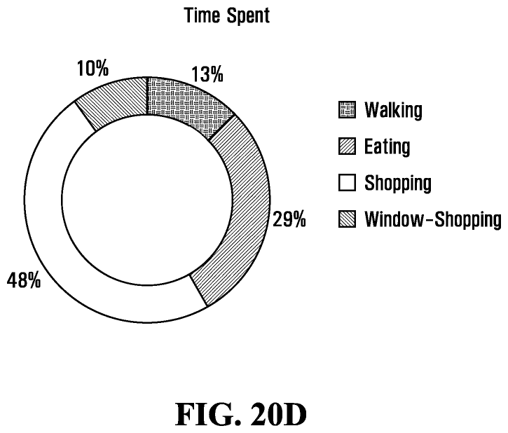

Patterns and activities can be combined into a customer journey, which can provide a useful notion which can be presented visually, either on a map or schematically, upon which statistical data can be derived. FIG. 20A illustrates an event flow comprising multiple activities which together make up a customer journey. As illustrated, the customer journey can be illustrated visually on a map (FIG. 20B) or schematically (FIG. 20C). In certain embodiments, the customer monitoring system 2000 may automatically generate a map visualization by superimposing customer geolocation data and pattern/activity data on a stored map, and/or may automatically generate schematic visualization. Moreover, statistical data about the customer may be automatically generated based on time (or other) information by the customer monitoring system 2000 (FIG. 20D).

In certain embodiments, pattern recognition may use other information about the customer 120, such as information derived by the customer interaction system 100. For example, data which has been described as informing an update to the customer profile, such as purchase data, customer inquiry data, and the like, may further be fit into pattern or activity parameters such that patterns or activities may be derived from such data. For example, if a customer is detected on the basis of a data package from the network tracking system 1405 as being geolocated within a store, and is moreover detected by the customer interaction system 100 as having purchased an item, this may fit an activity defined as a customer making a purchase in a store.

Thus, the customer monitoring system 2000 derives relevant information about customers on the basis of rawer data, such as geolocation data provided by a network tracking system 1405. Advantageously, this relevant information may be communicated to a customer relationship management system to improve the customer data contained therein and provide more complete knowledge about customers to the system's users.

Communication with the customer relationship management system 1410 may take place in two parts. In a first instance the customer monitoring system 2000 may collect pull API data from the customer relationship management system 1410. In a second part, the customer monitoring system 2000 may provide push API data to the customer relationship management system 1410. The configuration of the CRM integration may be implemented through an interface in the same dashboard than the configuration of maps, patterns, activities and triggers. The CRM integration may be a two-way data collection system. Pulled data may include account information or customer ID information, which may be used by the customer monitoring system to populate the customer profile database with relevant data linking customer profiles to respective identifiers used by the customer relationship management system 1410. This may be done similarly to the way customer profiles are linked to customer tracking IDs.

Optionally, API calls may be chained to collect missing data before trying to push data. For example, if the customer monitoring system 2000 only has a mac address to identify a customer and requires a customer monitoring ID to push the number of times the customer has registered, it would typically require two calls. Moreover, with both the customer tracking ID and the customer monitoring ID, new customer profile datasets may be created when these IDs do not correspond to existing customer profiles, such that if a customer is detected/known to the network tracking system 1405 and is known to the customer relationship management system 1410, relevant customer data may be derived and provided to the customer relationship management system 1410 even if the customer interaction system 100 did not previously have knowledge of or a profile for the customer.

For both the pull API and/or the push API interactions with the customer relationship management system 1410, predefined templates may be use to save significant time to integrate common templates. Thus, existing customer relationship management systems may have their own data exchange module already integrated within the application, which may make it possible to simply select the relevant modules in a list of data to be obtained and/or to send. By supporting multiple APIs for multiple customer relationship management systems, the customer monitoring system 2000 may be versatile and work in many commercial contexts and may simultaneously serve as a tool to integrate divergent systems together. Although the RESTFul architecture is generally favored, other models of architecture or protocol may be supported (e.g. SOAP) for compatibility with different/more customer relationship management system.

The pull API may be used to retrieve pertinent data from the customer relationship management system 1410, based on a unique key, e.g. the customer monitoring ID, which may take the form of a MAC Address. Each time a MAC Address matches with one of the device registered in the customer relationship management system 1410, the customer monitoring ID for this Mac Address may be added to the customer monitoring database Visitor profile table. Where the customer monitoring system 2000 is implemented by the customer interaction system 100 and the customer monitoring database is the customer profile database, this data may be added to the related customer's customer profile dataset as described herein. A summary of the customer profile may also be stored locally to provide an instant access to basic knowledge about the user like the age, gender, email, name, whether they are an employee, etc. This is particularly useful where the customer monitoring database is separate from the customer profile database. In certain cases, this step may be mandatory sometimes in order to push data later.

As requesting data typically requires initial data (to retrieve the data matching with the customer monitoring ID), each time a real-time event trigger is triggered, it may be linked to information about the current device. Advantageously by having access to the customer monitoring database this data may be stored and provided with the contribution message. Typically, real-time push API only require access to the primary key of the device, like the mac address or the customer monitoring ID.

In certain cases, there may be a global event trigger not linked to one specific device. In such cases determining which information to send and receive would typically imply loops, typically with a few conditions. In one example global events are be used to push data and not to collect data. To that end, a binding system may be offered in the interface to select which field should be sent with which form and syntax. Another may be used to process the retrieved data.

Many paradigms exist for data collection and are commonly used, any suitable one of which may be used or adapted to be used herein. In the present example, for a RESTFul-type API, the definition of the information collection may be performed by combining the API's url, and the parameters necessary for the collection of information. To simplify the management of these definitions, access to one API may be defined and reused for all calls to be made via the API. Access to an API typically requires the API root URL and dual authentication of key combination type with access token. Each call to this API may be defined by completing the root url (e.g., / users/1234), as well as the type of request to be performed (e.g., GET, POST . . . ) and any necessary parameters (e.g. if there is one POST type request).

As described herein, the customer monitoring system generates contribution message sent to the customer relationship management system 1410 in a customer relationship management format, that is to say formatted to be useable by the customer relationship management system 1410, e.g. by using customer relationship management system 1410 API/protocols. To that end, patterns as detected by the customer monitoring system and other data may be processed to derive activities such as are understood by the customer relationship management system 1410. In order to be compatible with the customer relationship management system 1410, the activity definitions may be defined so as to match data fields and parameters used by the customer relationship management system 1410. To that end, certain activities that may be detected by the customer monitoring system 2000 may be translated to corresponding activities (which may be defined as data fields, parameters, etc. . . . in the customer relationship management system 1410) that are understood by and/or present in the customer relationship management system 1410. In certain cases, perfect compatibility with the customer relationship management system 1410 may not be possible, particularly where certain customer relationship management systems do not have the ability/support to treat certain activity types. In such cases activity data may need to go unsent. To that end, the customer monitoring system 2000 may implement a compatibility filter filtering content for contribution messages according to the destination customer relationship management system such as to avoid sending contribution messages concerning activities to customer relationship management systems that cannot process the concerned activities.

Having activities, patterns and triggers defined, the triggers to send information to the customer relationship management system 1410 are configured. Transmitting push requests may be in the same manner as pull requests, and may be simpler to implement since once a query is working properly there is no need to consider the results. However, push requests must be carefully adapted to the customer relationship management system 1410′ API so as to provide data in a form the API expects. To this end the customer monitoring system 2000 integrates customer relationship management system 1410's specific API and performs activity configuration, filtering and translation as described herein so as to ensure compatibility and inter-intelligibility of the data between the systems. In one exemplary implementation this is done by working upstream, via a system of integration modules. A manual approach may be followed, though it typically implies several constraints, whereby a developer may map the different parameters of each request, the transferred values and the structure of the data being dictated by the documentation.

Although various embodiments have been illustrated, this was for the purpose of describing, but not limiting, the present invention. Various possible modifications and different configurations will become apparent to those skilled in the art and are within the scope of the present invention, which is defined more particularly by the attached claims. In the claims, enumerations (e.g. “a”, “b”, “c”, . . . ) may be used to label certain things such as system elements or method steps. These enumerations are meant only as labels to make refering to the things they enumerate more convenient. They are not used herein to imply a sequence or order for the enumerated elements.

1-103. (canceled)

104. A method of populating a customer relationship management system with data derived by a customer monitoring system comprising:
a. obtaining at the customer monitoring system a plurality of data packages, each of which describing corresponding information content about a particular customer;
b. processing the plurality of data packages to determine that the corresponding information content about the particular customer fits a particular behavior pattern; and
c. in response to determining that the corresponding information content about the particular customer fits the particular behavior pattern, generating a contribution message descriptive of the particular behavior pattern in a customer relationship management system format and communicating the contribution message to the customer relationship management system through an inter-system interface.

105. The method of claim 104, further comprising:
a. upon processing the plurality of data packages, processing the particular behavior pattern to assess that it warrants communication to the customer relationship management system, wherein communicating the contribution message to the customer relationship management system occurs in response to assessing that the particular behavior pattern warrants communication to the customer relationship management system.

106. The method of claim 104, wherein the plurality of data packages is a first plurality of data packages from amongst a larger plurality of data packages, and wherein processing the first plurality of data packages comprises processing the larger plurality of data packages to identify therein the first plurality of data packages that comprise corresponding information content that fits the particular behavior pattern.

107. The method of claim 104, wherein at least a portion of the plurality of data packages comprise information indicative of a location of the particular customer.

108. The method of claim 107, wherein processing the plurality of data packages to determine that the corresponding information content about the particular customer fit a particular behavior pattern comprises assessing the location of the particular customer over a period of time, the particular behavior pattern comprising a pattern of movement.

109. The method of claim 108, further comprising accessing geographic site data indicative of the geolocation of the particular user, wherein assessing the location of the particular customer over a period of time comprises assessing the location of the particular user with respect to one or more geographic features.

110. The method of claim 104, further comprising accessing a customer profile dataset associated with the particular customer, retrieving from the customer profile dataset customer attribute data, wherein the particular behavior pattern is determined as a function of the customer attribute data.

111. The method of claim 104, wherein processing the plurality of data packages to determine that the corresponding information content about the particular customer fit a particular behavior pattern comprises comparing the content of each of the plurality of data packages to an activity definition and determining on the basis of concordance between the content of each of the plurality of data packages and the event definition.

112. The method of claim 104, further comprising receiving at least a portion of the plurality of data packages from network tracking system over another inter-system interface.

113. The method of claim 104, wherein at least a portion of the plurality of data packages comprises customer attribute data derived by the customer monitoring system.

114. A customer monitoring system for identifying customer behavior and populating a customer relationship management system with customer data comprising:
a. a general-purpose processing entity configured to be programmed by computer-readable instructions;
b. a network interface in communication with the general-purpose processing entity for communicating data over a data network with remote devices; and
c. a computer-readable memory accessible by the general-purpose processing entity comprising computer-readable program instructions for:
i. obtaining at the customer monitoring system a plurality of data packages, each of which describing corresponding information content about a particular customer;
ii. processing the plurality of data packages to determine that the corresponding information content about the particular customer fit a particular behavior pattern; and
iii. in response to determining that the corresponding information content about the particular customer fit the particular behavior pattern, generating a contribution message descriptive of the particular behavior pattern in a customer relationship management system format and communicating the contribution message to the customer relationship management system through an inter-system interface.

115. The customer monitoring system of claim 114, wherein the computer-readable memory further comprises computer-readable program instructions for upon processing the plurality of data packages, processing the particular behavior pattern to assess that it warrants communication to the customer relationship management system, wherein communicating the contribution message to the customer relationship management system occurs in response to assessing that the particular behavior pattern warrants communication to the customer relationship management system.

116. The customer monitoring system of claim 114, wherein the plurality of data packages is a first plurality of data packages from amongst a larger plurality of data packages, and wherein processing the first plurality of data packages comprises processing the larger plurality of data packages to identify therein the first plurality of data packages that comprise corresponding information content that fits the particular behavior pattern.

117. The customer monitoring system of claim 114, wherein at least a portion of the plurality of data packages comprise information indicative of a location of the particular customer.

118. The customer monitoring system of claim 117, wherein processing the plurality of data packages to determine that the corresponding information content about the particular customer fit a particular behavior pattern comprises assessing the location of the particular customer over a period of time, the particular behavior pattern comprising a pattern of movement.

119. The customer monitoring system of claim 118, wherein the computer-readable memory further comprises computer-readable program instructions for accessing geographic site data indicative of the geolocation of the particular user, wherein assessing the location of the particular customer over a period of time comprises assessing the location of the particular user with respect to one or more geographic features.

120. The customer monitoring system of claim 114, wherein the computer-readable memory further comprises computer-readable program instructions for accessing a customer profile dataset associated with the particular customer, retrieving from the customer profile dataset customer attribute data, wherein the particular behavior pattern is determined as a function of the customer attribute data.

121. The customer monitoring system of claim 114, wherein processing the plurality of data packages to determine that the corresponding information content about the particular customer fit a particular behavior pattern comprises comparing the content of each of the plurality of data packages to an activity definition and determining on the basis of concordance between the content of each of the plurality of data packages and the event definition.

122. The customer monitoring system of claim 114, wherein the computer-readable memory further comprises computer-readable program instructions for receiving at least a portion of the plurality of data packages from network tracking system over another inter-system interface.

123. The customer monitoring system of claim 114, wherein at least a portion of the plurality of data packages comprises customer attribute data derived by the customer monitoring system.
